(19) United States
(12) Patent Application Publication
(10) Pub. No.: US 2002/0080931 A1
(43) Pub. Date: Jun. 27, 2002

(54) Method for changing function of electronic device, customer center, dealer system and user system

(75) Inventors: Seiichi Yamamoto, Sagamihara-shi (JP); Yoshimitsu Ebisawa, Tokyo (JP); Yasumasa Sasaki, Tokyo (JP); Emi Senga, Tokyo (JP); Yoshihiro Kawauchi, Tokyo (JP); Takaaki Hoshikawa, Tokyo (JP); Tooru Iida, Tokyo (JP); Yasuo Funato, Tokyo (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/078,551

(22) Filed: Feb. 20, 2002

Related U.S. Application Data
(63) Continuation of application No. PCT/JP01/05278, filed on Jun. 20, 2001.

(30) Foreign Application Priority Data
Jun. 20, 2000 (JP) 2000-185151
Jul. 14, 2000 (JP) 2000-214513

(51) Int. Cl. H04M 11/00; G06F 17/60

(52) U.S. Cl. 379/90.01; 705/1

(57) ABSTRACT

When adding a new function to a key telephone unit BT, a function addition request is transmitted from a user PC of an user system CM to a customer center CC. The function addition request includes information indicative of the function to be added, a credit number, and a telephone number of the key telephone unit. The customer center CC accesses a credit company CR based on the received credit number, carries out credit research of a user. The customer center CC accesses the key telephone unit BT through a public network PNW based on the telephone number, acquires function information of the key telephone unit BT, judges whether the function can be added based on the function information. If addition is possible, the customer center CC transmits a license code of the function to the key telephone unit BT through the public network PNW, thereby setting the function.

### CROSS-REFERENCE TO RELATED APPLICATIONS

This is a Continuation Application of PCT Application No. PCT/JP01/05278, filed Jun. 20, 2001, which was not published under PCT Article 21 (2) in English.

This application is based upon and claims the benefit of priority from the prior Japanese Patent Applications No. 2000-185151, filed Jun. 20, 2000; and No. 2000-214513, filed Jul. 14, 2000, the entire contents of both of which are incorporated herein by reference.

### BACKGROUND OF THE INVENTION

1. Field of the Invention

The present invention relates to a method for changing a function of an electronic device, which is used for adding or deleting a function of, e.g., an electronic private branch exchange, a Key telephone unit or any other business electronic device, a customer center which executes this function change control, a user system provided with the above-described electronic device, and a dealer system which mediates support operations between the customer center and said user system.

2. Description of the Related Art

In an office, a school or a business institution, business electronic devices such as an electronic private branch exchange, a Key telephone unit, a facsimile machine, a copying machine and others are in heavy usage. When purchasing and using these business electronic devices, a user generally selects a device having functions which are necessary at that moment in time.

After starting to use such a device, however, a function of the device must be added or an unnecessary function of the same must be deleted in accordance with, e.g., increase in work force or a change in business contents in some cases. In such a case, for example, a user calls and informs a customer center or the like in a manufacturer of a request for adding a function, and a person in charge of the maintenance service makes a business visit to a place where the electronic device is installed in accordance with the content in order to perform the setting operation for adding a function desired by the user to the electronic device in the conventional way.

In such a conventional change method, however, the person in charge of the maintenance service in the customer center manually carries out most of the operations from acceptance of the function change request from the user to the function change operation with respect to the electronic device. It, therefore, takes a lot of trouble and time from liaison about the function change request by the user until completion of the function change.

Thus, the user can not immediately user a new function and must bear travel expenses of the person in charge of maintenance service, work costs or the like as well as the counter value of the added function itself, thereby increasing the burden of expenses. On the other hand, since the customer center must predict a number of function change requests to occur and secure persons in charge of maintenance service whose number is comparable to the predicted number, the cost is increased. Also, the customer center has a problem that there are irregularities in quality among the persons responsible.

In view of the above-described problems, it is an object of the present invention to provide a method for changing a function of an electronic device, a customer center, a dealer system and a user system which can rapidly and appropriately change a function without requiring man power, thereby reduce the burden of costs on a user and a time required for making a change, and decrease the costs and labor in the customer center.

### BRIEF SUMMARY OF THE INVENTION

In order to achieve this aim, the present invention carries out a function change by the following procedure.

(1) When changing a function of an electronic device by communicating information between a user system which has the electronic device having a communication function and a customer center that performs operation support businesses for the electronic device through a communication network, a function change request including a content of a function change of the electronic device and subscriber information allocated to the electronic device from the communication network is transmitted from the user system to the customer center, and the customer center accesses the corresponding electronic device through the communication network based on the subscriber information included in the function change request transmitted from the user system and acquires information indicative that function from the electronic device. Further, function change control information is created based on the information indicative of the function acquired from the electronic device and the function change content included in the function change request, and the function change control information is transmitted from the customer center to the corresponding electronic device through the communication network, thereby carrying out function change processing for the electronic device.

According to the present invention, therefore, the steps from a request of a change in the function by the user system to the function change processing in the electronic device of the user system are all automatically executed through the communication network without requiring man power. Thus, the business trip of a person responsible for the maintenance service and the manual change operation are no longer necessary. Therefore, the user can change a function of his/her electronic device in a short time at the small expense and, on the other hand, the customer center can greatly reduce the labor and costs required for changing a function.

(2) There is provided a method for changing a function of an electronic device by communicating information between a user system and a customer center in a system including a user data base storing therein subscriber information allocated to the electronic device from a communication network, device identification information allocated to the electronic device in advance and information indicative of a function of the electronic device in association with individual identification information imparted to a user, a user system which has the electronic device including a communication function and a customer center which performs operation support businesses for the electronic device being connected with each other through a communication network,

wherein the user system transmits a function change request including a content of a function change of the electronic device and individual identification information of the user to the customer center, and the customer center respectively reads the subscriber information of the corresponding electronic device and the information indicative of the function from the user data base based on the individual identification information of the user included in the function change request transmitted from the user system. Then, function change control information is created based on the information indicative of the function read from the user data base and the content of the function change included in the function change request, and the customer center transmits the function change control information to the corresponding electronic device through the communication network, thereby carrying out the function change of the electronic device based on the information change control information.

According to the present invention, therefore, as similar to the invention described in (1), the time required for changing a function and the burden of costs on a user can be reduced, and the labor required for changing a function and the costs in the customer center can be greatly decreased. Furthermore, since communication between the customer center and the electronic device or judgment on the possibility of a function change or the like is carried out by using the information concerning the electronic device of the user stored and managed in the user data base, the appropriate function change processing can be executed with the simple procedure without acquiring the information indicative of the function from the electronic device each time.

(3) There is provided a method for changing a function of an electronic device including a communication function by communicating information through a communication network between a user system which has the electronic device, a customer center which carries out operation support businesses of the electronic device and a dealer which mediates the support businesses between the user system and the customer center,

wherein a function change request including a content of/a function change of the electronic device and subscriber information allocated to the electronic device from the communication network is transferred from the user system to the customer center through the dealer, the customer center accesses through the communication network the corresponding electronic device based on the subscriber information included in the function change request transferred from the dealer in order to acquire information indicative of that function from the electronic device, and function change control information is created based on the acquired information indicative of the function and the function change content included in the function change request. Then, the function change control information is transmitted from the customer center to the corresponding electronic device, and the function is changed in the electronic device based on the function change control information.

Therefore, in addition to the advantage described in (1), the present invention can be also applied to the system interposing the dealer.

(4) There is provided a method for changing a function of an electronic device by utilizing the dealer system described in (3),

wherein the customer center accesses through the communication network the corresponding electronic device based on subscriber information included in a function change request transferred from the user system through the dealer system, acquires information indicative of that function from the electronic device, and transfers the information indicative of the function and the function change request to the dealer system, and the dealer system creates function change control information based on the information indicative of the function transferred from the customer center and the function change content included in the function change request, transmits through the communication network the function change control information to the corresponding electronic device based on subscriber information of the electronic device included in the function change request, and changes a function in the electronic device based on the function change control information.

Therefore, according to the present invention described in (4), since a function of the electronic device of the user system is changed by the dealer system, the burden of processing on the customer center is thereby reduced, and the advantage mentioned in (1) can be obtained.

(5) There is provided a method for changing a function of an electronic device including a communication function by communicating information between a user system, a dealer and a customer center in a system, the user system which has the electronic device, the customer center which performs operation support businesses of the electronic device and the dealer which mediates support businesses between the user system and the customer center being connected to each other by a communication network, the system including a user data base storing therein subscriber information allocated to the electronic device from the communication network, device identification information allocated to the electronic device in advance and information indicative of a function of the electronic device in association with individual identification information imparted to a user,

wherein a function change request including a function change content of the electronic device and subscriber information allocated to the electronic device from the communication network is transferred to the customer center from the user system through the dealer, and the customer center reads the subscriber information and information indicative of the function of the corresponding electronic device from the user data base based on the individual identification information of the user included in the function change request transmitted from the user system. Then, function change control information is created based on the information indicative of the function read from the user data base and the function change content included in the function change request, and the function change control information is transmitted from the customer center to the corresponding electronic device through the communication network, thereby changing the function in the electronic device based on the function change control information.

According to the present invention, therefore, the advantage described in (2) and the advantage mentioned in (3) can be demonstrated, respectively.

(6) There is provided a method for changing a function of the electronic device by utilizing the dealer system according to (5),

wherein the customer center reads subscriber information of the corresponding electronic device and information indicative of the function from the user data base based on the individual identification information of the user included in the function change request transferred from the user system through the dealer system, and transfers the subscriber information of the electronic device, the information indicative of the function and the function change request to the dealer system, and the dealer system creates function change control information based on the information indicative of the function transferred from the customer center and the function change content included in the function change request, and accesses through the communication network the corresponding electronic device based on the subscriber information of the electronic device transferred from the customer center in order to transmit the function change control information, thereby changing the function in the electronic device based on the function change control information.

According to the present invention defined in (6), therefore, since the function of the electronic device of the user system is changed by the dealer system, the burden of processing on the customer center is reduced, and the advantage described in (2) can be obtained.

(7) According to the present invention defined in (1) to (6), when the customer center and a payment institution can be connected to each other through the communication network, account identification information of a user is transmitted from the user system to the customer center, and payment processing for transferring a charge required for the function change from the account of the user is executed between the customer center and the payment institution through the communication network after completion of the function change with respect to the electronic device of the user system.

(8) According to the present invention defined in (3) to (6), when the dealer and the payment institution can be connected to each other through the communication network, account identification information of a user is transmitted from the user system to the customer center, and payment processing for transferring a charge required for the function change from the account of the user is executed between the customer center and the payment institution through the communication network after completion of the function change with respect to the electronic device of the user system.

According to the present invention defined in (7) and (8), therefore, payment required for the function change can be automatically performed between the customer center or the dealer and the payment institution through the communication network.

(9) According to the present invention defined in (7), the legitimacy of the user is inquired from the customer center to the payment institution through the communication network based on the acquired account identification information of the user. Then, the customer center makes judgment upon whether the function change can be allowed based on a result of the inquiry, and allows the function change to the corresponding electronic device only when it is determined that the function change is allowed.

(10) According to the present invention defined in (8), the legitimacy of the user is inquired from the dealer to the payment institution through the communication network based on the acquired account identification information of the user. Then, the dealer makes judgment upon whether the function change can be allowed based on a result of the inquiry, and allows the function change by the customer center only when it is determined that the function change is allowed.

According to the present invention defined in (9) and (10), therefore, the presence/absence of the user as well as outstanding balance of the account or an expiration date is checked by utilizing the account information of the user owned by the payment institution before the function change, and the legitimacy of the user can be thereby assuredly judged in advance.

(11) According to the present invention defined in (1) or (3) or (4), the step of acquiring the information indicative of the function and the device identification information confidentially imparted to the electronic device in advance by the customer center from the electronic device encrypts the function change control information by using the acquired device identification information, transmits the encrypted function change control information to the electronic device, decrypts the function change control information in the electronic device by using its own device identification information, and allows the function change in accordance with the decrypted function change control information.

(12) According to the present invention defined in (2) or (5) or (6), the step of reading the device identification information of the corresponding electronic device from the user data base based on the individual identification information of the user and transmitting the function change information in the customer center encrypts the function change control information by using the acquired device identification information, transmits the encrypted function change control information to the electronic device, decrypts the function change control information in the electronic device by using its own device identification information, and allows the function change in accordance with the decrypted function change control information.

According to the present invention defined in (11) and (12), therefore, the function change control information is encrypted based on the device identification information acquired from the electronic device when transferred to the electronic device. Therefore, when the function change control information is accidentally transferred to a different electronic device or even if another user tries to steal the function change control information designated to any other electronic device in order to change a function of his/her electronic device, the erroneous function change or the fraudulent function change can not be carried out.

(13) According to the present invention defined in (1) or (3), the customer center makes judgment upon the possibility of the function change requested from the user based on the information indicative of the function acquired from the electronic device and the function change content included in the function change request, transmits the function change control information from the customer center to the corresponding electronic device through the communication network when it is determined that the function change is possible, and executes the function change of the electronic device based on the function change control information.

(14) According to the present invention defined in (2) or (5), the customer center makes judgment upon the possibility of the requested function change based on the information indicative of the function read from the user data base and the function change content included in the function change request, accesses the corresponding electronic device from the customer center through the communication network based on the subscriber information of the electronic device read from the user data base in order to transmit the function change control information when it is determined that the function change is possible, and performs the function change of the electronic device based on the function change control information.

According to the present invention defined in (13) and (14), therefore, before executing the function change with respect to the electronic device, the customer center accesses the electronic device, acquires the information indicative of that function, namely, the information of the currently set function or the function which can be newly set, and makes judgment upon whether the function change is possible based on this information. Thus, the appropriate function change processing can be carried out in accordance with each electronic device, and the reliability of maintenance can be further improved.

(15) According to the present invention defined in (13), the customer center informs the user of a result of judgment upon the possibility of the function change requested from the user through the communication network.

(16) According to the present invention defined in claim (13), the customer center transfers a result of judgment upon the possibility of the function change requested from the user to the dealer through the communication network, and the dealer informs the user who has made the request of the result of judgment through the communication network.

According to the present invention defined in (15) and (16), therefore, the user can confirm whether the function change requested by has been accepted. Moreover, at that moment, if the user can be informed of reasons or countermeasure guidance information in addition to the result of judgment upon the possibility of the function change, the user can grasp the cause and perform an appropriate repeat operation or the like when the function change has not been accepted.

(17) According to the present invention defined in (2) or (5), after completion of function change processing with respect to the electronic device, information indicative of the function of the electronic device relative to the corresponding user in the user data base is updated.

By doing so, storage management information in the user data base can be automatically constantly updated to latest information without manually performing updating processing by a person in charge of maintenance management in the customer center or the dealer.

(18) According to the present invention defined in (1) to (6), when the electronic device includes a function table storing therein setting information indicative of enabled/disabled states with respect to at least part of all functions provided to the electronic device, the step of changing the function of the electronic device changes the setting information of the corresponding function in the function table in accordance with the content of the function change control information transmitted from the customer center to the electronic device.

According to the present invention, therefore, when executing the function change processing of the electronic device, it is good enough for the customer center to only transmit information used for changing the setting information of the function as a target of change as control information, and the function change can be thereby simply carried out in a short period of time as compared with a case of downloading a program realizing an additional function, for example.

(19) In the customer center according to the present invention, the effect and advantage similar to those mentioned in (1) to (18) can be also demonstrated.

(20) In the dealer system according to the present invention, the effect and advantage similar to those described in (3) to (18) can be also demonstrated.

(21) In the user system according to the present invention, the effect and advantage similar to those mentioned in (11), (12) and (18) can be also demonstrated.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic structural view showing a system carrying out a function change method according to first embodiment of the present invention;

FIG. 2 is a sequence diagram illustrating the outline of the function change method according to the first embodiment;

FIG. 3 is a signal sequence diagram illustrating a first embodiment of the function change method according to the first embodiment;

FIG. 4 is a signal sequence diagram illustrating the first embodiment of the function change method according to the first embodiment;

FIG. 5 is a signal sequence diagram illustrating a second embodiment of the function change method according to the first embodiment;

FIG. 6 is a signal sequence diagram illustrating the second embodiment of the function change method according to the first embodiment;

FIG. 7A is a block diagram showing a function configuration of a maintenance personal computer and a key telephone unit illustrated in FIG. 1;

FIG. 7B is a block diagram showing a function configuration of a customer center depicted in FIG. 1;

FIG. 8 is a flowchart showing a processing procedure and its content of the customer center of the system illustrated in FIG. 1;

FIG. 9 is a flowchart showing a processing procedure of a user PC and its content when a title is received from the customer center in the system depicted in FIG. 1;

FIG. 10 is a flowchart showing a processing procedure of the user PC and its content when a user information input request is received from the customer center in the system depicted in FIG. 1;

FIG. 11 is a flowchart showing a processing procedure of the user PC and its content when a function selection screen is received from the customer center in the system depicted in FIG. 1;

FIG. 12 is a flowchart showing a processing procedure of the user PC and its content when a confirmation request screen is received from the customer center in the system depicted in FIG. 1;

FIG. 13 is a flowchart showing a processing procedure of the user PC and its content when an addition termination screen is received from the customer center in the system depicted in FIG. 1;

FIG. 14 is a flowchart showing a processing procedure of the user PC and its content when a user information re-input request is received from the customer center in the system depicted in FIG. 1;

FIG. 15 is a flowchart showing a processing procedure of the user PC and its content when a function addition processing NG is received from the customer center in the system illustrated in FIG. 1;

FIG. 16 is a flowchart showing a processing procedure of the customer center and its content when a main page access request is received from the user PC in the system illustrated in FIG. 1;

FIG. 17 is a flowchart showing a processing procedure of the customer center and its content when user information is received from the user PC in the system depicted in FIG. 1;

FIG. 18 is a flowchart showing a processing procedure of the customer center and its content when a selected function group is received from the user PC in the system illustrated in FIG. 1;

FIG. 19 is a flowchart showing a processing procedure of the customer center and its content when a confirmation selection is received from the user PC in the system depicted in FIG. 1;

FIG. 20 is a flowchart showing a processing procedure of a Key telephone unit and its content in the system illustrated in FIG. 1;

FIG. 21 is a flowchart showing a processing procedure of a credit company and its content in the system depicted in FIG. 1;

FIG. 22 is a view showing an example of a display screen in the user PC illustrated in FIG. 1;

FIG. 23 is a view showing an example of the display screen in the user PC depicted in FIG. 1;

FIG. 24A is a block diagram showing a function configuration of a function information/system ID transmission/reception setting processing section which is a primary part of the key telephone unit illustrated in FIG. 1;

FIG. 24B is a block diagram showing a function configuration of a function information/system ID transmission/reception setting processing section which is a primary part of the key telephone unit illustrated in FIG. 1;

FIG. 25A is a block diagram showing a function configuration of a function information storage area and a function enabling processing section which are primary parts in the key telephone unit depicted in FIG. 1;

FIG. 25B is a block diagram showing a function configuration of a function information storage area and a function enabling processing section which are primary parts in the key telephone unit depicted in FIG. 1;

FIG. 26 is a view illustrating the operation when a call pickup request and a call forward setting request are transmitted to the key telephone unit from an extension terminal;

FIG. 27 is a view illustrating the operation when a multi appearance setting request and a private branch exchange switchboard group setting request are transmitted to the key telephone unit from a maintenance terminal;

FIG. 28 is a view illustrating an outgoing/incoming correspondence processing operation between the key telephone unit and the extension terminal;

FIG. 29 is a sequence diagram showing call pickup processing in the key telephone unit;

FIG. 30 is a flowchart showing call pickup processing procedure and its content in the key telephone unit;

FIG. 31 is a sequence diagram illustrating call forward setting processing in the key telephone unit;

FIG. 32 is a flowchart showing the call forward setting processing and its content in the key telephone unit;

FIG. 33 is a sequence diagram illustrating multi appearance setting processing in the key telephone unit;

FIG. 34 is a flowchart showing the multi appearance setting processing procedure and its content in the key telephone unit;

FIG. 35 is a sequence diagram illustrating extension setting processing in the key telephone unit;

FIG. 36 is a flowchart showing the extension setting processing procedure and its content in the key telephone unit;

FIG. 37 is a sequence diagram showing outgoing/incoming correspondence connection processing in the key telephone unit;

FIG. 38 is a flowchart showing the outgoing/incoming correspondence connection processing procedure and its content in the key telephone unit;

FIG. 39 is a schematic structural view showing a system carrying out a function change method according to a second embodiment of the present invention;

FIG. 40 is a sequence diagram illustrating the outline of the function change method according to the second embodiment;

FIG. 41 is a signal sequence diagram illustrating the function change method according to the second embodiment;

FIG. 42 is a signal sequence diagram illustrating the function change method according to the second embodiment;

FIG. 43A is a block diagram showing a function configuration of a maintenance personal computer and a key telephone unit illustrated in FIG. 39;

FIG. 43B is a block diagram showing a function configuration of a customer center and a user data base depicted in FIG. 39;

FIG. 44 is a flowchart showing a processing procedure of the customer center and its content in a system illustrated in FIG. 39;

FIG. 45 is a flowchart showing a processing procedure of a user PC and its content when an additional function selection screen is received from the customer center in the system illustrated in FIG. 39;

FIG. 46 is a flowchart showing a processing procedure of the customer center and its content when user information is received from a user PC in the system depicted in FIG. 39;

FIG. 47 is a flowchart showing a processing procedure of the customer center and its content when a result of selecting an additional function is received from the user PC in the system illustrated in FIG. 39;

FIG. 48 is a flowchart showing a processing procedure of the customer center and its content when a confirmation selection is received from the user PC in the system depicted in FIG. 39;

FIG. 49 is a schematic structural view showing a system carrying out a function change method according to a third embodiment of the present invention;

FIG. 50A is a sequence diagram illustrating the outline of the function change method according to the third embodiment;

FIG. 50B is a sequence diagram illustrating the outline of the function change method according to the third embodiment;

FIG. 51 is a signal sequence diagram illustrating the function change method according to the third embodiment;

FIG. 52 is a signal sequence diagram illustrating the function change method according to the third embodiment;

FIG. 53 is a signal sequence diagram illustrating the function change method according to the third embodiment;

FIG. 54A is a block diagram showing a function structure of a maintenance personal computer and a key telephone unit illustrated in FIG. 49;

FIG. 54B is a block diagram showing a function configuration of a customer center and a dealer depicted in FIG. 49;

FIG. 55 is a flowchart showing a processing procedure of the customer center and its content in a system illustrated in FIG. 49;

FIG. 56 is a flowchart showing a processing procedure of the dealer and its content in the system illustrated in FIG. 49;

FIG. 57 is a flowchart showing a processing procedure of the dealer and its content when a selected function group is received from the user PC in the system depicted in FIG. 49;

FIG. 58 is a flowchart showing a processing procedure of the dealer and its content when a confirmation selection is received from the user PC in the system illustrated in FIG. 49;

FIG. 59 is a flowchart showing a processing procedure of the customer center and its content when a function addition request is received from the dealer in the system depicted in FIG. 49;

FIG. 60 is a flowchart showing a processing procedure of the customer center and its content when a function download request is received from the dealer in the system depicted in FIG. 49;

FIG. 61 is a schematic structural view showing a system carrying out a function change method according to a fourth embodiment of the present invention;

FIG. 62A is a sequence diagram illustrating the outline of the function change method according to the fourth embodiment;

FIG. 62B is a sequence diagram illustrating the outline of the function change method according to the fourth embodiment;

FIG. 63 is a signal sequence diagram illustrating the function change method according to the fourth embodiment;

FIG. 64 is a signal sequence diagram illustrating the function change method according to the fourth embodiment;

FIG. 65 is a signal sequence diagram illustrating the function change method according to the fourth embodiment;

FIG. 66A is a block diagram showing a function configuration of a maintenance personal computer, a key telephone unit and a user data base illustrated in FIG. 61;

FIG. 66B is a block diagram showing a function configuration of a customer center and a dealer depicted in FIG. 61;

FIG. 67 is a flowchart showing a processing procedure of the customer center and its content in the system illustrated in FIG. 61;

FIG. 68 is a flowchart showing a processing procedure of the customer center and its content when a function addition request is received from the dealer in the system depicted in FIG. 61;

FIG. 69 is a flowchart showing a processing procedure of the customer center and its content when a function download request is received from the dealer in the system illustrated in FIG. 61;

FIG. 70 is a schematic structural view showing a system carrying out a function change method according to a fifth embodiment of the present invention;

FIG. 71 is a sequence diagram illustrating the function change method according to the fifth embodiment;

FIG. 72 is a sequence diagram illustrating the function change method according to the fifth embodiment;

FIG. 73 is a sequence diagram illustrating the function change method according to the fifth embodiment;

FIG. 74A is a block diagram showing a function configuration of a maintenance personal computer and a key telephone unit illustrated in FIG. 70;

FIG. 74B is a block diagram showing a function configuration of a customer center and a dealer depicted in FIG. 70;

FIG. 75 is a sequence diagram illustrating a first modification of the function change method according to the fifth embodiment;

FIG. 76 is a sequence diagram illustrating the first modification of the function change method according to the fifth embodiment;

FIG. 77 is a sequence diagram illustrating the first modification of the function change method according to the fifth embodiment;

FIG. 78 is a sequence diagram illustrating a second modification of the function change method according to the fifth embodiment;

FIG. 79 is a sequence diagram illustrating the second modification of the function change method according to the fifth embodiment;

FIG. 80 is a sequence diagram illustrating the second modification of the function change method according to the fifth embodiment;

FIG. 81 is a schematic structural view showing a system carrying out the function change method according to a sixth embodiment of the present invention;

FIG. 82 is a sequence diagram illustrating the function change method according to the sixth embodiment;

FIG. 83 is a sequence diagram illustrating the function change method according to the sixth embodiment;

FIG. 84 is a sequence diagram illustrating the function change method according to the sixth embodiment;

FIG. 85A is a block diagram showing a function configuration of a maintenance personal computer, a user data base and a key telephone unit illustrated in FIG. 81;

FIG. 85B is a block diagram showing a function configuration of a customer center and a dealer depicted in FIG. 81;

FIG. 86 is a sequence diagram illustrating a first modification of the function change method according to a sixth embodiment;

FIG. 87 is a sequence diagram illustrating the first embodiment of the function change method according to the sixth embodiment; and

FIG. 88 is a sequence diagram illustrating the first modification of the function change method according to the sixth embodiment.

### DETAILED DESCRIPTION OF THE INVENTION

(First Embodiment)

In the first embodiment of the function change method according to the present invention, when adding a new function to a key telephone unit, a function addition request is first transmitted from a maintenance personal computer of a user to a customer center through the Internet INW. The function addition request includes information indicative of a function to be added, a credit number of the user, and a telephone number of the key telephone unit. Subsequently, the customer center accesses a credit company and performs the credit research of the user based on the credit number included in the function addition request. Then, the customer center accesses the key telephone unit of the user through a public network based on the telephone number included in the function addition request, acquires function information of the Key telephone unit, and makes judgment upon whether a function requested by the user can be added based on the acquired information. Further, when addition is possible, a license code of the function to be added is transmitted to the Key telephone unit of the user through the public network, thereby setting addition of the function.

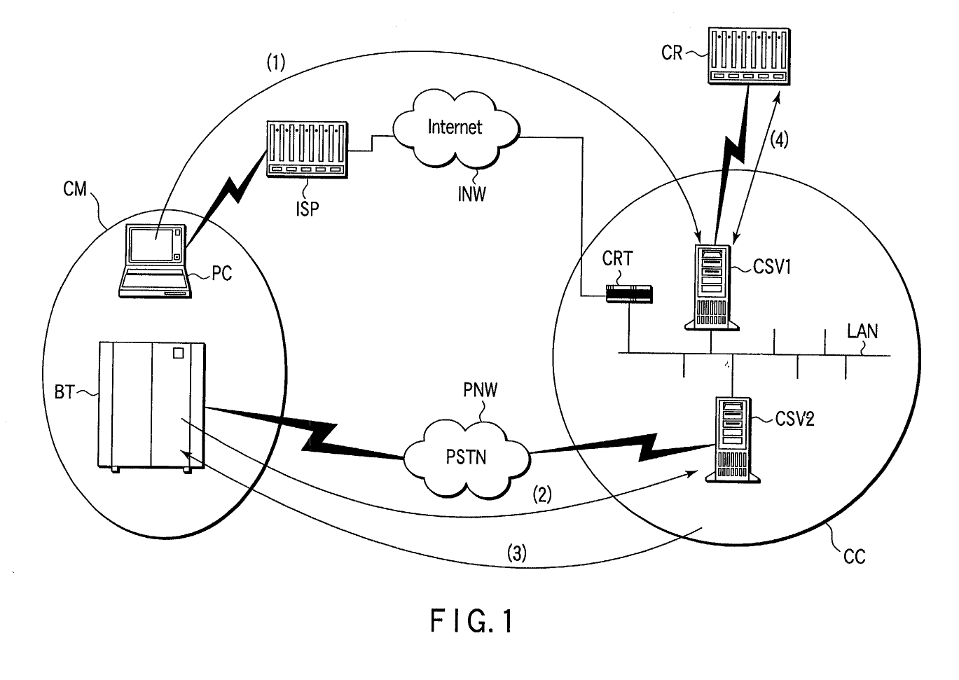

FIG. 1 is a schematic structural view showing a support system which carries out the function change method according to the first embodiment. Reference character CM denotes a user system; CC, a customer center; and CR, a credit company.

Said user system CM includes a key telephone unit BT and a maintenance personal computer PC. The key telephone unit BT has as a basic function a function for establishing switched connection between a plurality of non-illustrated extension terminals and between these extension terminals and subscriber lines in the public network PNW in accordance with the outgoing/incoming correspondence. Also, it has a plurality of optional service functions concerning the switched connection processing. For example, as the optical service functions, there are a call pickup function, a call forward function, a multi appearance function and others.

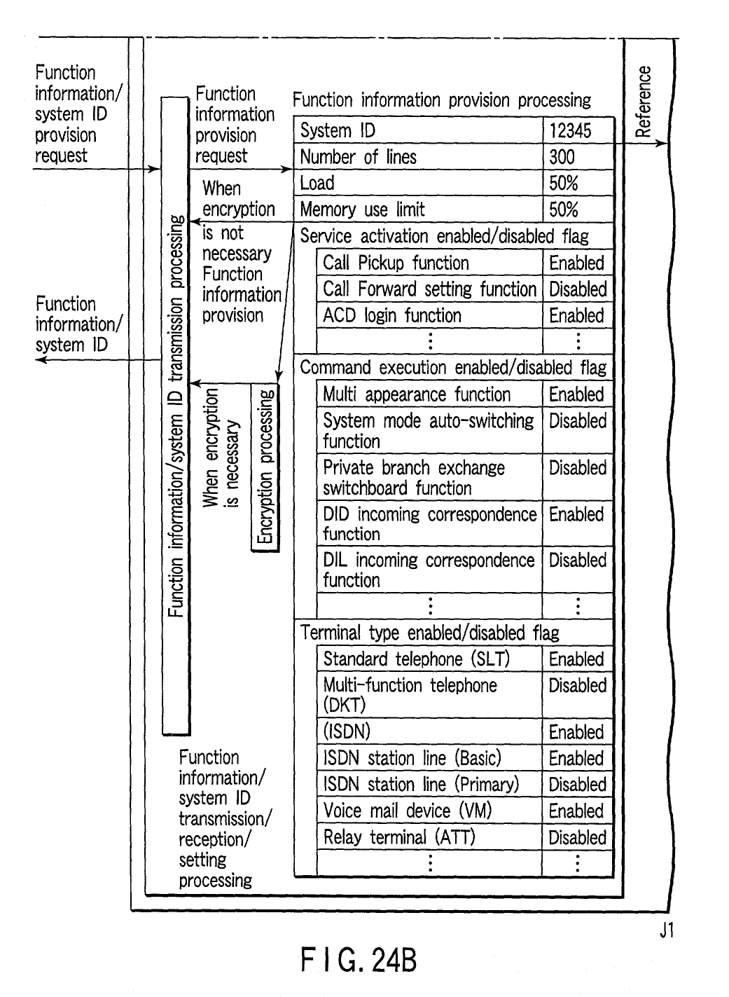

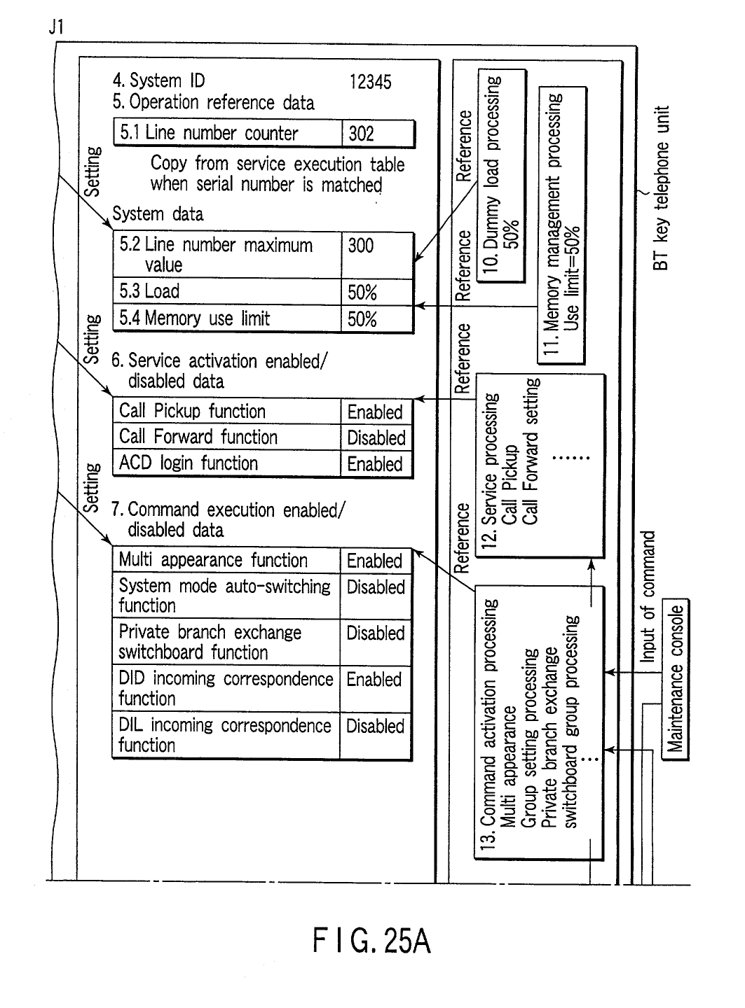

Programs which realize these optional service functions are all stored in a program memory in the key telephone unit BT in advance. Furthermore, in order to manage the setting state of these optional service functions, a function information setting processing table (service execution table) is provided to the key telephone unit BT. FIG. 24 shows an example of such a table, and each flag indicative of enabled/disabled states is stored in association with each optional service function. When this flag indicative of the enabled/disabled states is set to “enabled”, that function is executable. On the other hand, when it is set to “disabled”, that function can not be executed.

The maintenance personal computer PC is connected to the Internet INW through a provider ISP, and further connected to the customer center CC from the Internet INW.

The customer center CC includes an acceptance/charging server CSV1, a license server CSV2, and a router CRT and connects them with each other through a LAN. The acceptance/charging server CSV1 is connected to the Internet INW through the router CRT, and receives the function addition request transmitted from the maintenance personal computer PC of said user system CM. Moreover, the acceptance/charging server CSV1 is connected to the credit company CR through, for example, a dedicated line, and executes payment processing of the charge required for addition of the function between itself and the credit company CR.

The license server CSV2 is connected to the Key telephone unit BT of said user system CM through the public network PNW. The license server CSV2 has a function to acquire a device identification number (system ID) uniquely given to each Key telephone unit from the Key telephone unit BT and function information of the Key telephone unit BT, and a function to perform setting of addition of a function by transmitting a license code to the Key telephone unit BT. It is to be noted that the function information is created based on function information setting processing table (FIG. 24) provided to the Key telephone unit BT and consists of a list of functions which have been already enabled and functions which can be added and used. In addition, to the license code are added an instruction code for activating the addition function and a system ID.

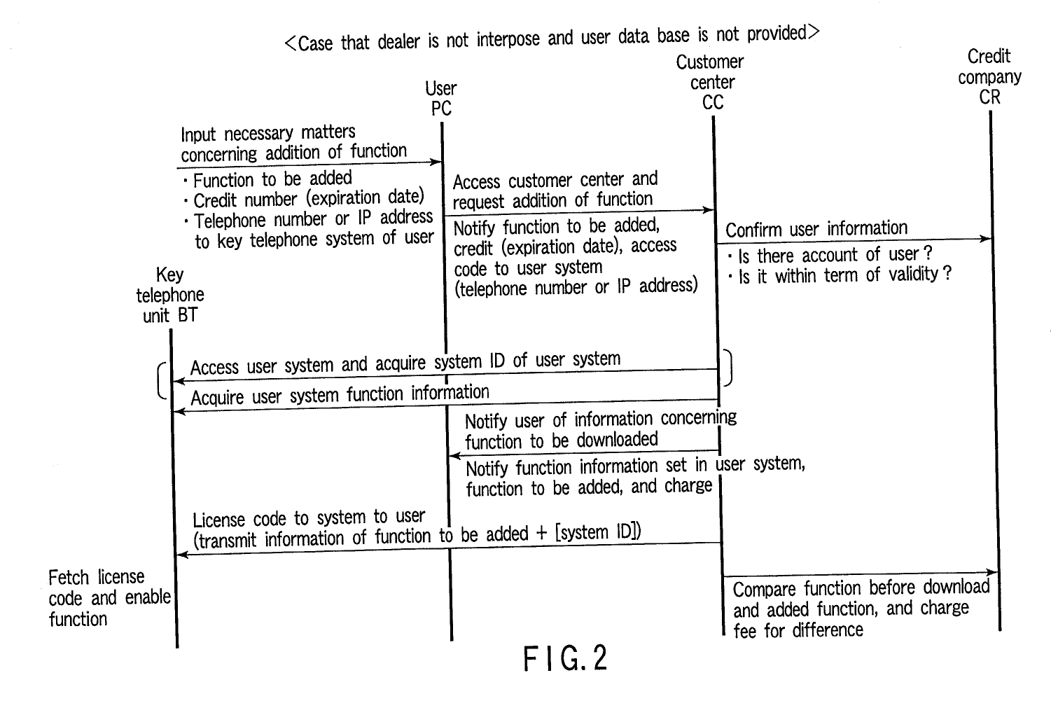

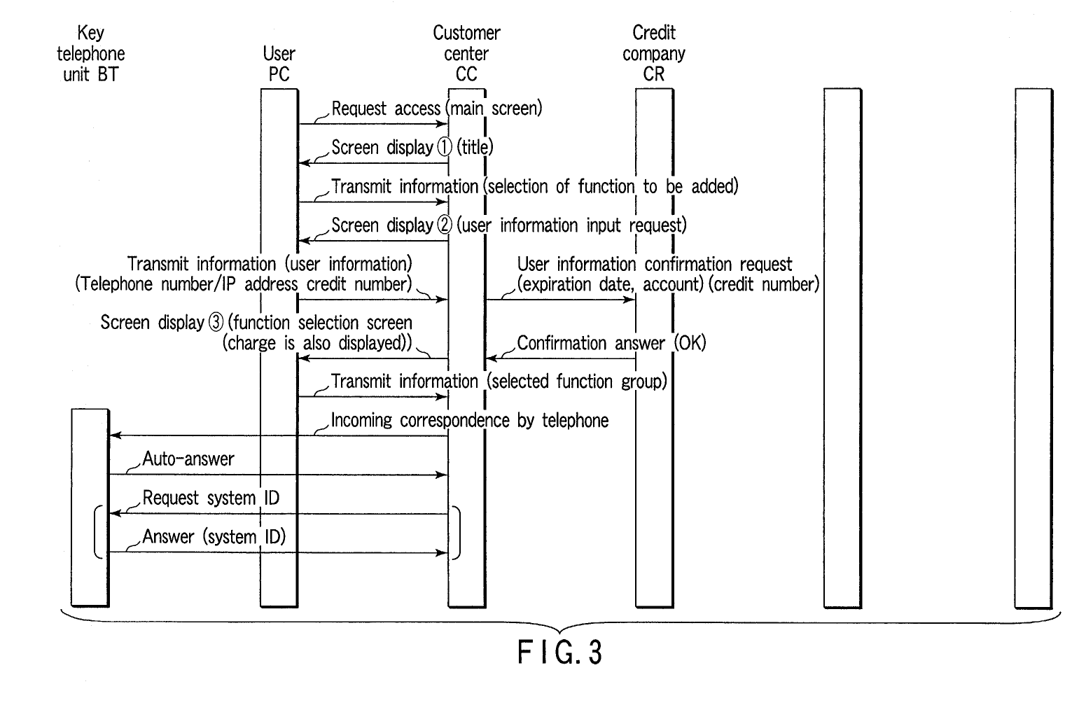

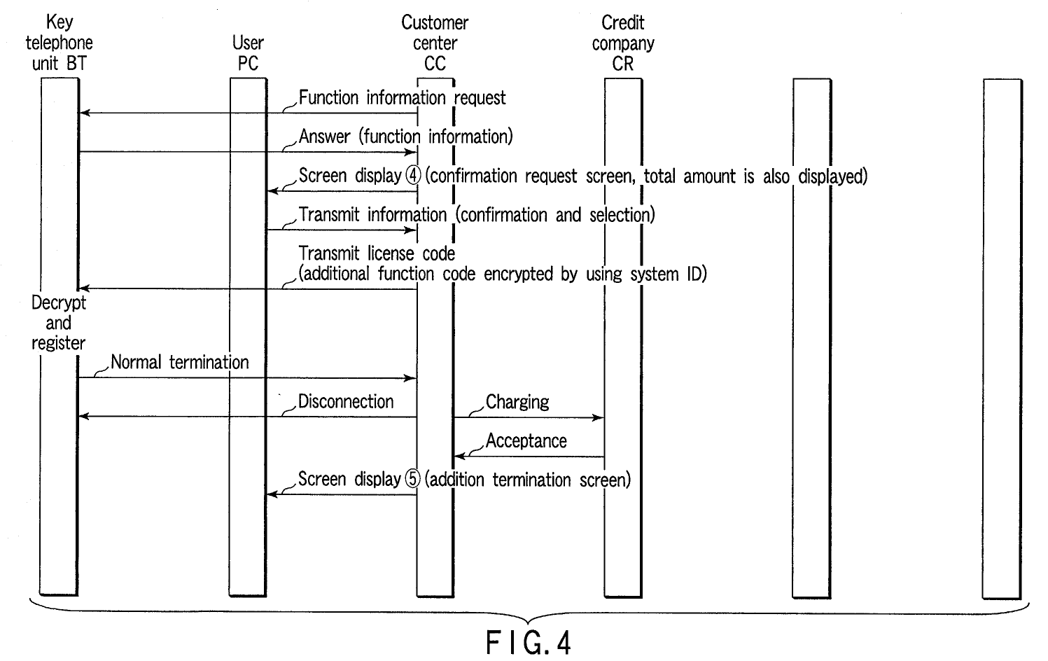

The procedure for adding a function to the key telephone unit BT in the system mentioned above will now be described. FIG. 2 is a schematic sequence diagram showing the operation for communicating information between the maintenance personal computer PC of said user system CM (user PC), the customer center CC and the credit company CR, and FIGS. 3 and 4 are schematic sequence diagrams of FIG. 2.

When adding a function of the key telephone unit BT, a user uses the maintenance personal computer PC to access the customer center CC through the Internet INW, and inputs necessary matters concerning addition of a function in accordance with the guidance on a screen downloaded from the customer center CC. The necessary matters to be inputted are information indicative of a function to be added, a credit number, and a telephone number or an IP address allocated to the key telephone unit BT from the public network PNW. Additionally, upon completion of input of these necessary matters, a function addition request including such information is transmitted to the customer center CC.

Upon receiving the function addition request, the customer center CC first accesses the credit company CR through the dedicated line, and inquires about the credit of the user based on the credit number of the user. With respect to this inquiry, the credit company CR makes judgment upon whether there is an account corresponding to the credit number, whether the expiration data of the credit is within the term of validity, and whether suspension of use is set. Further, the answer is returned to the customer center CC.

The customer center CC make judgment upon the credit of the user based on the answer from the credit company CR. Then, the customer center CC accesses the key telephone unit BT of the user through the public network PNW based on the telephone number included in the function addition request if there is no problem, and acquires the function information and the system ID from the key telephone unit BT. Furthermore, it makes judgment upon whether the function that the user wants to add has been already used and whether addition of the function is possible if it has not been used, and informs the maintenance personal computer PC of the user of the result of judgment together with the cost required for adding the function.

Moreover, upon receiving the answer of confirmation from the user with respect to this notification, the customer center CC transmits the license code as the function change control information to the key telephone unit BT of the user through the public network PNW. An instruction code which is used for setting the function to be added to “enabled” is inserted to the license code. At this moment, the instruction code is encrypted based on the system ID previously acquired from the key telephone unit BT.

Upon receiving the license code from the customer center CC, the key telephone unit BT first decrypts the instruction code included in the license code by using its system ID. Then, the key telephone unit BT changes a flag of the corresponding function in the function information setting processing table from “disabled” to “enabled” in accordance with the decrypted instruction code. Upon completing the setting processing of addition of the function, the key telephone unit BT returns to the customer center CC information indicating that the function addition processing has been normally terminated.

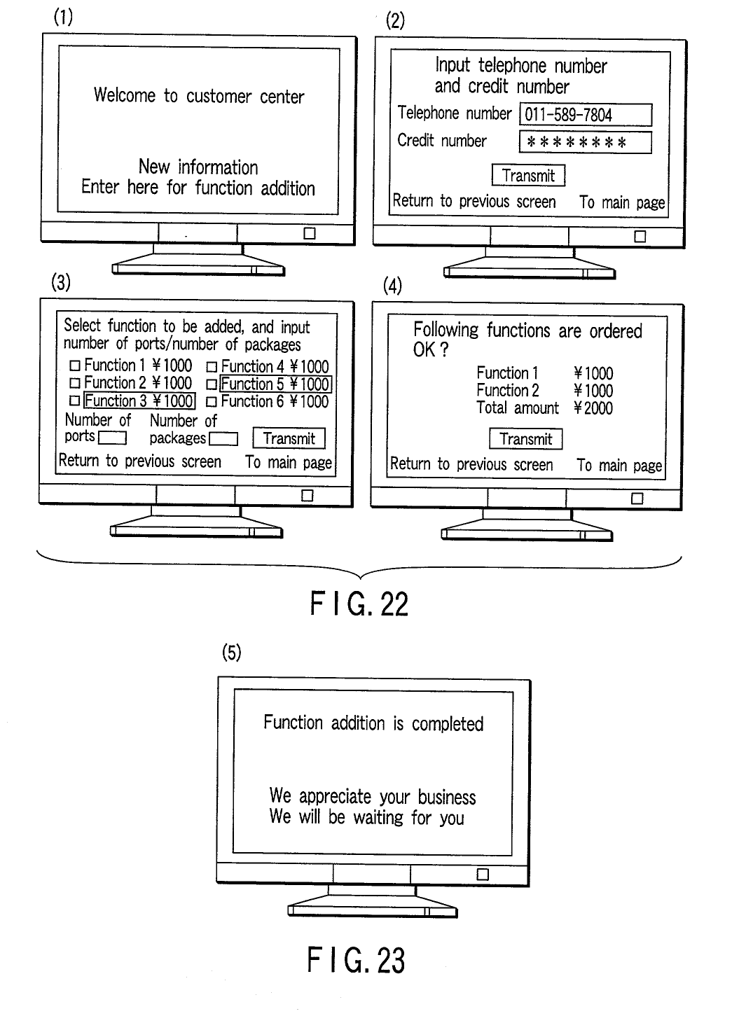

When the customer center CC receives the function addition completion notification from the key telephone unit BT, it disconnects the line between itself and the key telephone unit BT, and thereafter accesses the credit company CR and requests it to perform payment of the function addition charge. At that moment, the customer center CC calculates an amount billed with respect to each function that the user wants to add and which is actually set to be enabled, and creates an electronic bill of particulars. For example, when the user wants to add a function 1 and a function 2 as shown in FIG. 22(4), a total amount (=\2,000) is calculated by adding together a charge for adding the function 1 (=\1,000) and a charge for adding the function 2 (=\1,000), and creates the electronic bill of particulars. Furthermore, the electronic bill of particulars is included in the payment request information and transmitted to the credit company CR.

When the credit company CR receives the payment request information, it first authenticates the user and makes judgment upon whether transaction is possible based on the credit number of the user included in the payment request information. Moreover, if transaction is possible, the payment acceptance processing of the charge is carried out based on the electronic bill of particulars included in the payment request information. In addition, after completion of the payment acceptance processing, the credit company CR returns an answer informing that the payment request has been accepted to the customer center CC which has sent the request.

Upon receiving the answer informing that the payment has been accepted from the credit company CR, the customer center CC transmits information of completion of the function addition processing to the maintenance personal computer PC of the user, and the maintenance personal computer PC is caused to display the information.

In this manner, the function that the user wants to add is set to be enabled in the Key telephone unit BT, and thereafter the Key telephone unit BT of the user can use the newly added optional service function.

It is to be noted that the configuration of each section of the support system which realizes the above-described function change method is as follows.

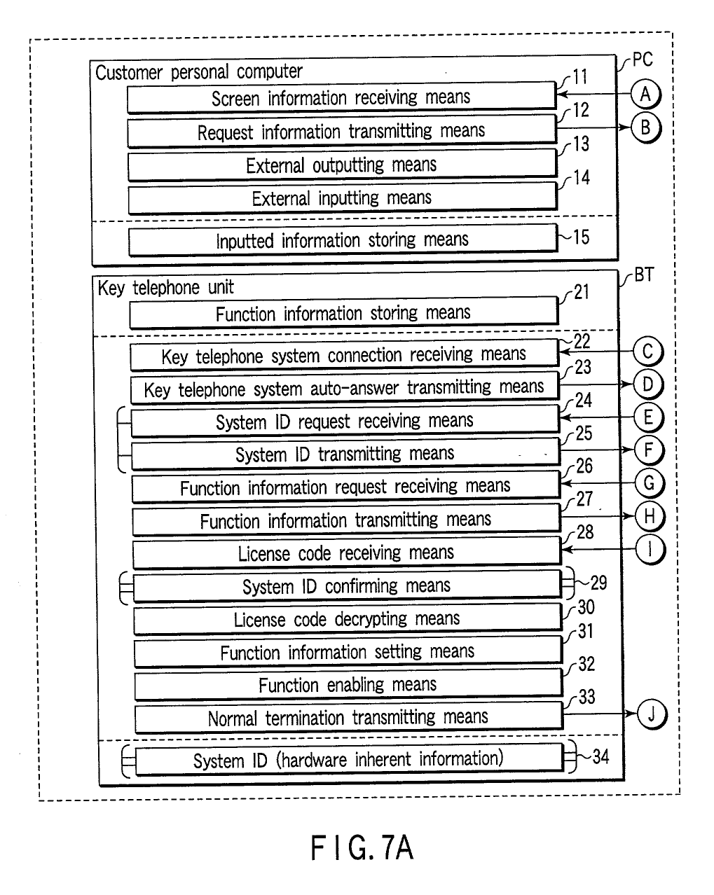

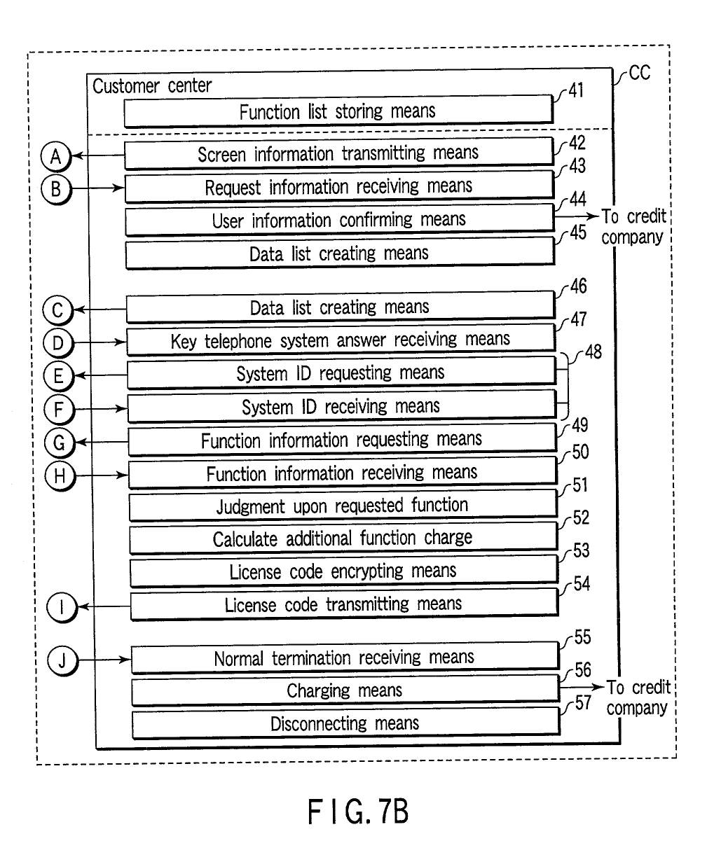

FIG. 7 is a block diagram showing the function configuration of the maintenance personal computer PC, the key telephone unit BT and the customer center CC.

The maintenance personal computer PC includes screen information receiving means 11, request information transmitting means 12, external outputting means 13, external inputting means 14, and inputted information storing means 15.

Of these means, the screen information receiving means 11 receives and displays various kinds of screen information downloaded from the customer center CC during execution of the function addition procedure. The request information transmitting means 12 inserts information indicative of the added function inputted by the user, the credit number, and the telephone number or the IP address of the key telephone unit BT into the request information and transmits it to the customer center CC.

As functions relating to the present invention, the key telephone unit BT includes: function information storing means 21; Key telephone unit connection receiving means 22; button telephone system auto-answer transmitting means 23; system ID request receiving means 24; system ID transmitting means 25; function information request receiving means 26; function information transmitting means 27; license code receiving means 28; system ID confirming means 29; license code decrypting means 30; function information setting means 31; function enabling means 32; normal termination transmitting means 33; and system ID (hardware inherent information) storage section 34.

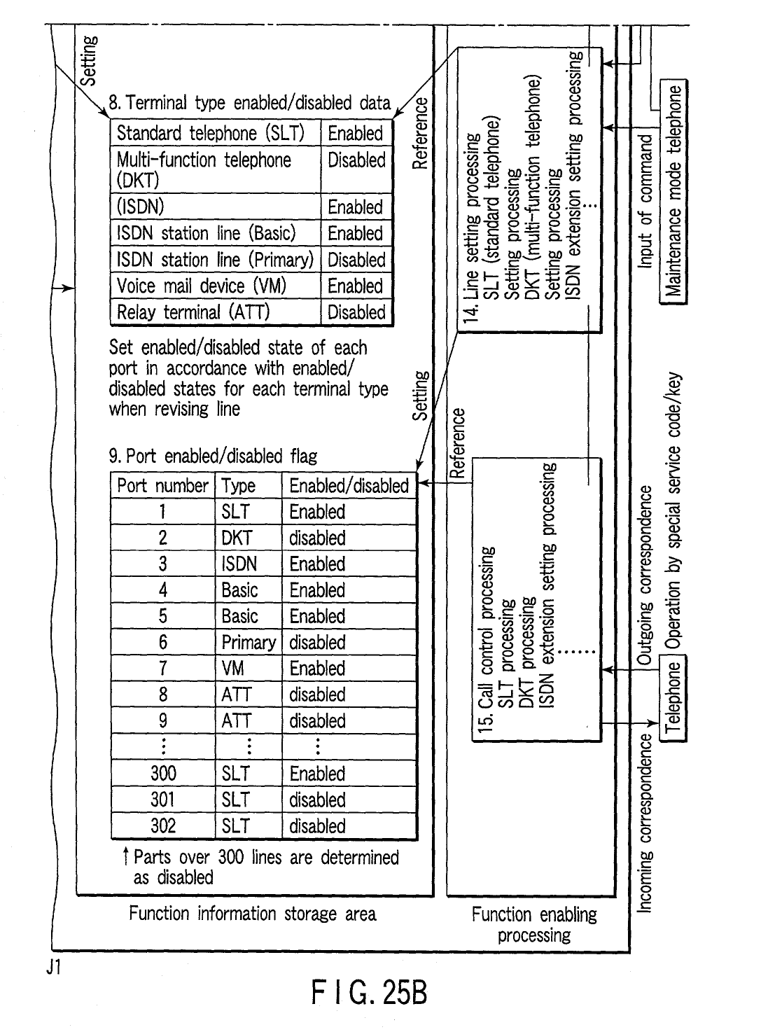

Of these means, the function information storing means 21 stores therein the function information shown in FIGS. 24 and 25. Moreover, the system ID storage section 34 stores therein a unique system ID fixedly given to its own device. As the system ID, there is used a serial number of the key telephone unit, for example.

The key telephone unit connection receiving means 22 and the Key telephone unit auto-answer transmitting means 23 performs reception and answering when there is the incoming correspondence from the customer center CC. When a request to acquire a system ID is transmitted from the customer center CC, the system ID request receiving means 24 and the system ID transmitting means 25 receive this request and transmit the system ID. When a request to acquire the function information is transmitted from the customer center, the function information request receiving means 26 and the function information transmitting means 27 receive this request and transmit a function information list.

The license code decrypting means 30 decrypts the license code received by the license code receiving means 28 by using the system ID of its own device. The function information setting means 31 and the function enabling means 32 set a flag of the function, which is designated to be added, in accordance with the decrypted license code.

The customer center CC includes: function list storing means 41; screen information transmitting means 42; request information receiving means 43; user information confirming means 44; data list creating means 45; key telephone unit connecting means 46; key telephone unit answer receiving means 47; system ID requesting means and system ID receiving means 48; function information requesting means 49; function information receiving means 50; requested function judging means 51; additional function charge calculating means 52; license code encrypting means 53; license code transmitting means 54; normal terminal receiving means 55; charging means 56; and disconnecting means 57.

Of these means, the screen information transmitting means 42 transmits screen information used for causing the maintenance personal computer PC of the user to input a request for adding the function and transmit it, when there is access from the maintenance personal computer PC. The request information receiving means 43 receives information of the function addition request transmitted from the maintenance personal computer PC. The user information confirming means 44 accesses the credit company CR based on the credit number included in the received function addition request information and inquires about the credit of the user.

The key telephone unit connecting means 46 and the Key telephone unit answer receiving means 47 access the key telephone unit BT through the public network PNW based on the telephone number included in the received function addition request information, and receive the answer. The system ID requesting means and the system ID receiving means 48 transmit a request to transmit the system ID to the Key telephone unit BT, and receive the system ID from the key telephone unit BT.

The function information requesting means 49 and the function information receiving means 50 transmit a request to transmit the function information to the key telephone unit BT, and receive the function information from the key telephone unit BT. The requested function judging means 51 makes judgment upon whether the requested function addition is possible based on the received list of the function information. The additional function charge calculating means 52 calculates the charge of the additional function based on the list of functions.

The license code encrypting means 53 and the license code transmitting means 54 encrypt the license code by using the system ID acquired from the key telephone unit BT, and transmit the encrypted license code to the key telephone unit BT. The normal termination receiving means 55 receives a normal terminal signal transmitted from the key telephone unit BT after the function addition processing, and transmits the information indicative of reception of the signal to the maintenance personal computer PC. The charging means 56 transmits a bill of the charge precedent calculated in the function addition charge calculating means 52 to the credit company CR after receiving the normal terminal signal.

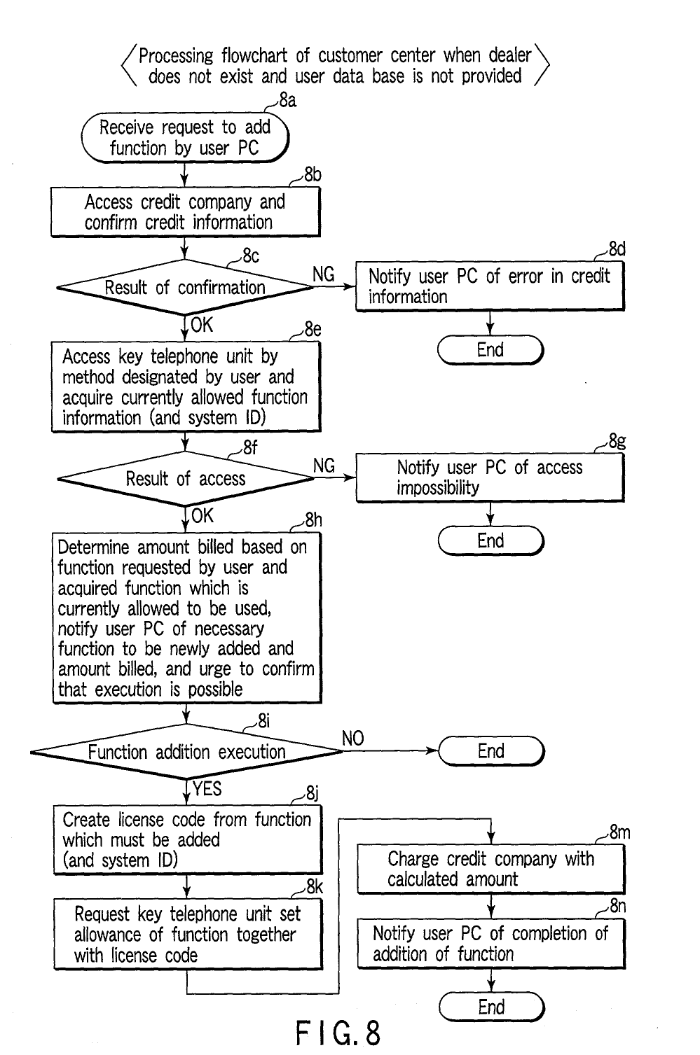

FIG. 8 is a flowchart showing the operation of the customer center CC, and the processing operation for adding the function is performed in accordance with the procedure indicated at steps 8a to 8n.

That is, upon receiving a request to add the function from the maintenance personal computer PC of the user through the Internet INW at the step 8a, the customer center CC first accesses the credit company CR and confirms the credit information at the step 8b. If the credit information can not be confirmed, the processing shifts from the step 8c to the step 8d, and the maintenance personal computer PC which has sent the request is informed of an error in the credit implementation information.

On the other hand, the credit information can be confirmed, the processing shifts from the step 8c to the step 8e, and the access is made to the key telephone unit BT of the user by using a telephone number or a mail address of the key telephone unit BT transmitted from the user in order to acquire information of the functions which are currently allowed to be used and the system ID from the key telephone unit BT. Incidentally, when the access can not be made, the processing shifts from the step 8f to the step 8g, and the user is informed of the fact that the access can not be made.

Subsequently, at the step 8h, the customer center CC calculates an amount billed based on the information of the function requested from the user and the function acquired from the key telephone unit BT, informs of the maintenance personal computer PC of the user of a name of the function to be newly added and the amount billed, and inquires whether execution is possible. When the user transmits a request for execution with respect to this inquiry, the customer center CC shifts from the step 8i to the step 8j, creates the license code based on the additional function and the system ID of the key telephone unit BT, and transmits a request for setting use of the license code and the function to be enabled with respect to the Key telephone unit BT at the step 8k.

Then, upon completing the setting for adding the function in the key telephone unit BT, the customer center CC transmits payment request information of the precedent calculated amount billed to the credit company CR at the step 8m. Further, when an answer informing of acceptance is returned with respect to the payment request from the credit company CR, the maintenance personal computer PC of the user who has sent the request is informed of completion of addition of the function at the step 8n.

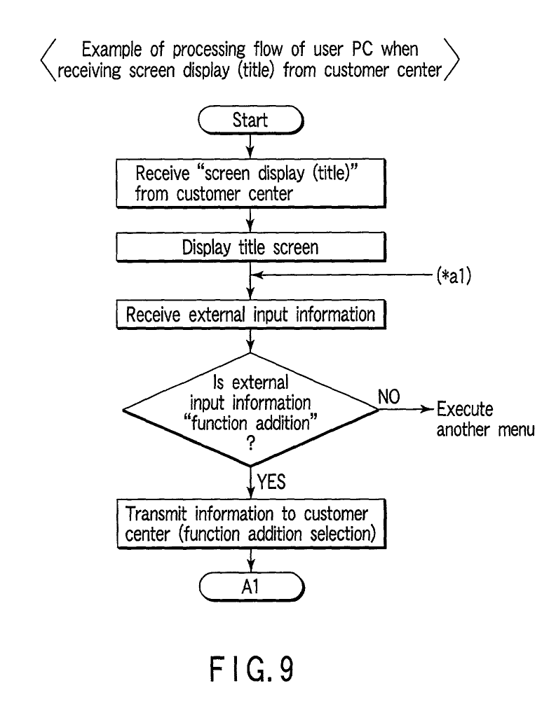

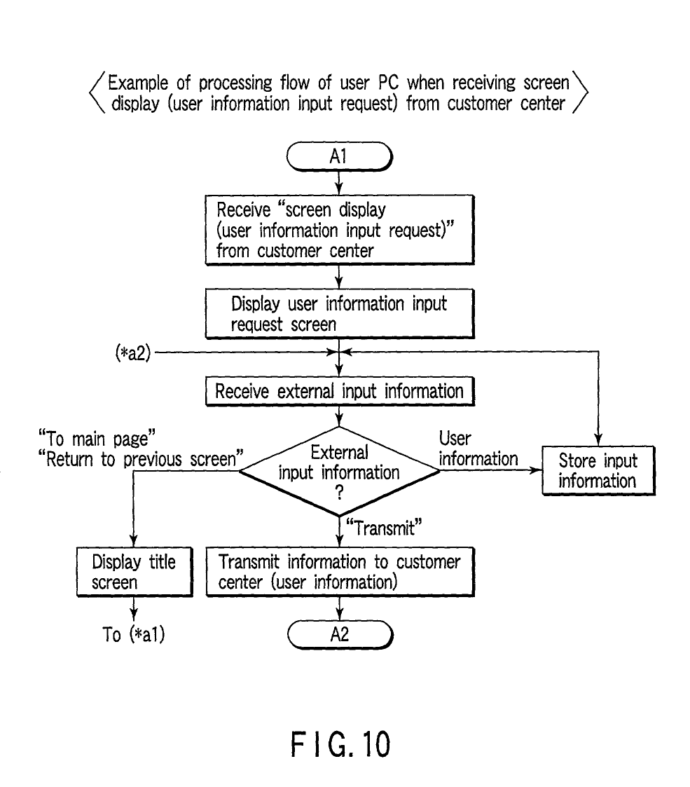

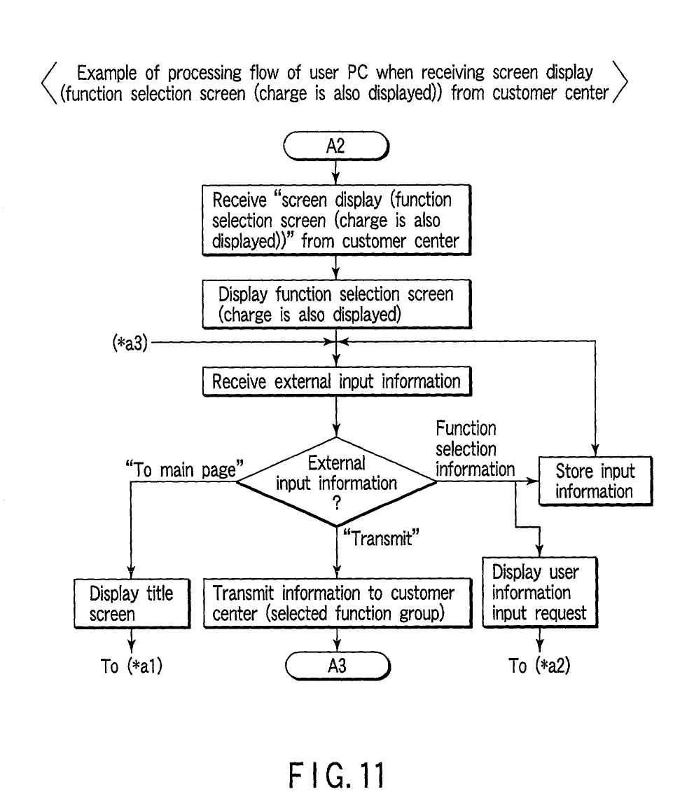

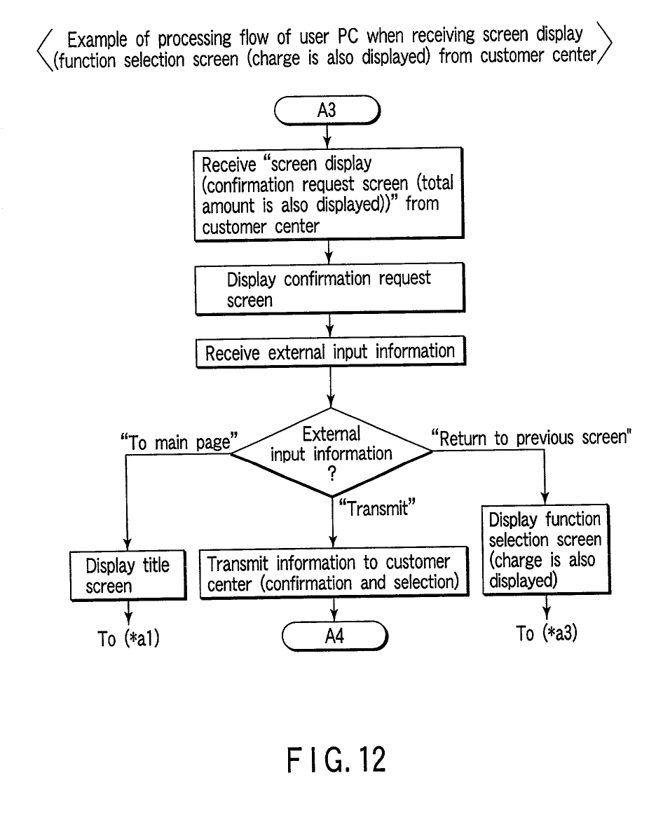

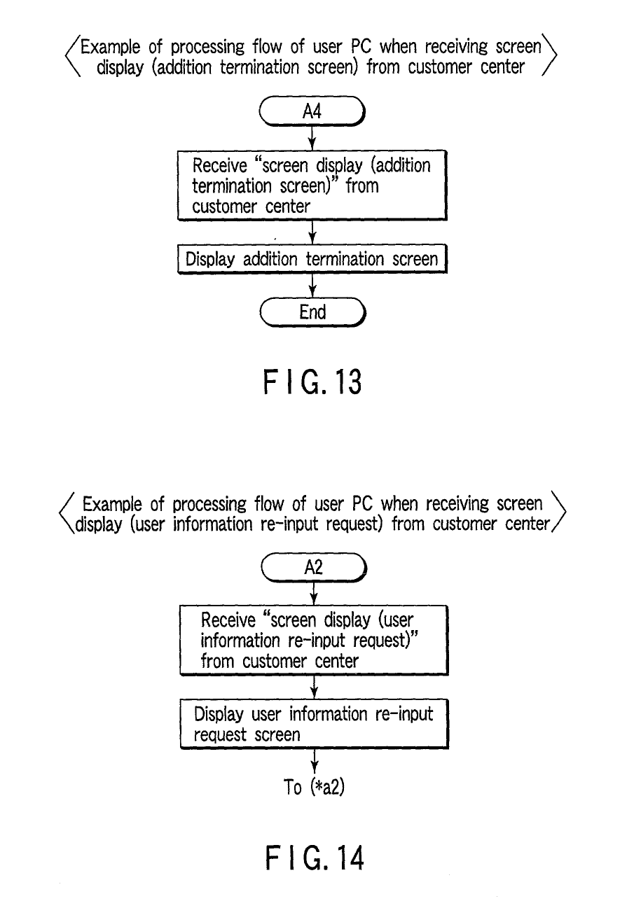

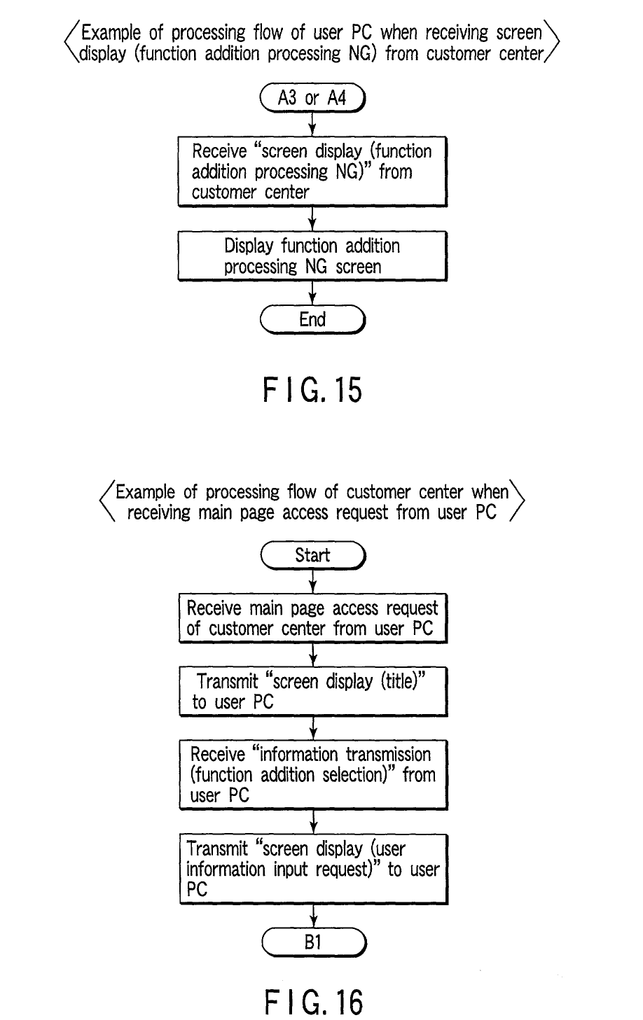

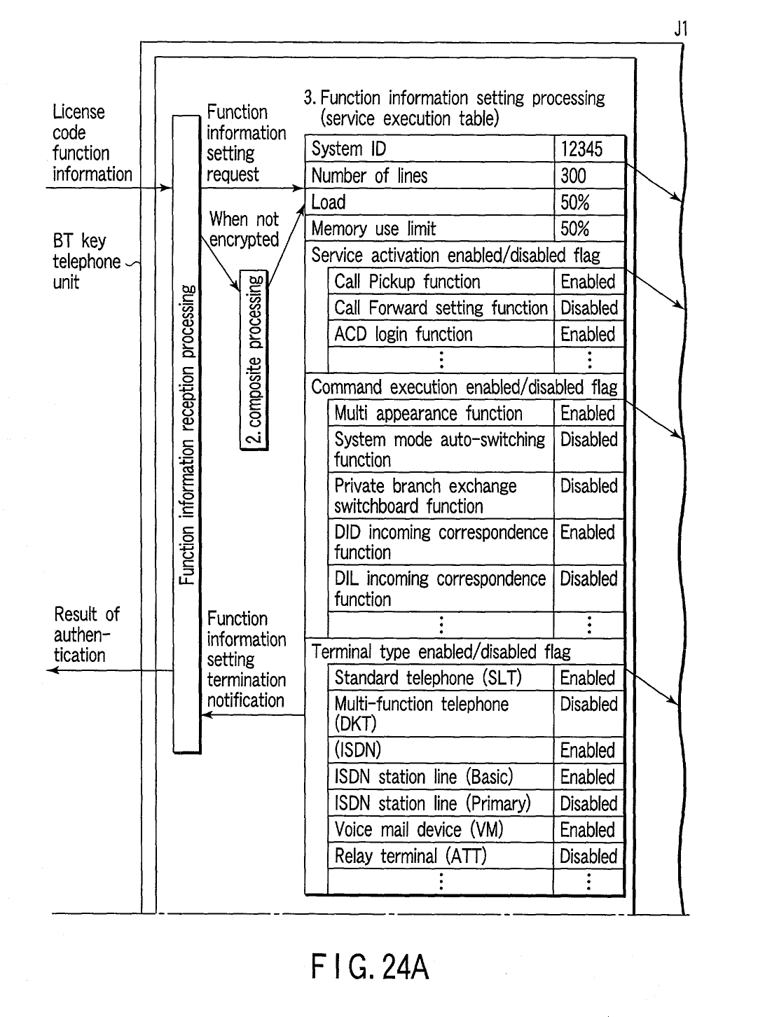

Incidentally, FIGS. 9 to 15 are flowcharts showing the processing procedure of the maintenance personal computer PC, and each figure shows the processing procedure when receiving a title screen (FIG. 22(1)), a user information input request screen (FIG. 22(2)), a function selection screen including the charge (FIG. 22(3)), a confirmation request screen (FIG. 22(4)), an addition termination screen FIG. 23(5)), a user information re-input screen and a function addition processing NG from the customer center CC during the function addition processing.

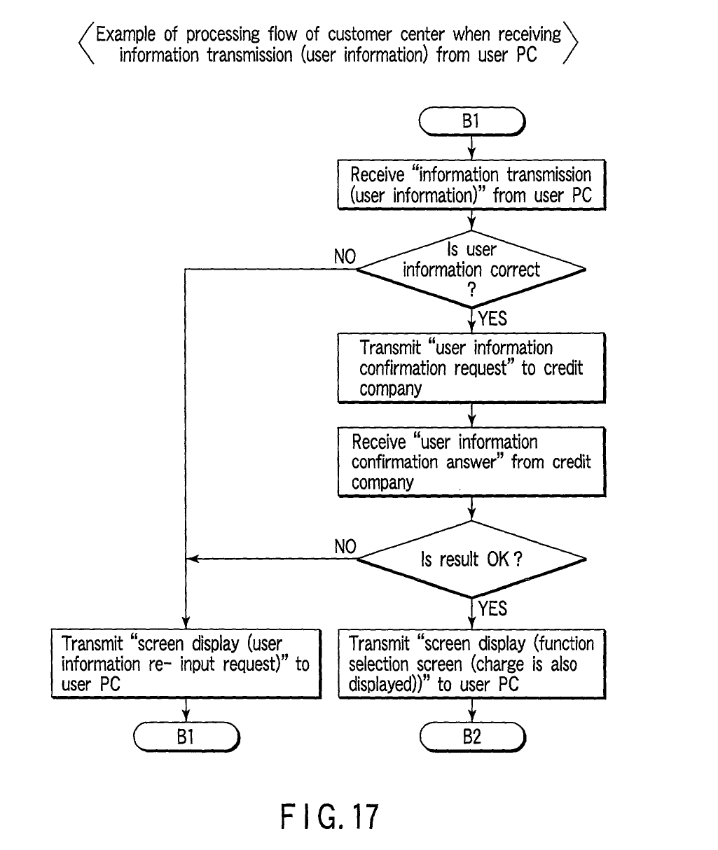

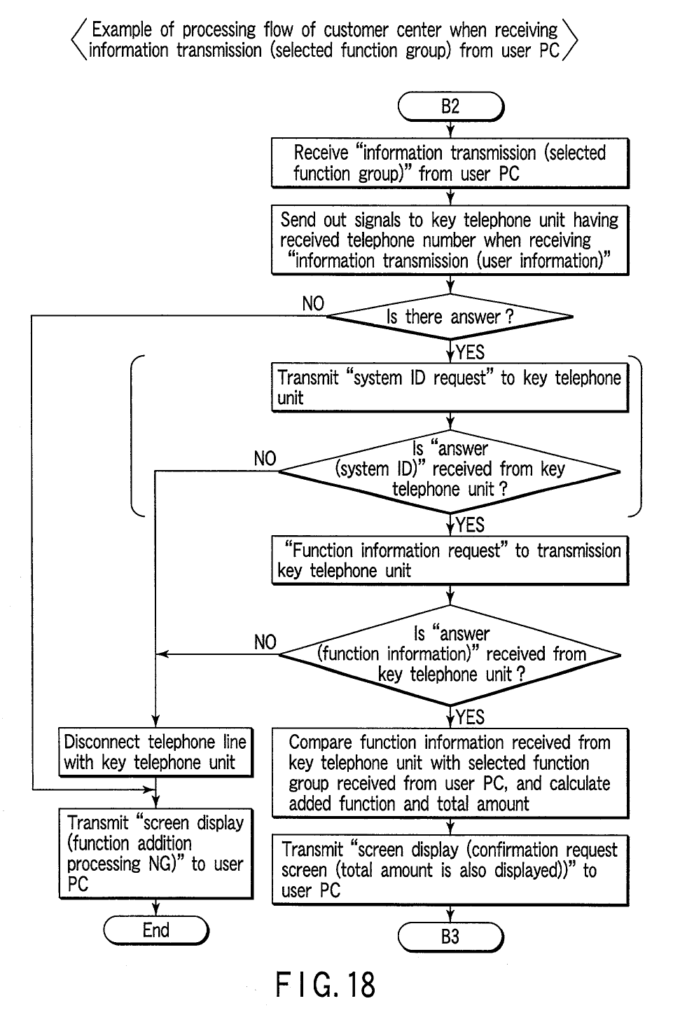

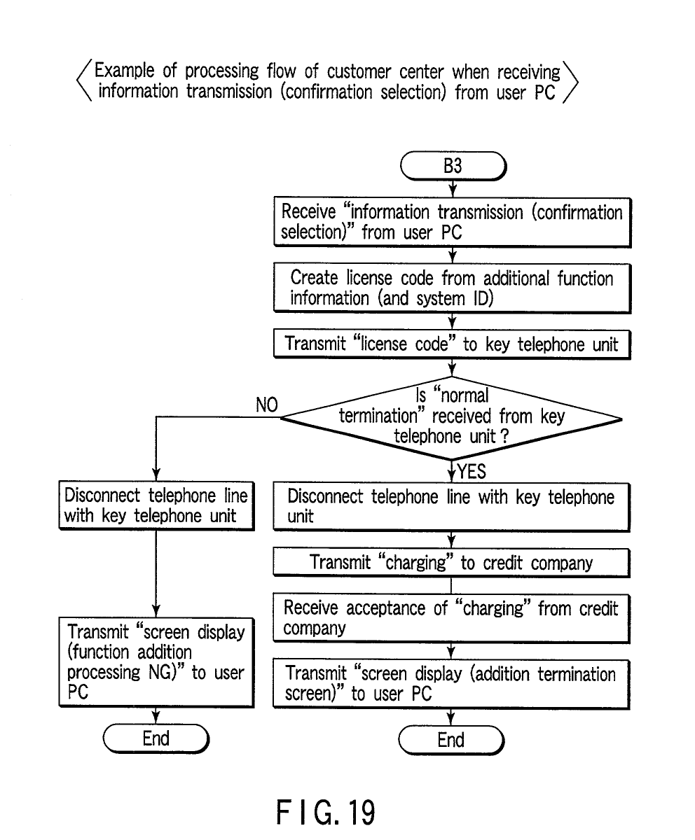

Furthermore, FIGS. 16 to 19 are flowcharts showing the detailed processing procedure of the customer center CC, and each shows the processing procedure when receiving a request of main page access of the customer center CC, user information, information of a selected function group and information for confirmation selection from the maintenance personal computer PC.

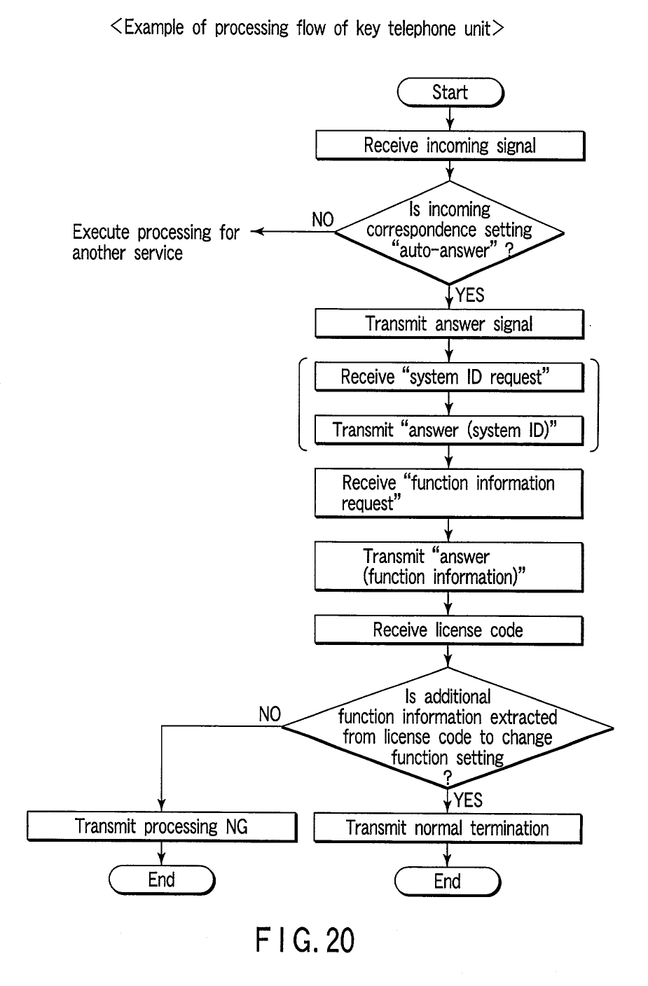

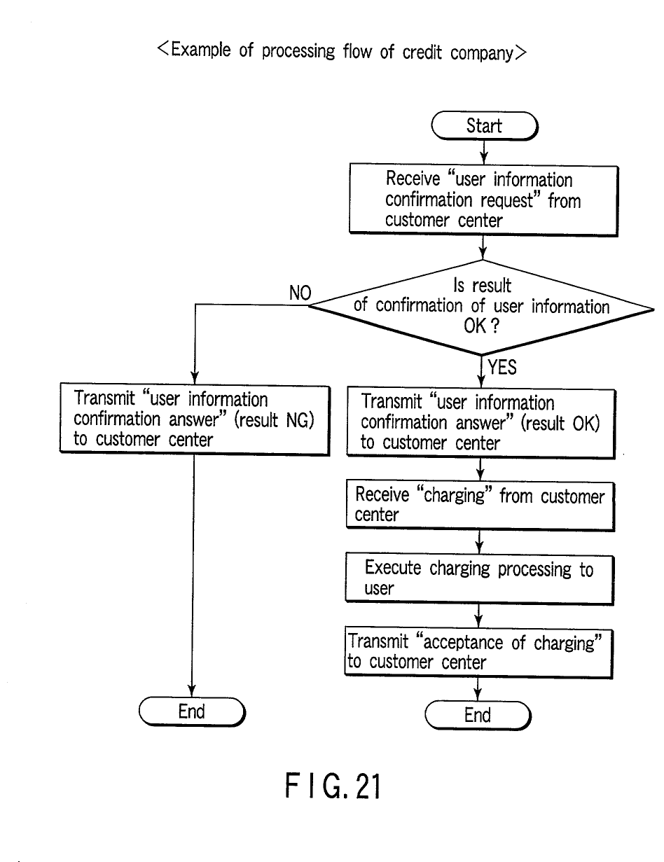

At In addition, FIGS. 20 and 21 are flowcharts showing the processing procedure of the key telephone unit BT and the credit company CR when executing the function addition processing, respectively.

Moreover, as described above, according to the function change method of the first embodiment, a series of procedures from transmission of the function addition request by the user to the function addition setting processing in the Key telephone unit of the user as well as the payment processing of the function addition charge can be all automatically carried out through the communication network without requiring the man power. Therefore, the change operation based on the business trip and the manual operation by a person responsible for the maintenance service and the charging operation for the cost by a person in charge of the charging operation are no longer necessary, and the user can add the function of his/her Key telephone unit BT with a small burden of the cost within a short period of time. On the other hand, the customer center CC can greatly reduce the labor and cost required for adding the function.

In addition, before executing the function addition processing with respect to the key telephone unit BT, the customer center CC accesses the key telephone unit BT, acquires its function information, namely, a list of functions which are currently set and functions which can be newly set, and makes judgment upon whether the function addition is possible based on this list. Thus, the appropriate function addition processing can be executed without any error in each key telephone unit BT, thereby performing the highly reliable function addition.

Additionally, when the license code is transferred from the customer center CC to the Key telephone unit BT, it is encrypted by using the system ID acquired from the Key telephone unit BT. Therefore, when the license code is accidentally transferred to a wrong Key telephone unit BT or even if another user tries to steal the license code which is to be transmitted to another Key telephone unit BT and add the function to his/her Key telephone unit BT, the wrong function addition or fraudulent function addition processing can be avoided.

Further, since a telephone number or the function information of the key telephone unit BT of the user is acquired from the user or the key telephone unit BT, there is no need to provide a user data base for storing and managing such user information, and user management can be thereby simplified, which leads to simplification of the system configuration.

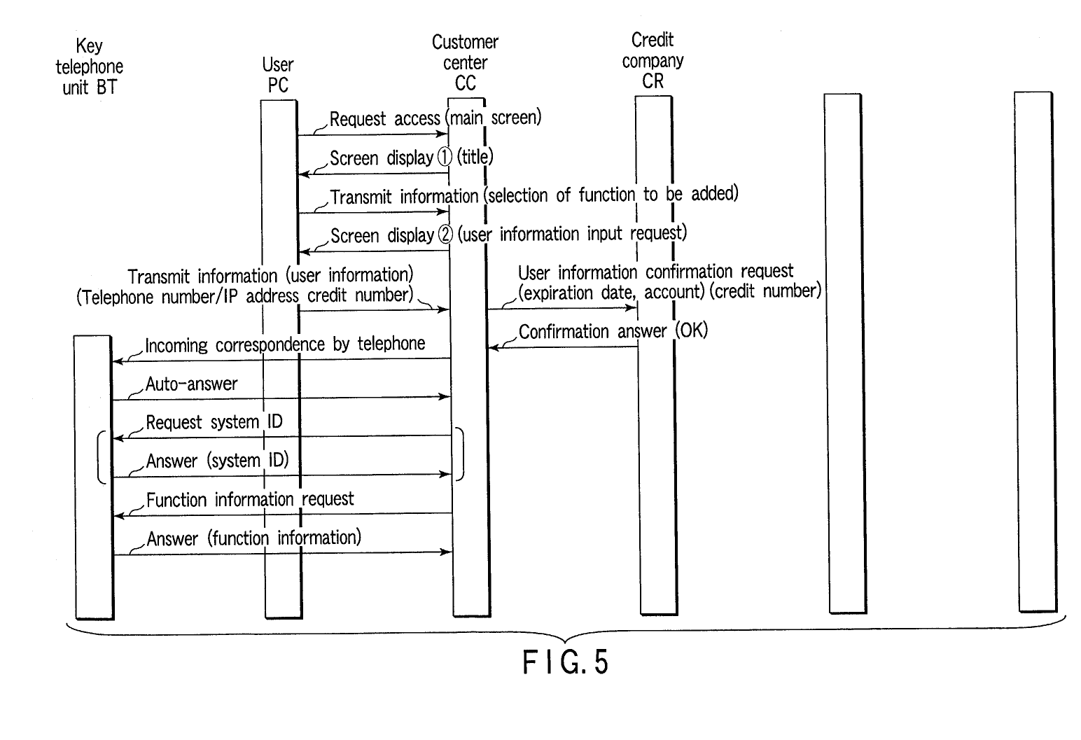

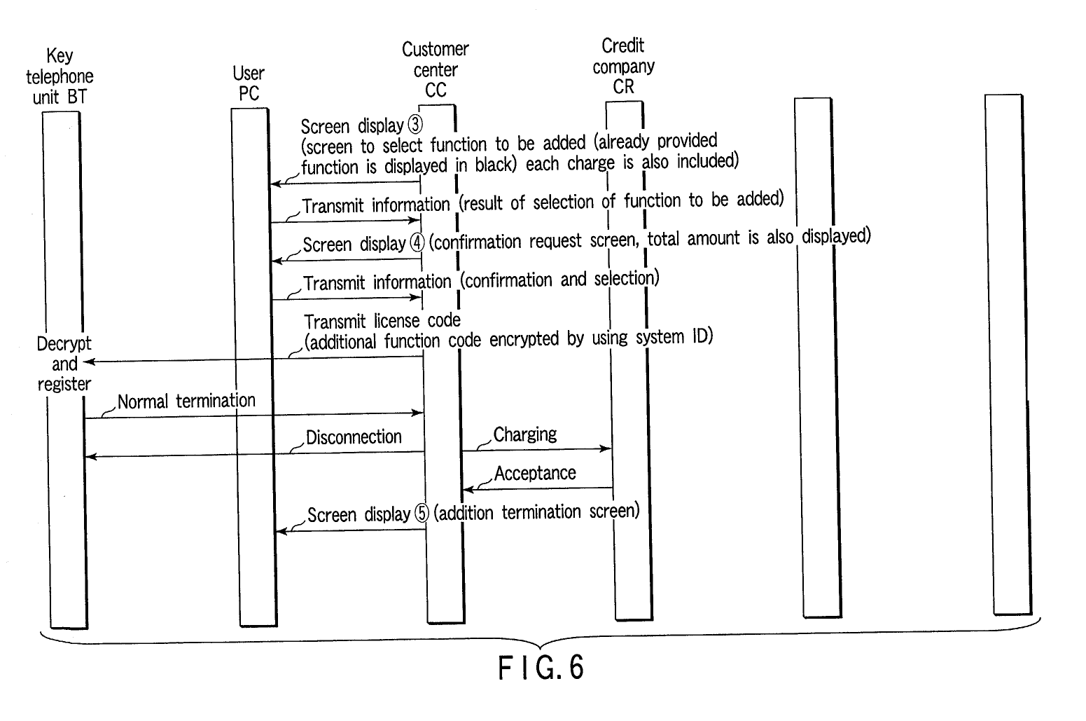

Incidentally, although the user designates and inputs a function to be added on an initial screen in the above description, the customer center CC may transfer to the user the function information acquired from the key telephone unit BT and cause him/her to display it, and the user may select and designate a function to be added after confirming the currently set functions and the functions which can be newly added based on the display information. FIGS. 5 and 6 show a sequence when executing the function change method by this procedure.

By doing so, the user can transmit a request to add the function after confirming the currently set functions and the functions which can be newly set in the key telephone unit BT, thereby constantly accurately requesting the function addition without any error.

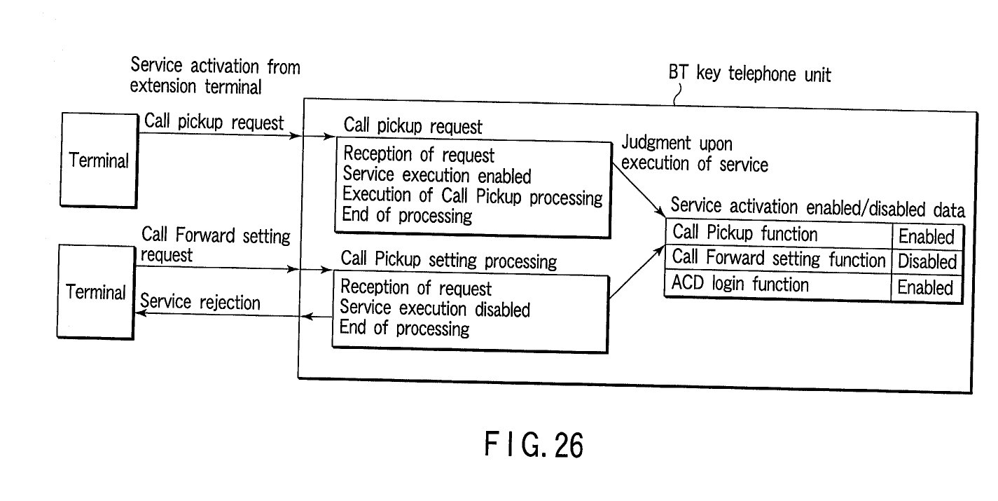

Meanwhile, various kinds of optional service functions of the key telephone unit BT which are added and set in the above-described manner are executed as follows. FIGS. 26 to 28 are views showing the outline of the operation.

That is, for example, when a call pickup request or a call forward setting request is transmitted from the extension terminal, the access is made to the service execution table shown in FIG. 24, and judgment is made upon whether the corresponding function is “enabled” or “disabled” based on an enabled/disabled flag corresponding to the call pickup function or the call forward setting function as shown in FIG. 26. Then, when the function is “enabled”, the request is accepted and the corresponding processing is executed. On the other hand, when the function is “disabled”, the service rejection is returned to the extension terminal which has sent the request.

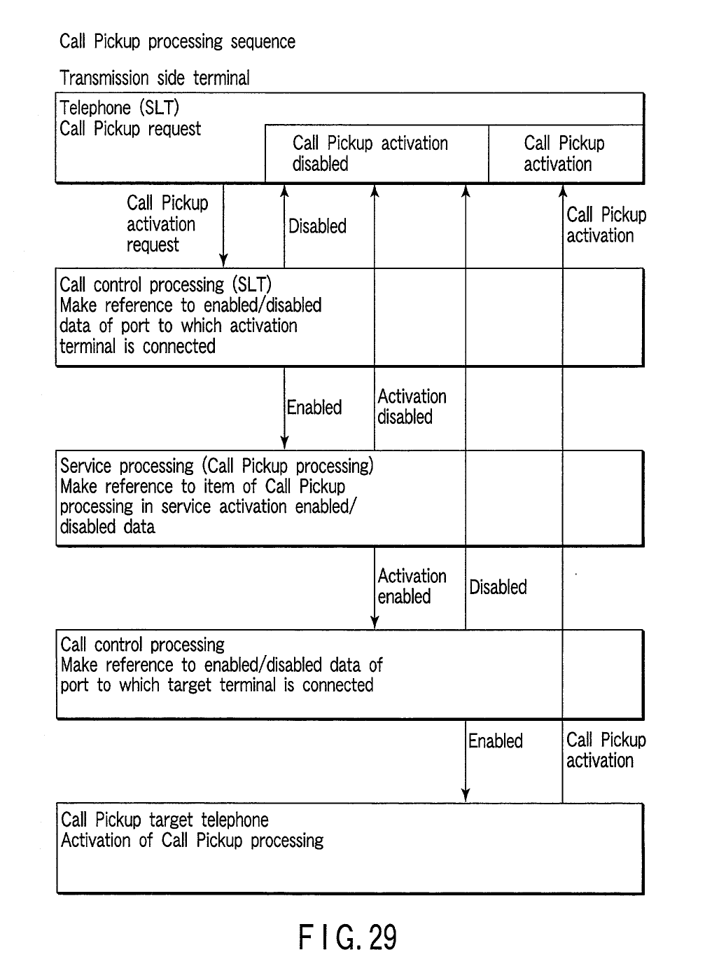

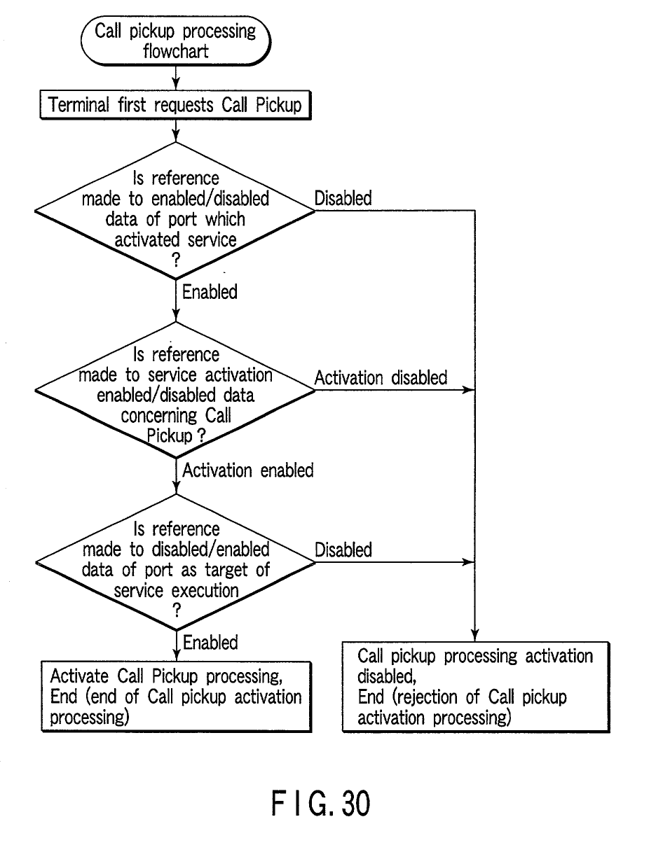

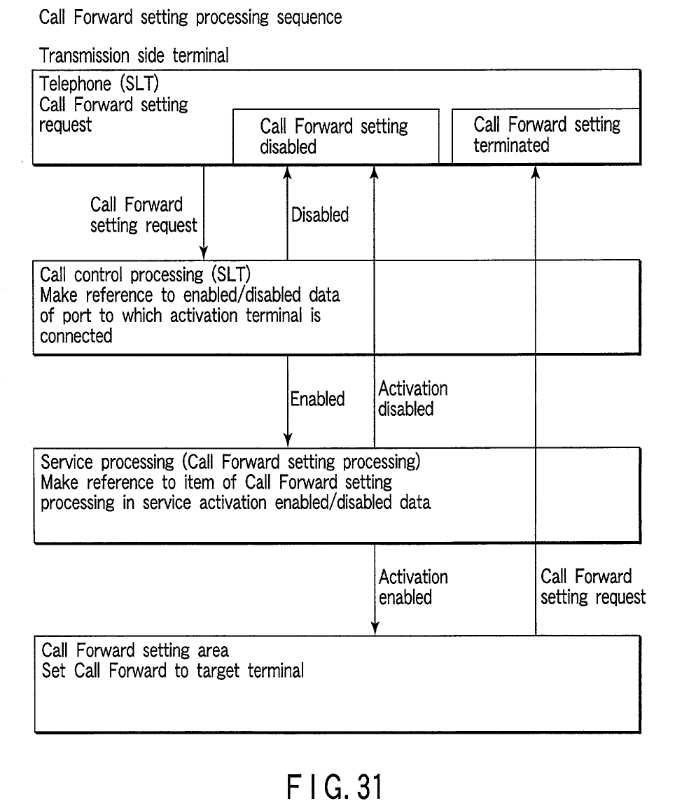

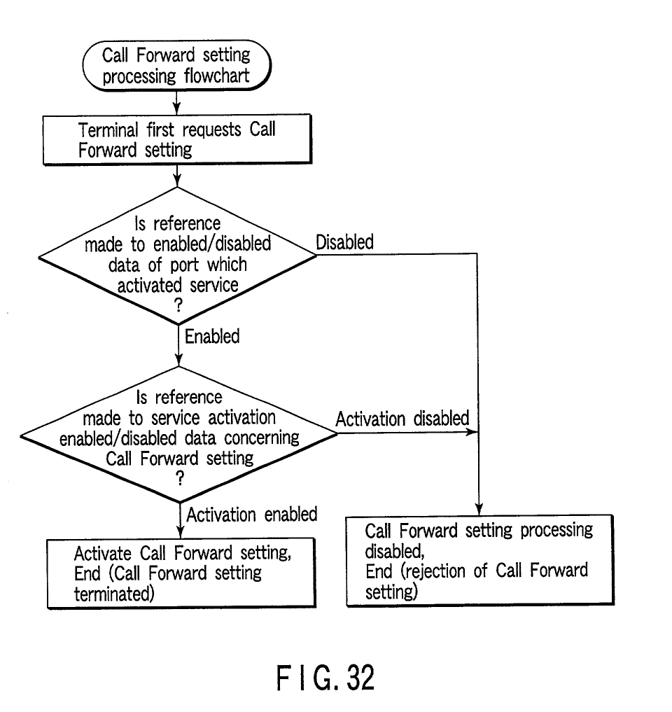

FIGS. 29 and 30 are a processing sequence diagram and a processing flowchart of the key telephone unit BT when the call pickup function is executed, and FIGS. 31 and 32 are a processing sequence and a processing flowchart of the key telephone unit BT when the call forward setting function is executed.

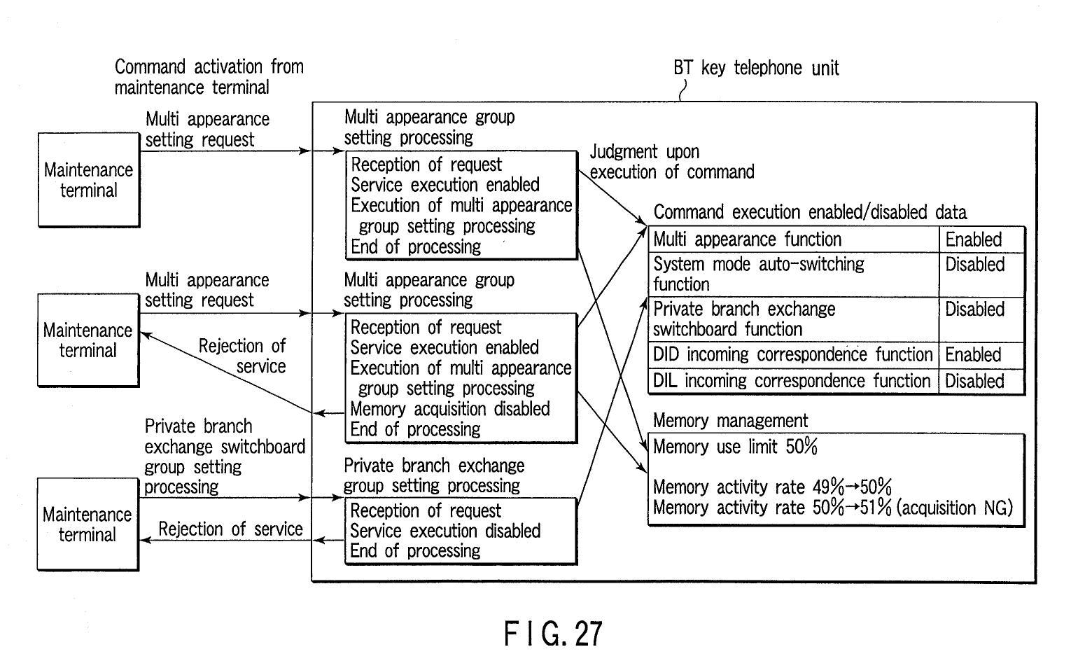

Furthermore, when a multi appearance setting request or a private branch exchange switchboard group setting request is transmitted from the maintenance terminal, i.e., the maintenance personal computer PC, the access is made to the service execution table, and judgment is made upon whether the corresponding function is “enabled” or “disabled” based on the enabled/disabled flag corresponding to the multi appearance function or the private branch exchange switchboard function as shown in FIG. 27. Then, when the function is “enabled”, the request is accepted, and the corresponding processing is executed. On the other hand, when the function is “disabled”, the service rejection is returned to the extension terminal which has sent the request.

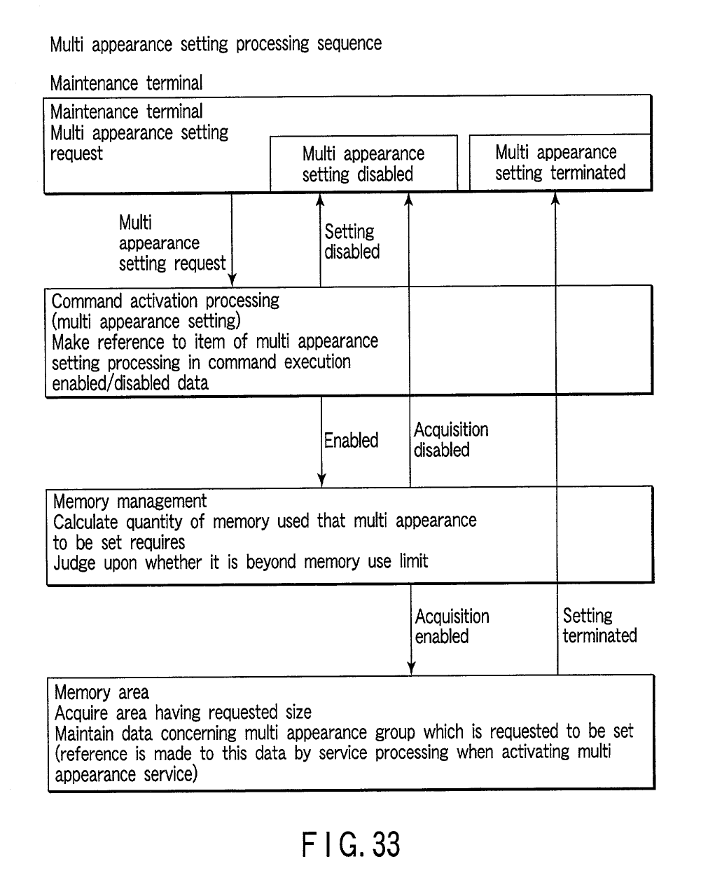

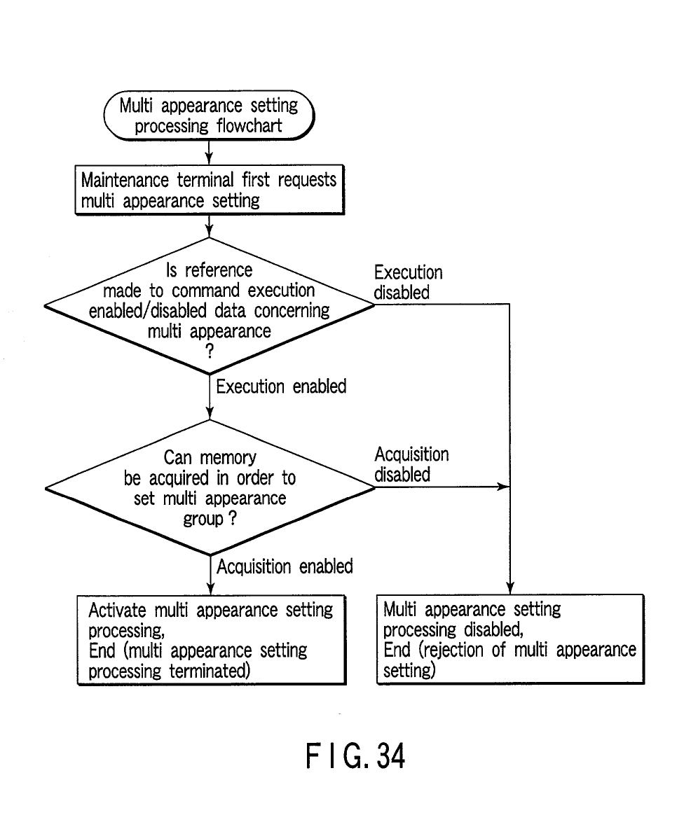

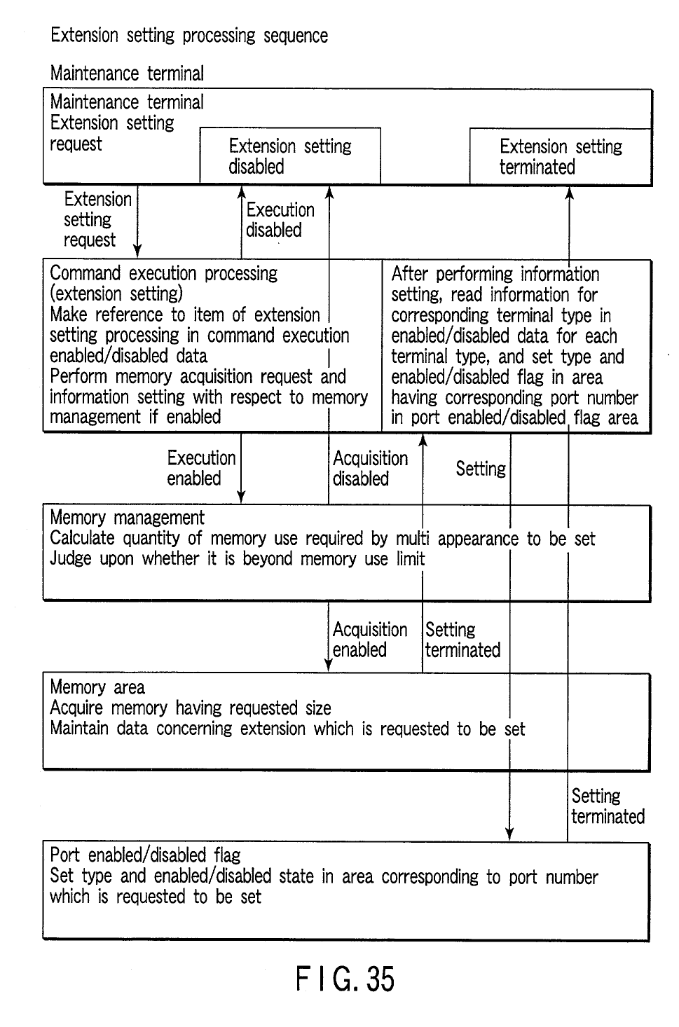

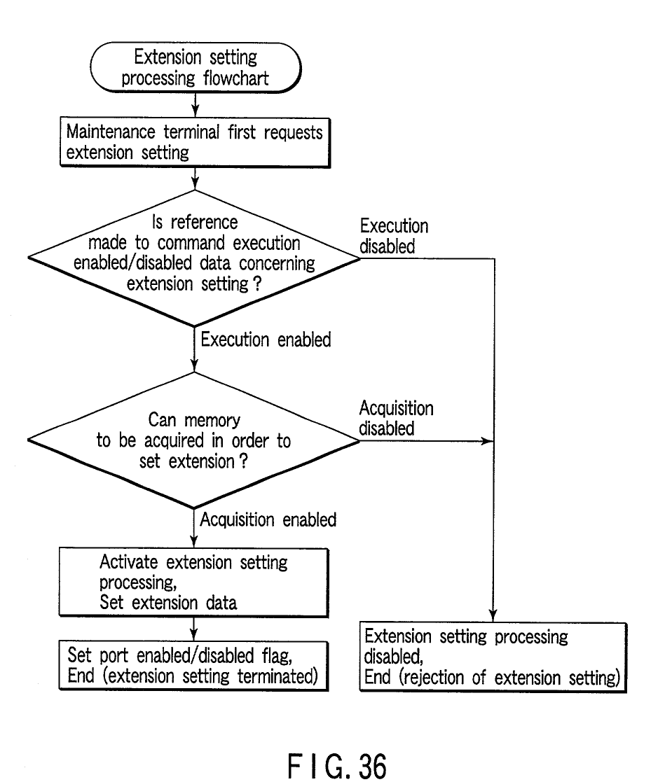

FIGS. 33 and 34 show a processing sequence and a processing flowchart of the key telephone unit BT when executing the multi appearance function, and FIGS. 35 and 36 show a processing sequence and a processing flowchart of the key telephone unit BT when executing the extension setting function.

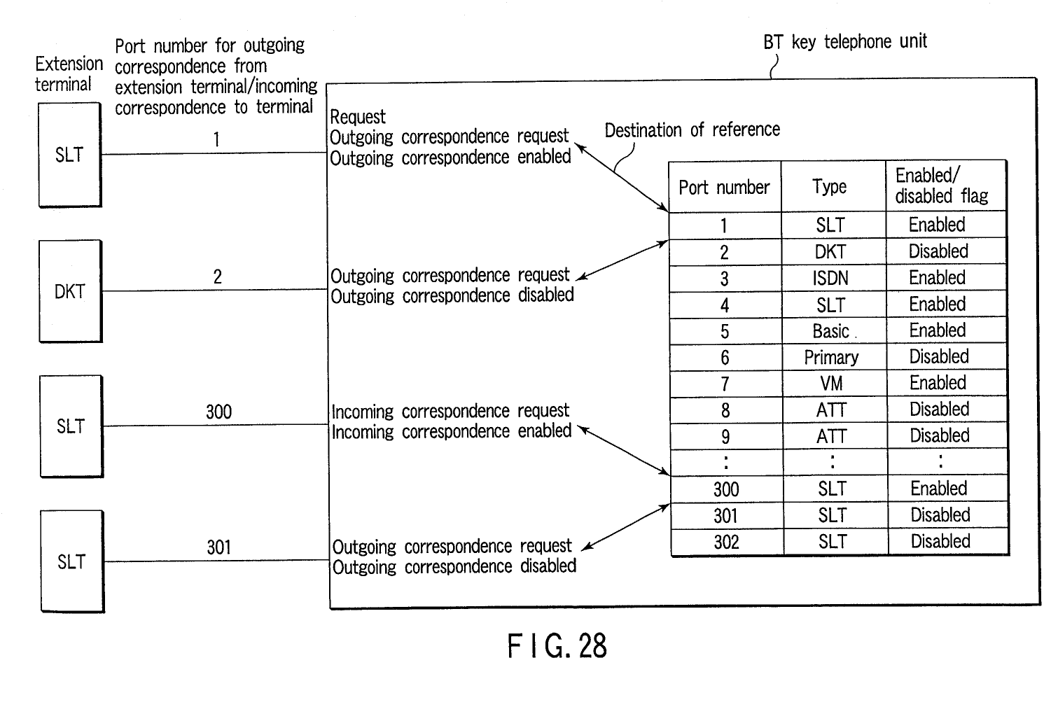

Moreover, when an outgoing correspondence request from the extension terminal (SLT) or an incoming correspondence request to the extension terminal arrives, as shown in FIG. 28, the Key telephone unit BT makes judgment upon whether a port at which the outgoing correspondence request has arrived or a port as a destination of the incoming correspondence can be used based on a port enabled/disabled flag provided to the function information storage area shown in FIG. 25. In addition, if it is determined that the port can be used as a result of judgment, the outgoing correspondence request or the incoming correspondence request is accepted, and the corresponding outgoing correspondence processing or incoming correspondence processing is executed. On the other hand, the port can not be used, information of the outgoing correspondence disabled or the incoming correspondence disabled is returned with respect to the outgoing correspondence request or the incoming correspondence request.

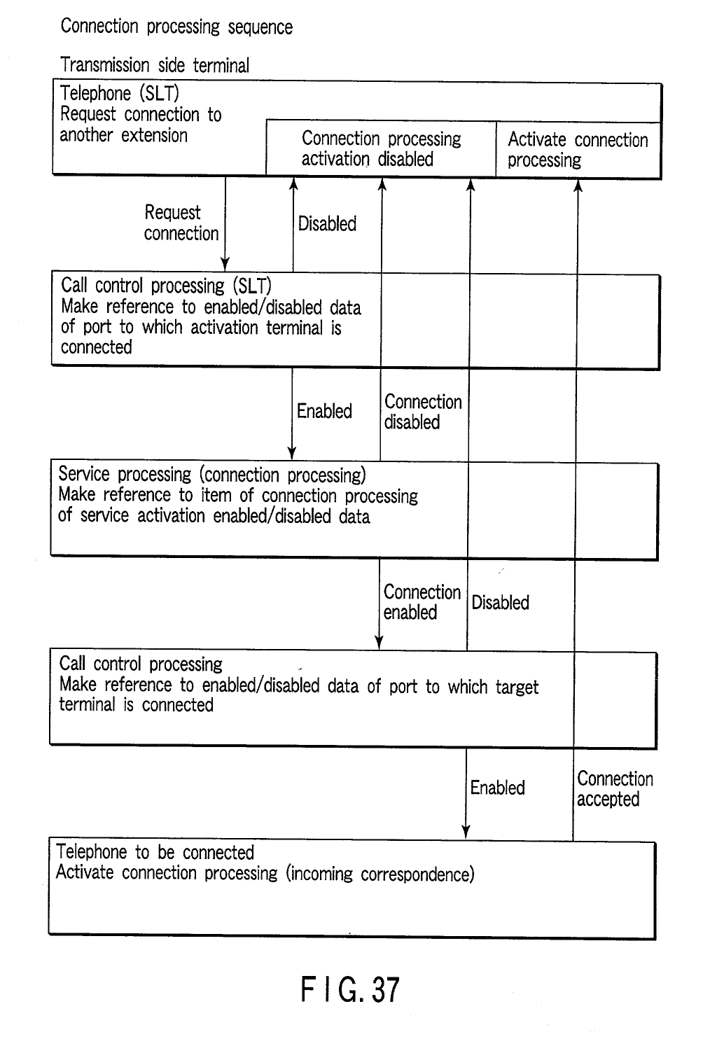

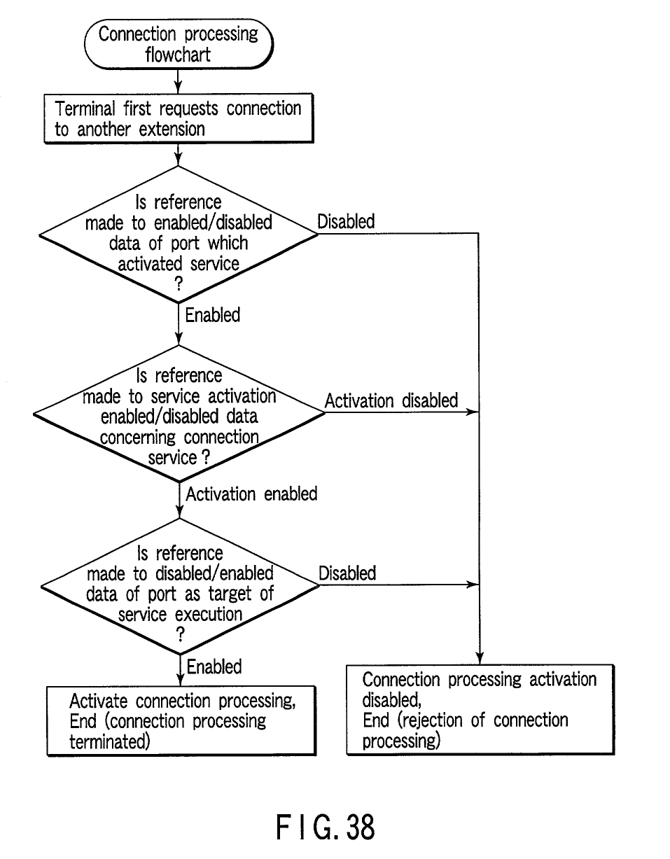

FIGS. 37 and 38 show a processing sequence and a processing flowchart of the Key telephone unit BT when executing the connection processing corresponding to the outgoing correspondence request or the incoming correspondence request.

(Second Embodiment)

According to the second embodiment of the function change method relation to the present invention, said user system directly accesses the customer center, and utilizes a user data base provided to the customer center, thereby performing the function addition processing with respect to the key telephone unit of said user system.

That is, the user transmits information indicative of a function to be added, a user identification information (user ID) and a function addition request including a credit number to the customer center by using the maintenance personal computer. The customer center accesses the credit company and carries out the credit research of the user based on the credit number included in the function addition request. Thereafter, the customer center accesses the user data base based on the user identification information included in the function addition request, and reads a system ID, function information and a telephone number of the key telephone unit of the user. Then, the customer center makes judgment upon whether a function requested by the user can be added based on the function information. If addition is possible, the customer center calls the Key telephone unit through the public network based on the telephone number, transmits a license code of the function to be added, and adds and sets that function.

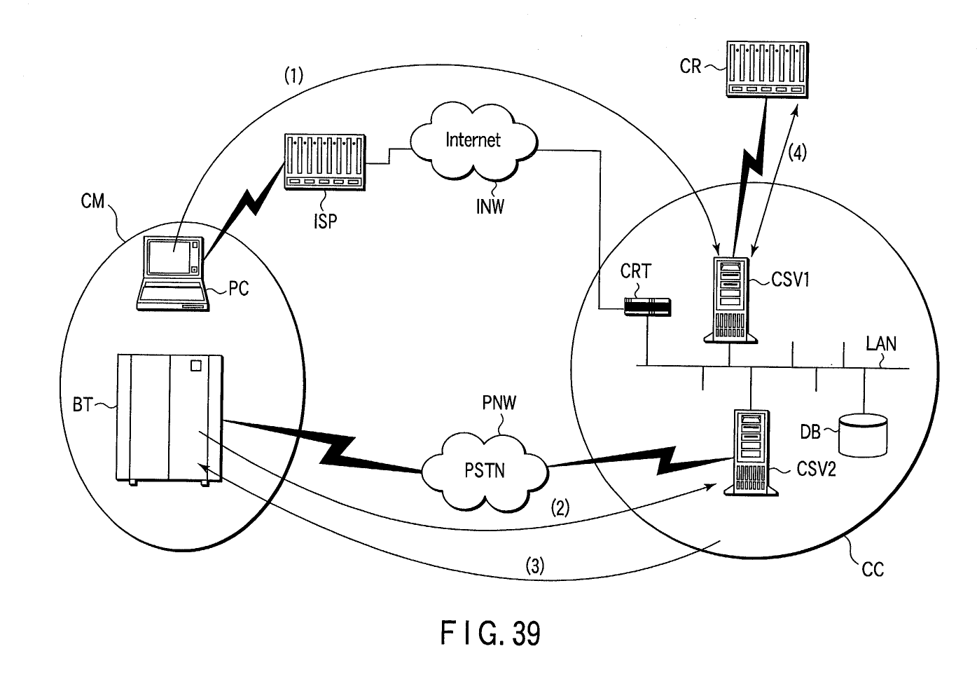

FIG. 39 is a schematic structural view showing a support system which realizes the first embodiment. It is to be noted that, in this drawing, like reference numerals denote parts similar to those in FIG. 1, thereby omitting the detailed explanation.

A user data base DB is provided to the customer center CC. The user data base DB stores therein a system ID, function information and a telephone number of the key telephone unit BT owned by the user in association with an individual identification number (user ID) allocated to each user.

When a function addition request arrives from the user, an acceptance/charging server CSV1 or a license server CSV2 of the customer center CC accesses the user data base DB based on a user ID included in the function addition request, and reads a system ID, function information and a telephone number of the key telephone unit BT owned by the user. Then, the server makes judgment upon whether the function desired by the user can be added, accesses the key telephone BT and transmits the license code by using the read information.

The procedure when adding the function to the key telephone unit BT in the above-described system will now be described.

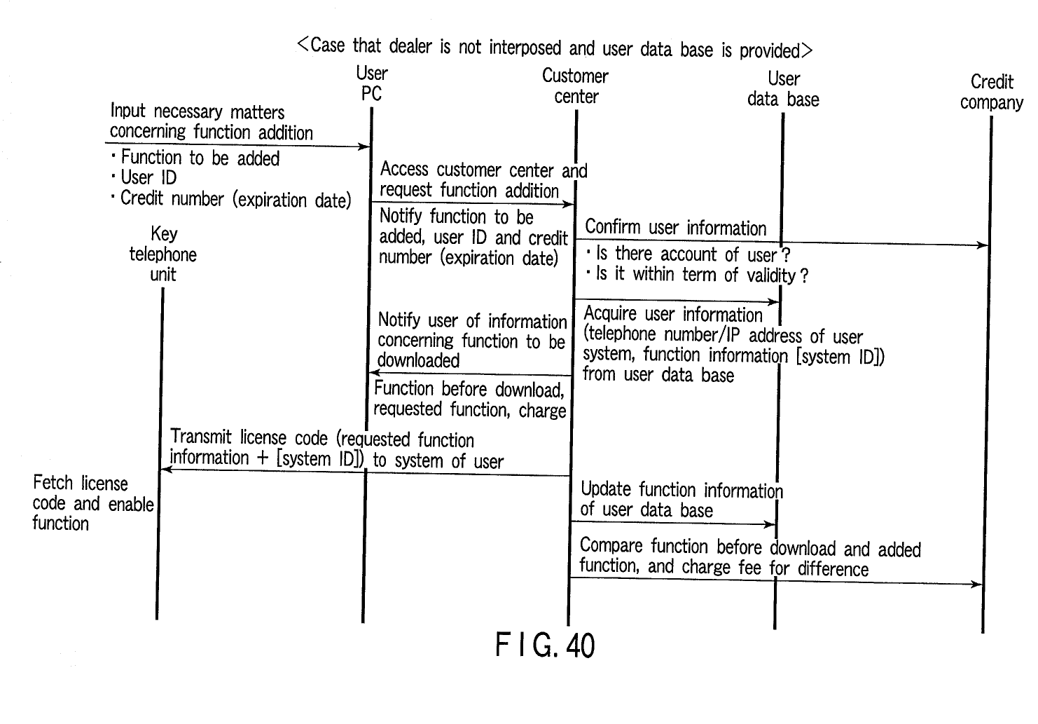

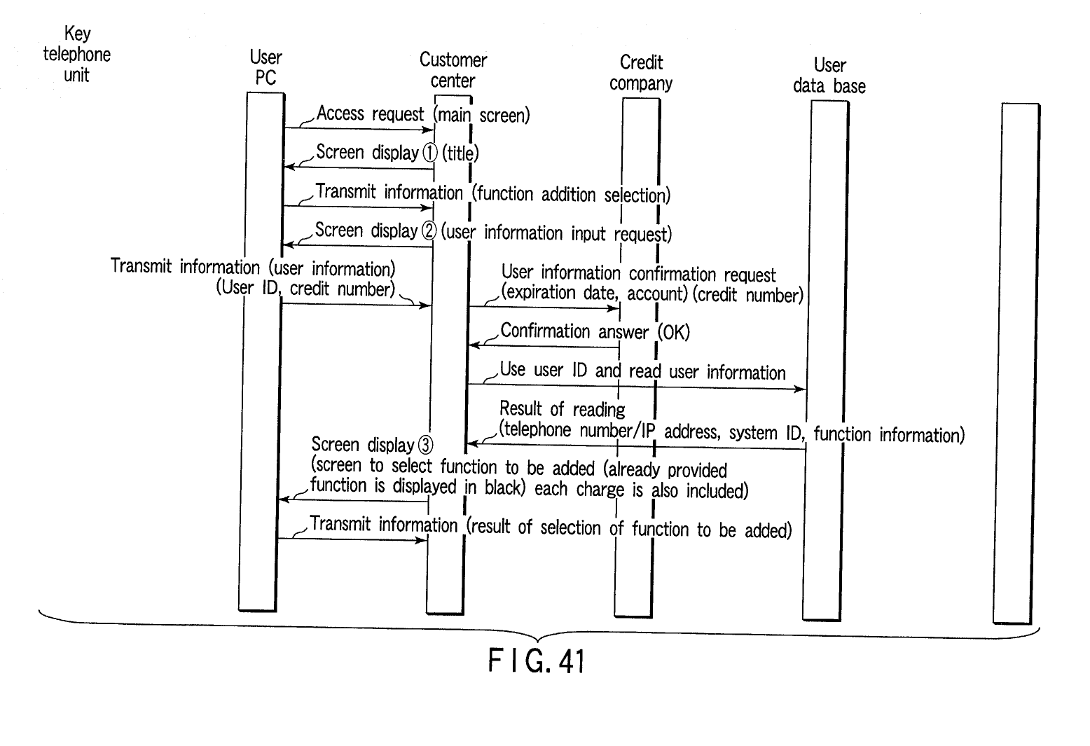

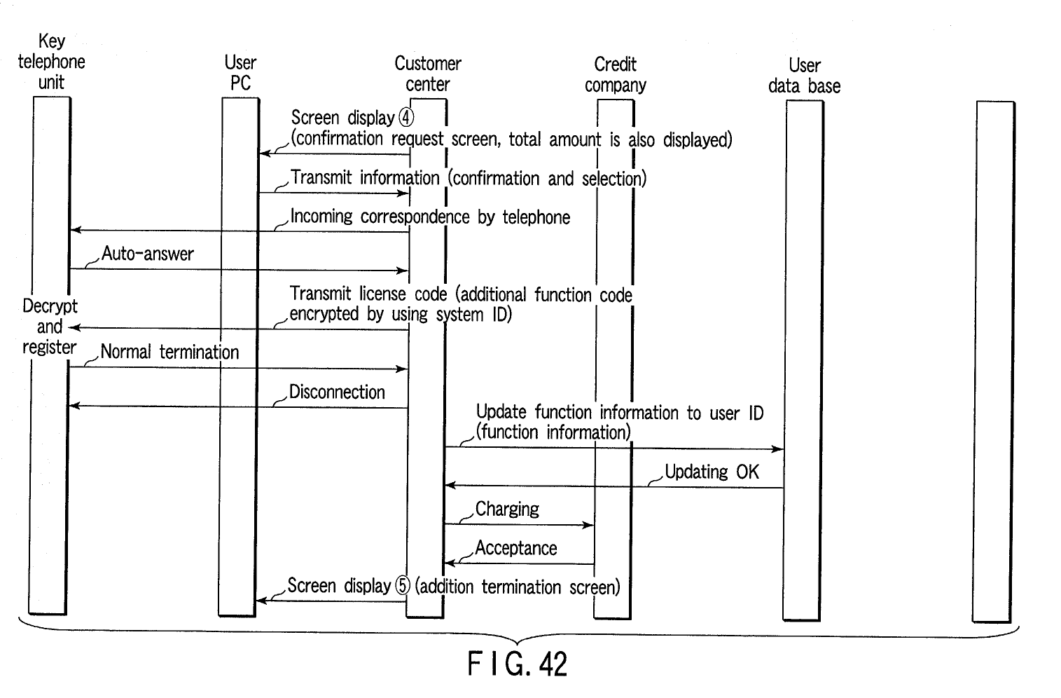

FIG. 40 is a schematic sequence diagram showing the operation for communicating a signal between the maintenance personal computer PC of said user system CM (user PC), the customer center CC and the credit company CR, and FIGS. 41 and 42 are detailed sequence diagrams of FIG. 40.

When adding the function of the key telephone unit BT, the user accesses a web page of the customer center CC through the Internet INW by using the maintenance personal computer PC, and inputs necessary matters concerning the function addition in accordance with the guidance on the screen downloaded from the customer center CC. The necessary matters to be inputted are information indicative of the function to be added, a user ID and a credit number. Moreover, upon completing input of these necessary matters, a function addition request including such information is transmitted to the customer center CC.

When the customer center CC receives the function addition request, it accesses the credit company CR through the dedicated line, and inquires about the credit of the user based on the credit number of the user. In response to this inquiry, the credit company CR makes judgment upon whether there is an account corresponding to the credit number, whether the expiration date of the credit is within the term of validity, and whether suspension of use is set. Then, the answer is returned to the customer center CC.

The customer center CC makes judgment upon the credit of the user based on the answer from the credit company CR. If there is no problem, the customer center CC accesses the user data base DB based on the user ID included in the function addition request transmitted from the user, and reads a system ID, function information and a telephone number of the key telephone unit owned by the user. In addition, the customer center CC makes judgment upon whether the function requested by the user can be added based on the function information, and transmits a result of judgment, a function which has been already enabled, a function which is requested to be added, and the charge to the maintenance personal computer PC of the user.

Additionally, upon receiving the confirmation response from the user with respect to this notification, the customer center CC accesses the key telephone unit BT of the user through the public network PNW based on the telephone number read from the user data base DB, and transmits the license code to the key telephone unit BT. An instruction code used for setting the function to be added to “enabled” is inserted into the license code. At this moment, the instruction code is encrypted by using the system ID read from the user data base DB.

When the key telephone unit BT receives the license code from the customer center CC, the key telephone unit BT first decrypts the instruction code included in the license code by using its system ID. Then, the key telephone unit BT changes a flag of the corresponding function in the function information setting processing table from “disabled” to “enabled” in accordance with the decrypted instruction code. Further, when the processing for setting the function addition is terminated, the key telephone unit BT returns to the customer center CC information indicating that the function addition processing has been normally terminated.

Upon receiving the function addition termination notification from the key telephone unit BT, the customer center CC disconnects the line between itself and the key telephone unit BT, and thereafter accesses the user data base DB in order to update the information of the function, which has been added and set, to “enabled”. Furthermore, when the updating termination notification is received from the user data base DB, the customer center CC accesses the credit company CR through the dedicated line, and requests the credit company CR to perform payment for the function addition charge. Subsequently, when the answer informing that the payment request has been accepted is received from the credit company CR, the customer center CC transmits information indicating that the function addition processing has been terminated to the maintenance personal computer PC of the user and causes it to display the information.

In this manner, the function which is desired to be added by the user is set to be enabled state in the key telephone unit BT, and thereafter the key telephone unit BT of the user can use the newly added optional service function.

It is to be noted that the structure of each part of the support system which realizes the above-described function change method is as follows.

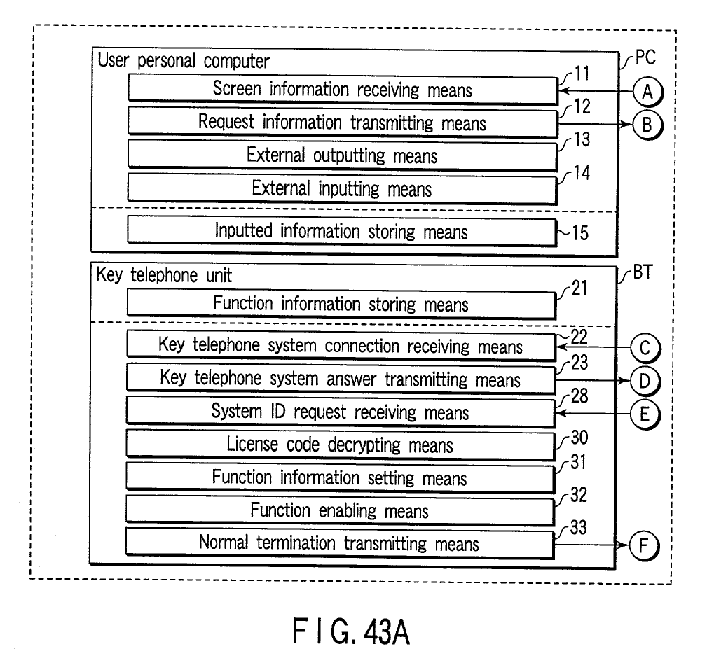

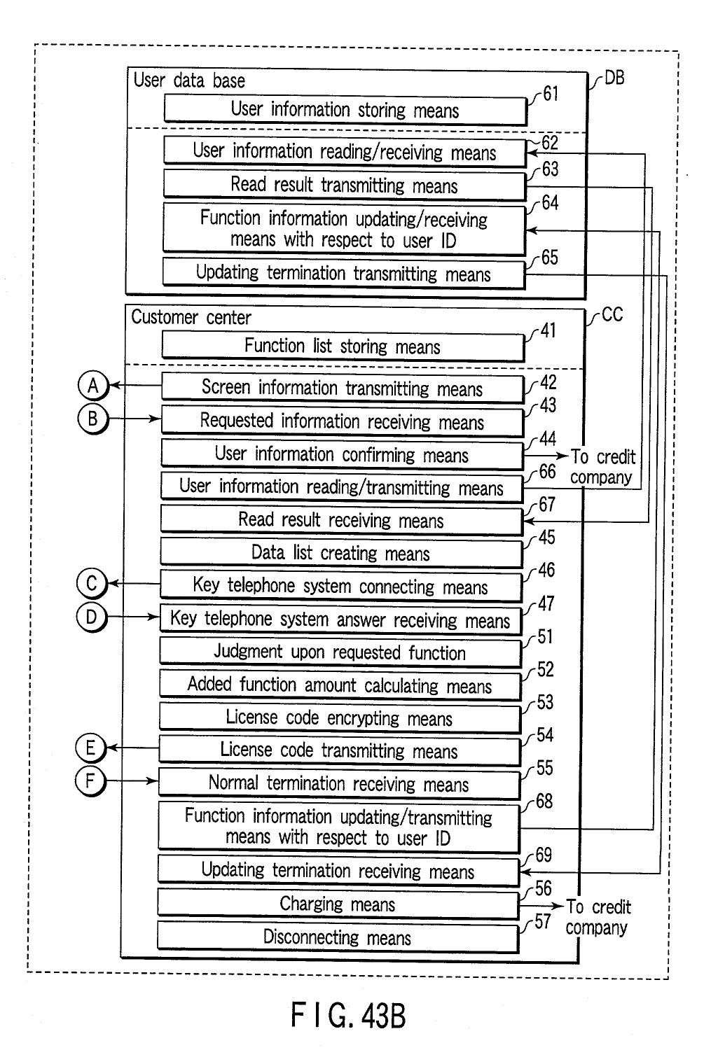

FIG. 43 is a block diagram showing the function configuration of the maintenance personal computer PC, the key telephone unit BT, the customer center CC and the user data base DB. Incidentally, in the drawing, like reference numerals denote parts equal to those in FIG. 7, thereby omitting the detailed explanation.

The user data base DB includes: user information storing means 61; user information reading/receiving means 62; read result transmitting means 63; function information updating/receiving means 64; and updating termination transmitting means 65.

Among these means, the user information storing means 61 stores therein a system ID, function information and a telephone number of the key telephone unit BT owned by each user in association with a unique user ID for that user. The user information reading/receiving means 62 and the read result transmitting means 63 read the corresponding stored information in accordance with the access from the acceptance/charging server CSV1 or the license setting server CSV2, and return the read stored information to the acceptance/charging server CSV1 or the license setting server CSV2 which has made the access.

The function information updating/receiving means 64 and the updating termination transmitting means 65 update the corresponding function information in accordance with the access from the license setting server CSV2 when setting of the function addition relative to the key telephone unit BT is terminated. Then, they return the updating termination to the license setting server CSV2.

To the customer center CC are newly provided user information reading/transmitting means 66 which makes access to the user data base DB, read result receiving means 67, function information updating/transmission controlling means 68, and updating termination receiving means 69.

The user information reading/transmitting means 66 and the read result receiving means 67 access the user data base DB with the user ID as an address, and receive the stored information read from the user data base DB in accordance with this access. The function information updating/transmission controlling means 68 and the updating termination receiving means 69 update the stored information by giving the changed function information to the user data base DB and receive the updating termination notification after completion of setting of the function addition with respect to the key telephone unit BT.

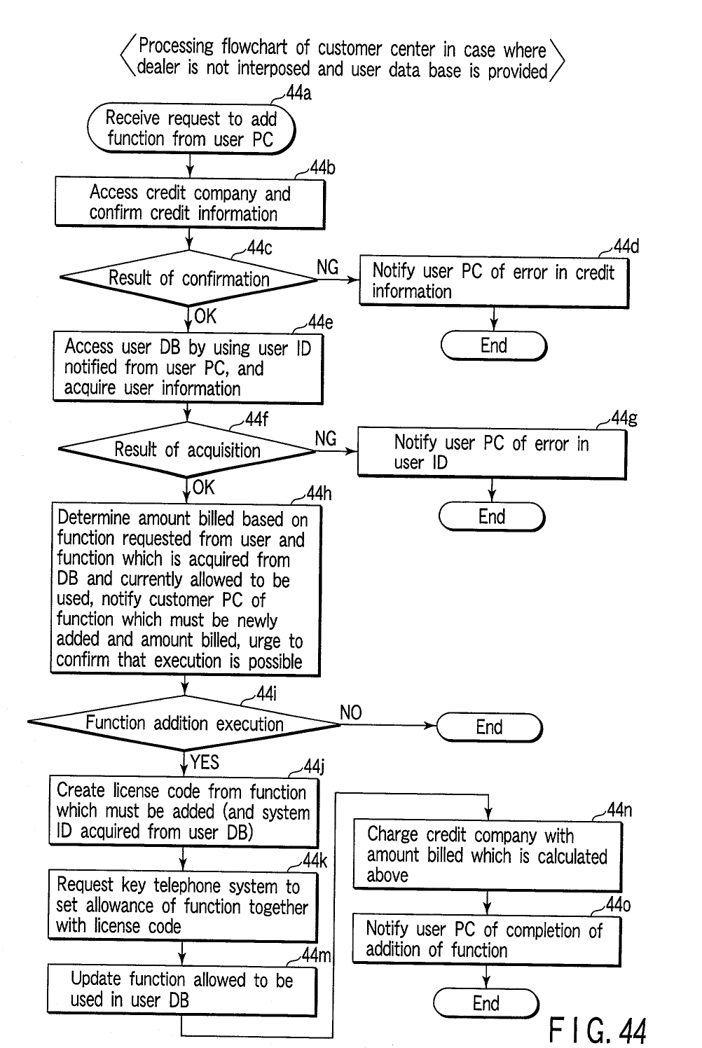

FIG. 44 is a flowchart showing the operation of the customer center CC, and the processing operation for the above-described function addition is carried out in accordance with the procedure indicated at steps 44a to 44o.

That is, when the customer center CC receives a request of the function addition from the maintenance personal computer PC of the user through the Internet INW at the step 44a, it first accesses the credit company CR and confirms the credit information at the step 44b. Then, if the credit information can not be confirmed, the processing proceeds from the step 44c to the step 44d, and the customer center CC notifies the maintenance personal computer PC, which has sent the request, of an error in the credit implementation information.

On the other hand, if the credit information can be confirmed, the processing proceeds from the step 44c to the step 44e, and the customer center CC accesses the user data base DB based on the user ID transmitted from the maintenance personal computer PC of the user and acquires the user information. The user information includes the function information of the Key telephone unit owned by the user. Incidentally, if the access can not be made as a result of an attempt of access, the processing proceeds from the step 44f to the step 44g, and the user's maintenance personal computer PC is informed of an error in the user ID.

Subsequently, at the step 44h, the customer center CC calculates an amount billed based on the function requested from the user and the function information read from the user data base DB, notifies the user's maintenance personal computer PC of a name of the function to be newly added and the amount billed, and inquires if the customer center CC can execute the processing. When the user transmits a request of execution with respect to this inquiry, the customer center CC advances from the step 44i to the step 44j, creates the license code based on the additional function and the system ID of the key telephone unit BT, and transmits a request for setting the license code and the function to be enabled to the key telephone unit BT at the step 44k.

Then, when the setting of addition of the function is terminated in the key telephone unit BT, the customer center CC updates the corresponding function information of the user stored in the user data base DB at the step 44m, and subsequently transmits the payment request information of the previously calculated amount billed to the credit company CR at the step 44n. Then, when the answer informing that the payment request has been accepted is returned from the credit company CR, the maintenance personal computer PC of the user who has sent the request is informed of the fact that addition of the function is completed at the step 44o.

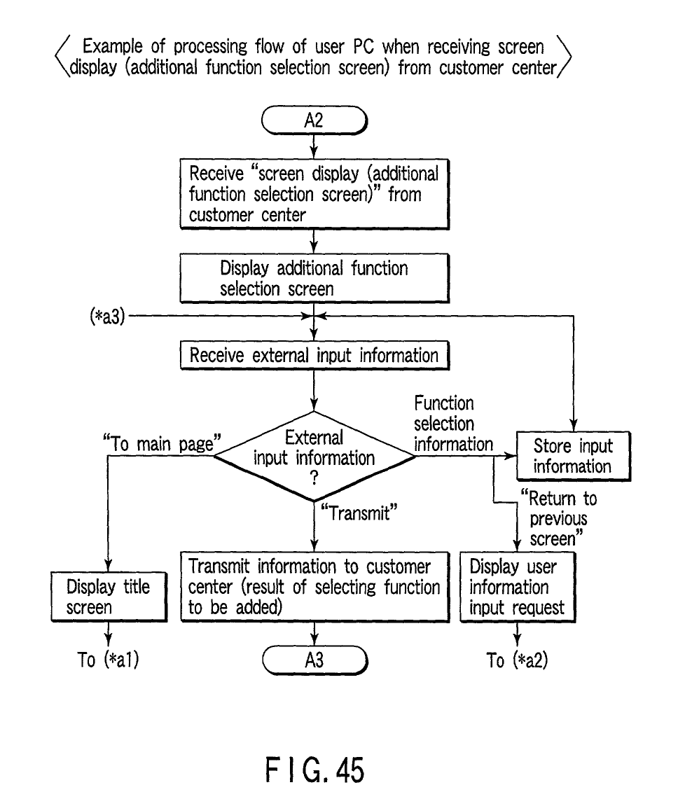

It is to be noted that FIG. 45 is a flowchart showing the detailed processing procedure of the maintenance personal computer PC of the user and illustrates the processing procedure when an additional function selection screen is received from the customer center CC during the function addition processing. Incidentally, the processing procedures when a title screen, a user information input screen, a confirmation request screen, an addition termination screen, a user information re-input screen and a function addition processing NG are received from the customer center CC are the same as the procedures illustrated in FIGS. 9, 10, 12, 13, 14 and 15.

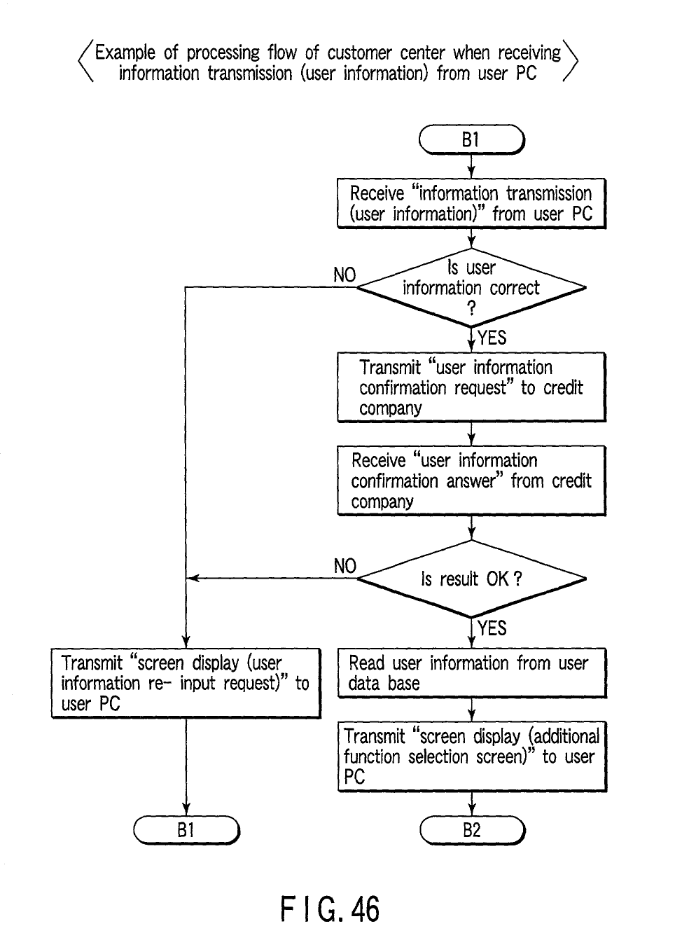

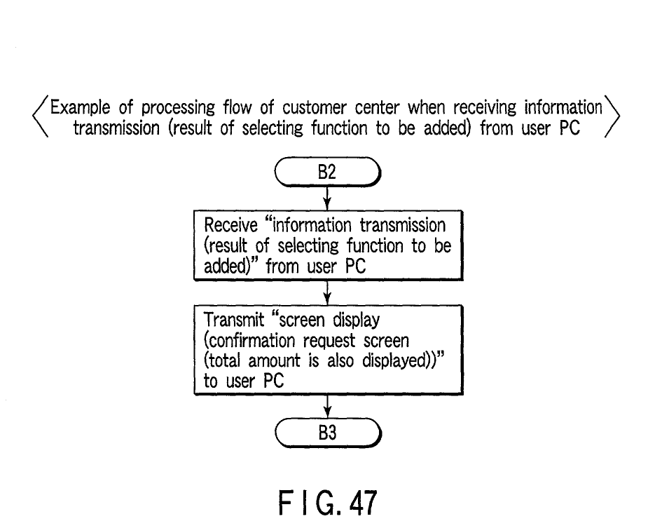

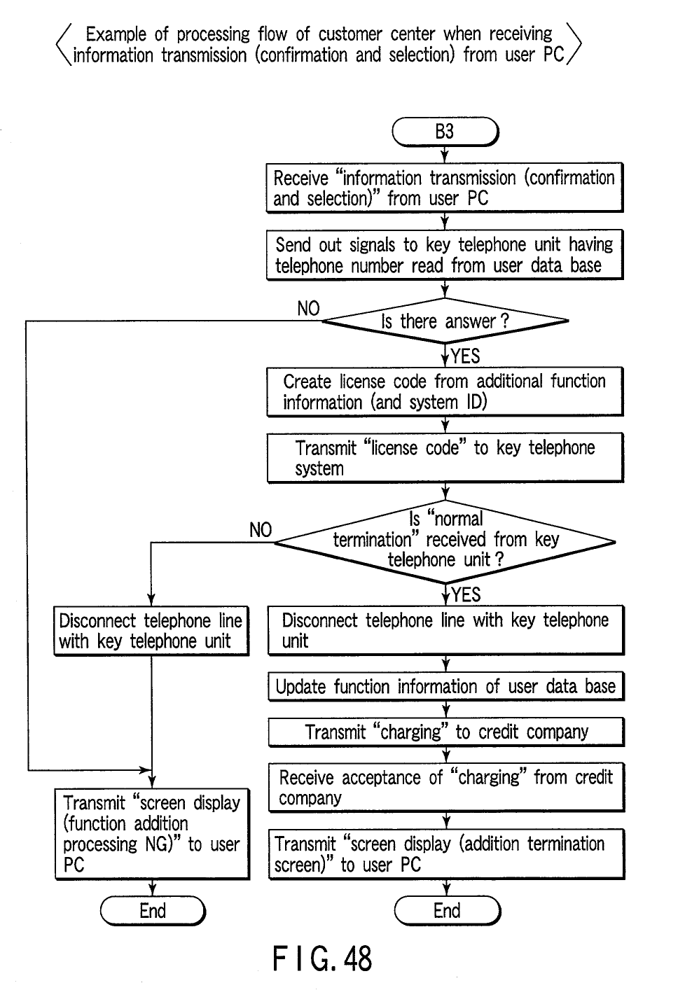

Further, FIGS. 46, 47 and 48 are flowcharts showing the detailed processing procedures of the customer center CC and illustrate the processing procedures when user information, information indicative of a result of selecting the function to be added and information for confirmation and selection are received from the maintenance personal computer PC, respectively. It is to be noted that the processing procedure when a request to access a main page is received from the maintenance personal computer PC is the same as the procedure shown in FIG. 16.

As described above, according to the function change method of the second embodiment, as similar to the first embodiment, since a series of the steps from the request of the function addition by the user to the function addition processing in the key telephone unit BT of the user are all automatically executed through the communication network without requiring the labor, reduction in the time required for adding the function and in the burden of costs on the user as well as great decrease in the labor and cost required for the function change in the customer center CC can be realized.

Furthermore, since judgment is made upon whether the function addition is possible based on the function information of the key telephone unit BT, the appropriate function addition processing can be carried out in accordance with each key telephone unit BT without making errors. Moreover, since the license code is encrypted by using the system ID of the key telephone unit BT and thereafter transferred to the key telephone unit BT, the erroneous function addition or the fraudulent function addition processing can not be performed.

In addition, in the second embodiment, communication between the customer center CC and the key telephone unit BT or judgment upon whether the function can be changed is conducted by utilizing the user information stored and managed in the user data base DB. Therefore, it is not necessary to acquire the information indicative of the function from the key telephone unit BT each time, and the appropriate function change processing can be thereby executed with the simple procedure.

Additionally, after termination of the processing for adding the function to the key telephone unit BT, the corresponding function information in the user data base DB is updated by the customer center CC. Therefore, the stored and managed information in the user data base DB can be automatically constantly updated to latest information without manually performing the updating processing by a person responsible for the maintenance management in the customer center CC.

(Third Embodiment)

The third embodiment of the function change method according to the present invention carries out the function addition processing with respect to the key telephone unit of said user system in the system having a dealer interposed between said user system and the customer center.

That is, a user first transmits a function addition request from his/her maintenance personal computer to the dealer through the Internet INW. The function addition request includes information indicative of a function to be added, a credit number of the user, and a telephone number of the key telephone unit. Then, the dealer accesses the credit company and performs the credit research of the user based on the credit number included in the function addition request. If there is no problem, the dealer transfers the function addition request to the customer center. The customer center accesses the key telephone unit of the user through the public network based on the telephone number included in the function addition request, acquires function information of the key telephone unit, and makes judgment upon whether the function demanded by the user can be added. Further, if the function can be added, the customer center transmits a license code of the function to be added to the key telephone unit of the user through the public network and sets to add the function.

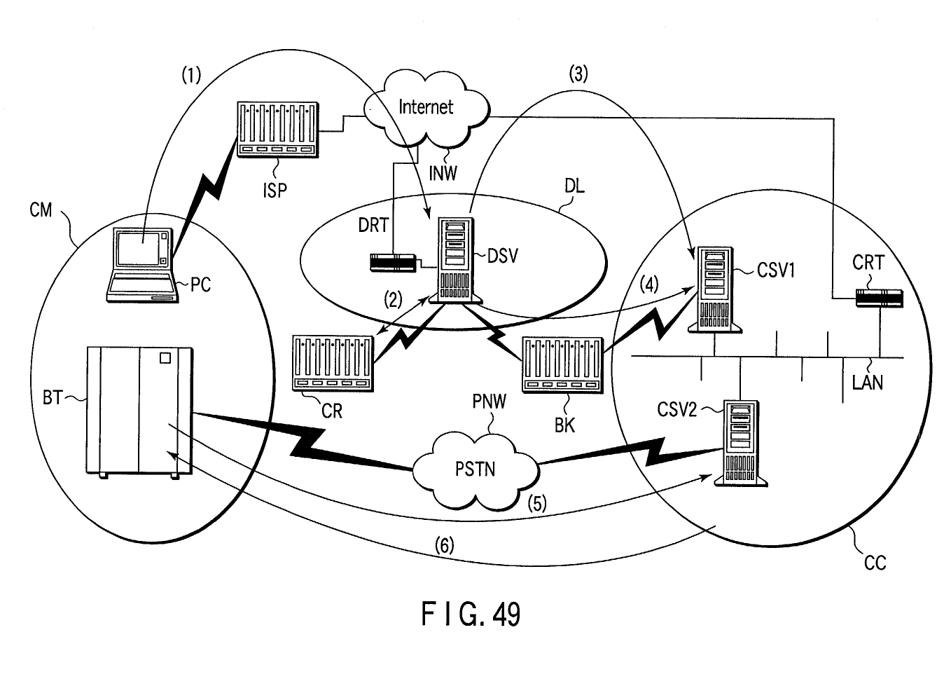

FIG. 49 is a schematic structural view showing a support system which carries out the function change method in the third embodiment. It is to be noted that, in the drawing, like reference numerals denote parts similar to those in FIG. 1, thereby omitting the detailed explanation.

A dealer DL is newly provided to the support system according to this embodiment. The dealer DL includes an acceptance/charging/communication server DSV and a router DRT. The acceptance/charging/communication server DSV is connected to the Internet INW through the router DRT, and further connected to the maintenance personal computer PC in said user system CM and the customer center CC from the Internet INW. Furthermore, it transmits/receives information required for the function addition processing between the maintenance personal computer PC and the customer center CC.

Moreover, the acceptance/charging/communication server DSV is connected to the credit company CR or the bank BK through a dedicated line. In addition, it effects the inquiry about the credit of the user and the operation for charging the agent commission required for the function addition.

Description will now be given as to the procedure when adding the function to the key telephone unit BT in the system mentioned above.

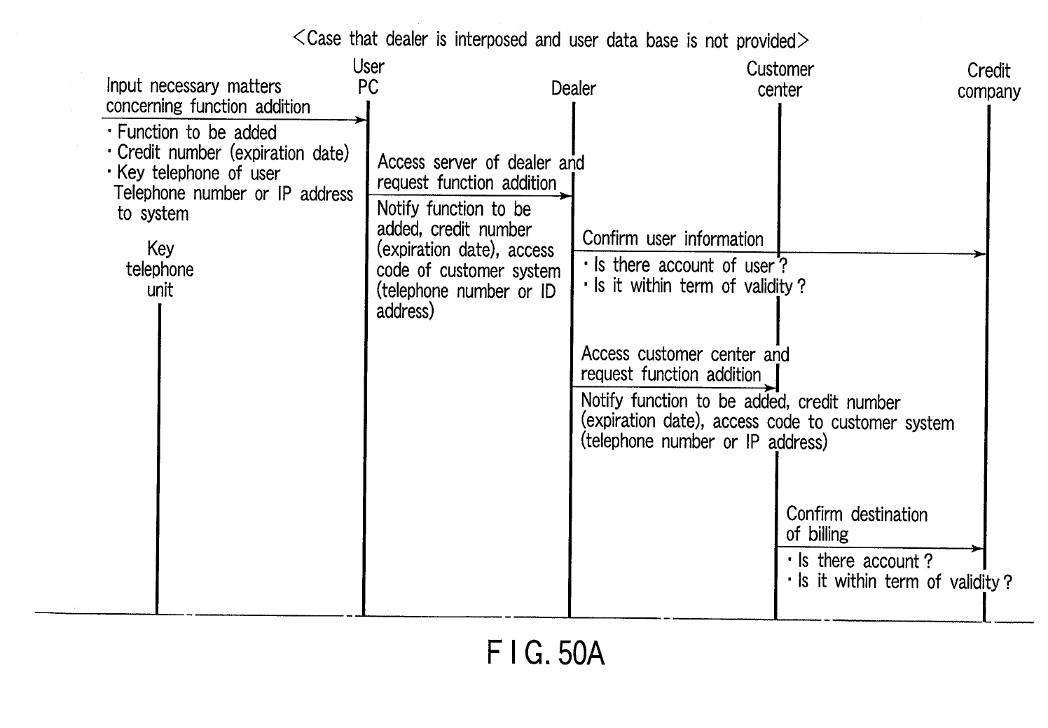

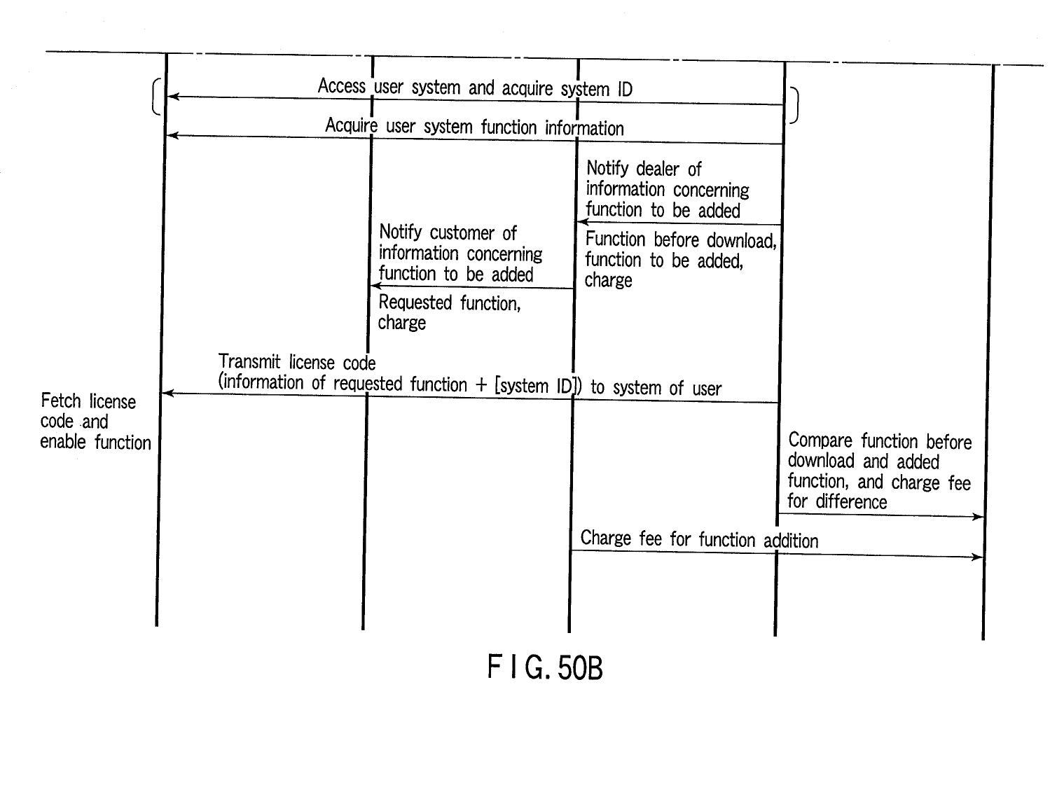

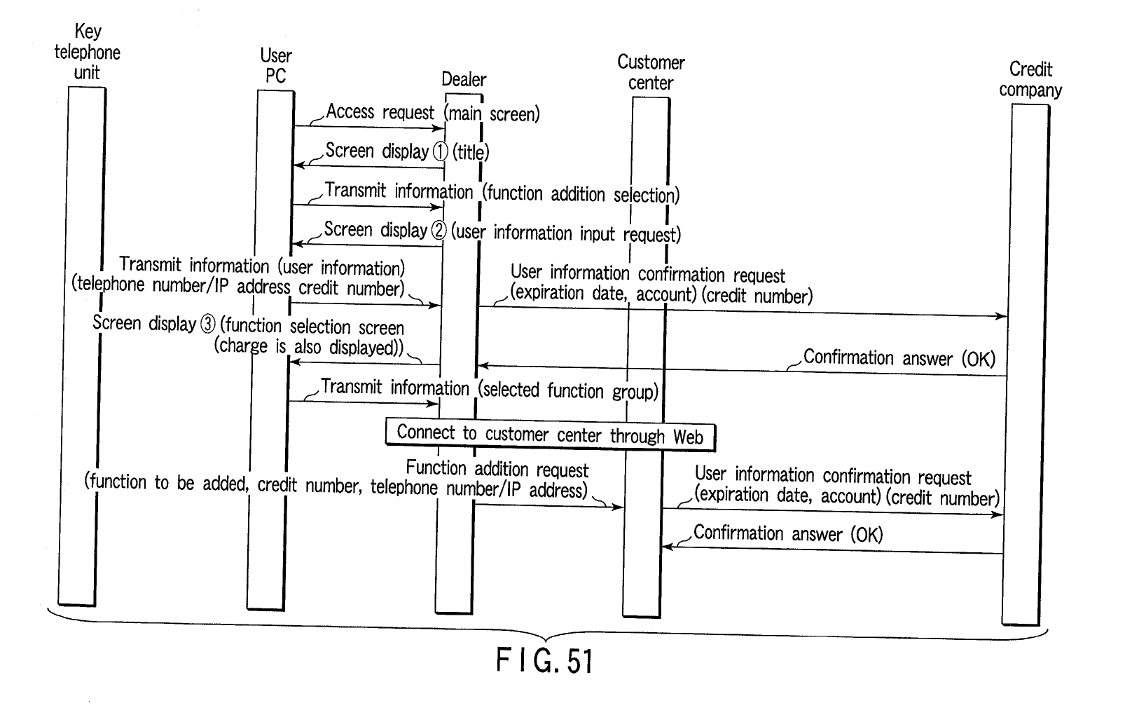

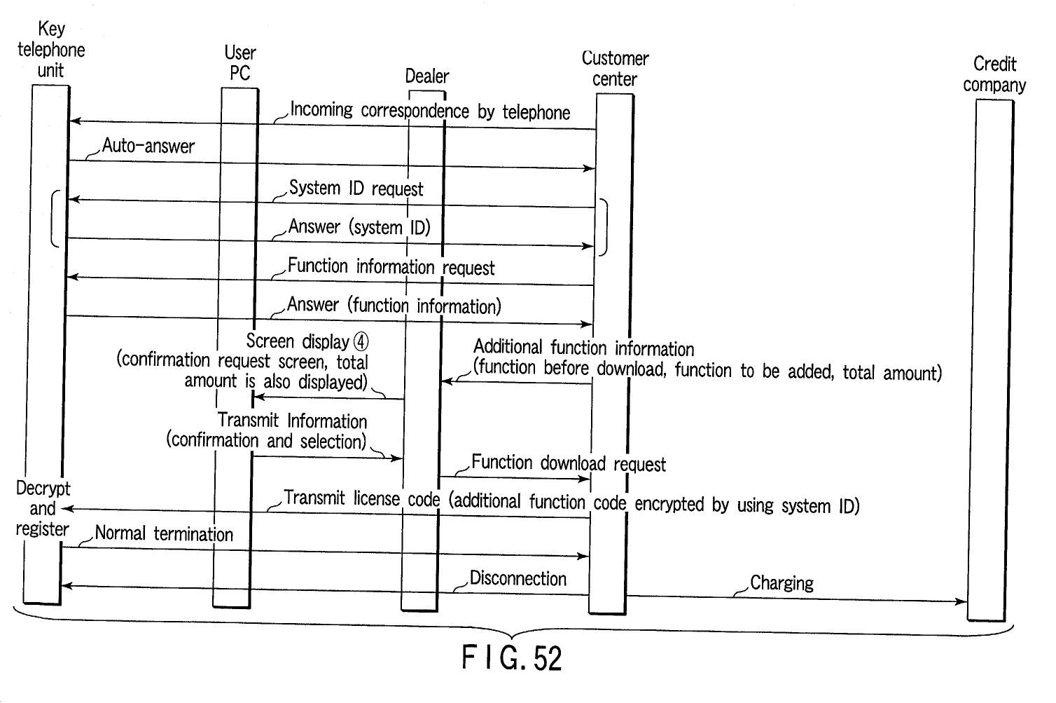

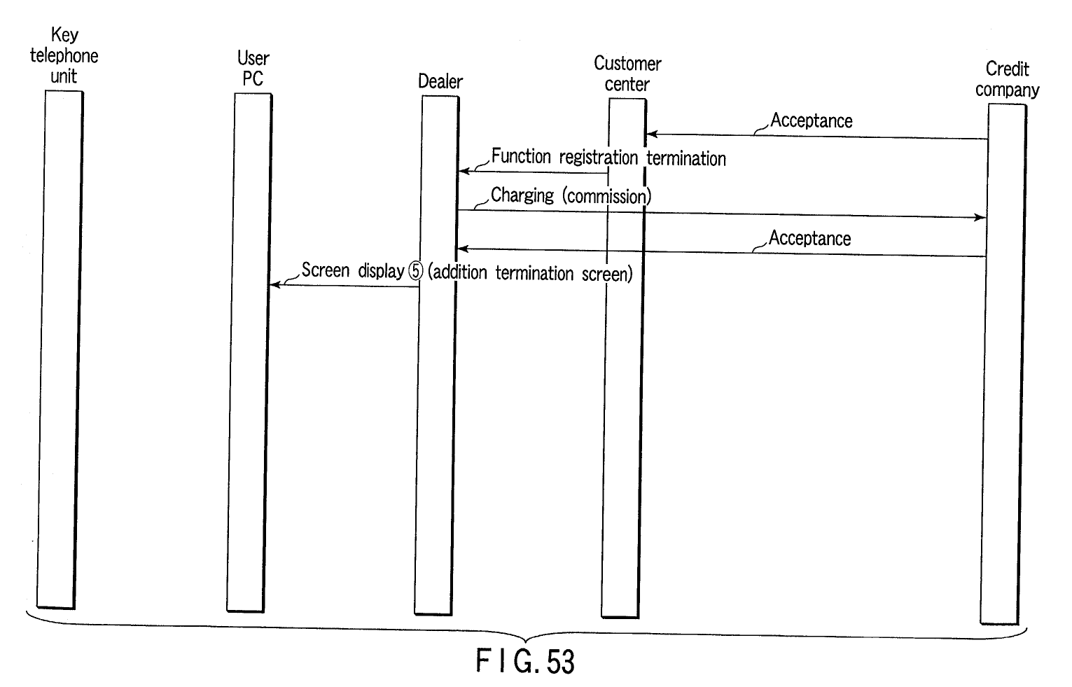

FIG. 50 is a schematic sequence diagram showing the operation for communicating information between the maintenance personal computer PC (user PC) of said user system CM, the dealer DL, the customer center CC and the credit company CR, and FIGS. 51 to 53 are detailed schematic sequence diagrams of FIG. 50.

When adding the function of the key telephone unit BT, the user accesses a web page of the dealer DL through the Internet INW by using the maintenance personal computer PC, and inputs necessary matters concerning the function addition in accordance with the guidance on a screen downloaded from the dealer DL. The necessary matters to be inputted are information indicative of a function to be added, a credit number of the user, and a telephone number or an IP address allocated to the key telephone unit BT from the public network PNW. Additionally, when input of these necessary matters are finished, the function addition request including such information is transmitted to the dealer DL.

Upon receiving the function addition request, the dealer DL first accesses the credit company CR through the dedicated line, and inquires about the credit of the user based on the credit number of the user. With respect to this inquiry, the credit company CR makes judgment upon whether there is an account corresponding to the credit number, whether an expiration date of the credit is within a term of validity, and whether suspension of use is set. Then, the answer is returned to the dealer DL.

The dealer DL makes judgment upon the credit of the user based on the answer from the credit company CR. If there is no problem, the dealer DL transfers the function addition request transmitted from the user to the customer center CC through the Internet INW.

When the customer center CC receives the function addition request, it accesses and requests the credit company CR to perform the credit research of the user. Thereafter, if there is no problem, the customer center CC accesses the Key telephone unit BT of the user through the public network PNW based on the telephone number included in the function addition request, and acquires the function information and the system ID from the key telephone unit BT. Then, it makes judgment upon whether the function that the user wants to add has been already used and whether this function can be added if it has not been used based on the acquired function information.

Subsequently, based on a result of judgment, the customer center CC informs the dealer DL of a list of functions which have been already used and functions which can be added and a table showing charges required for the function addition through the Internet INW. The dealer DL transfers the notified function list and the charge table to the maintenance personal computer PC of the user through the Internet INW. Further, upon receiving an answer of confirmation from the user with respect to notification of the function list and the charge table, the dealer DL transmits a function download request to the customer center CC.

When the customer center CC receives the function download request from the dealer DL, it transmits a license code to the key telephone unit BT of the user through the public network PNW. To the license code is inserted an instruction code used for setting a function to be added to “enabled”. At this moment, the instruction code is encrypted by using the system ID precedent acquired from the key telephone unit BT.

When the key telephone unit BT receives the license code from the customer center CC, it first decrypts the instruction code included in the license code by using the system ID of itself. Then, it changes a flag of the corresponding function in the function information setting processing table from “disabled” to “enabled” in accordance with the decrypted instruction code. When the function addition setting processing is terminated, the key telephone unit BT returns information indicating that the function addition processing has been normally terminated to the customer center CC.

When the customer center CC receives the function addition termination notification from the key telephone unit BT, it disconnects the line between itself and the key telephone unit BT. Thereafter, it accesses the credit company CR and charges an added function fee. Then, when the customer center CC receives an answer informing that the payment request has been accepted from the credit company CR, it notifies the dealer DL of information indicating that the function addition processing has been terminated. Upon receiving the processing termination notification, the dealer DL charges the credit company CR with the agent commission.

In this manner, the function that the user wants to add is set to the enabled state in the key telephone unit BT, and thereafter the key telephone unit BT of the user can use the newly added optional service function.

It is to be noted that the request for credit research of the user to the credit company CR by the customer center CC itself may be omitted. Also, the customer center CC may not perform the operation for charging the cost but the dealer DL may lump this operation. Further, a bank BK may conduct the payment operation for the cost in place of the credit company CR.

The structure of each part in the support system carrying out the above-described function change method is as follows, for example.

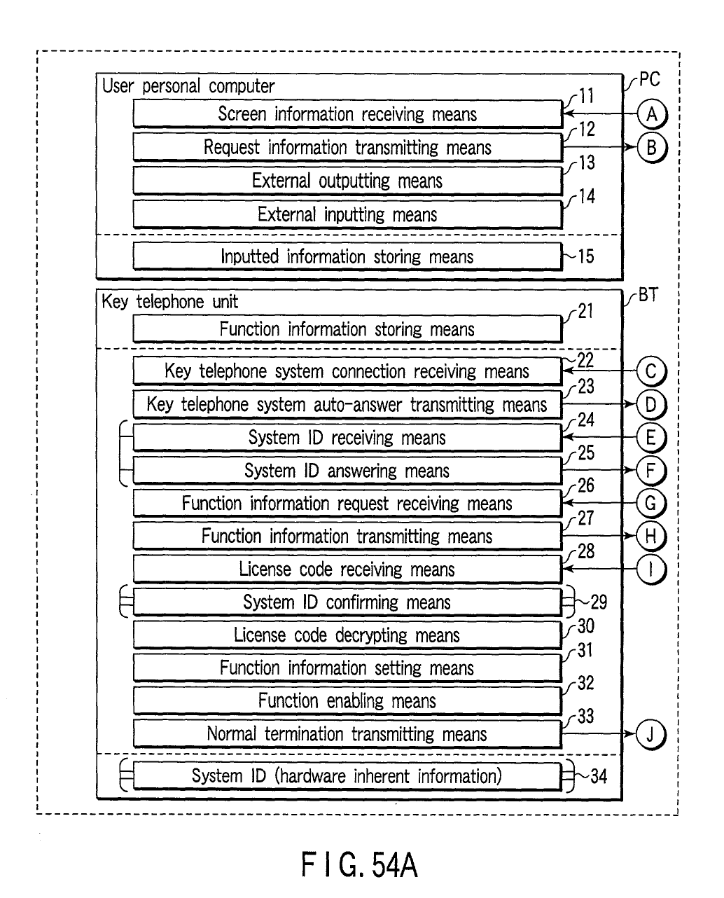

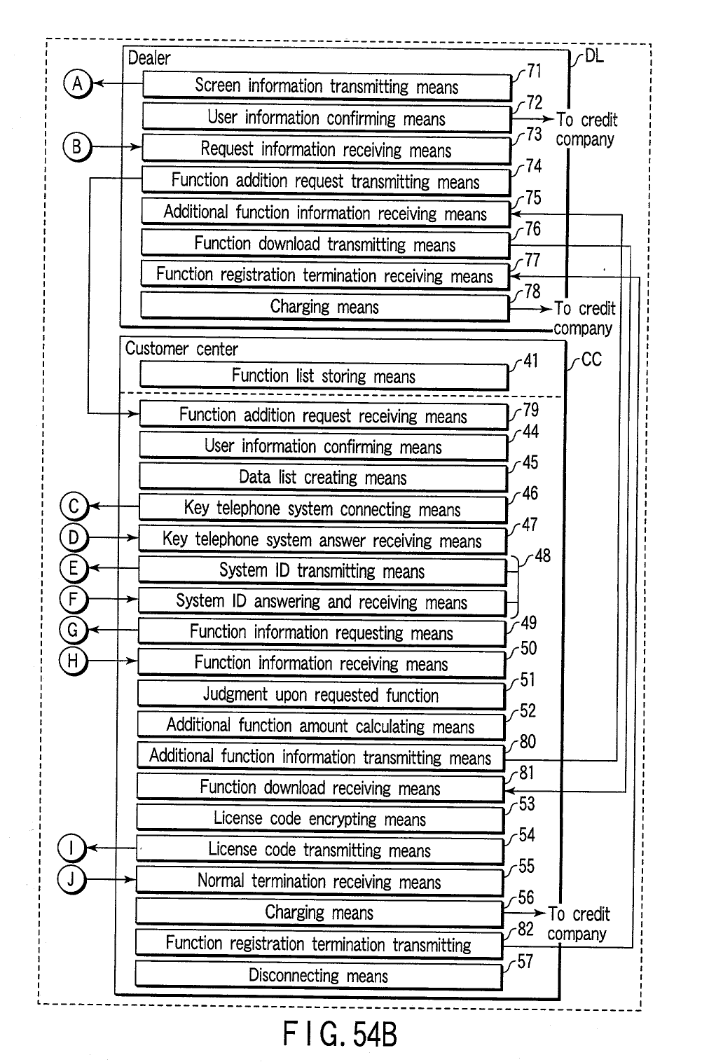

FIG. 54 is a block diagram showing the function configuration of the maintenance personal computer PC, the key telephone unit BT, the dealer DL and the customer center CC. Incidentally, in the drawing, like reference numerals denote parts similar to those in FIG. 7, thereby omitting the detailed explanation.

The dealer DL includes: screen information transmitting means 71; user information confirming means 72; request information receiving means 73; function addition request transmitting means 74; additional function information receiving means 75; function download transmitting means 76; function registration termination receiving means 77; and charging means 78.

Among these means, the screen information transmitting means 71 transmits to the maintenance personal computer PC of the user a series of screen information for the function addition request when the maintenance personal computer PC accesses the screen information transmitting means 71. The user information confirming means 72 accesses the credit company CR based on the credit number included in the received function addition request information, and inquires about the credit of the user. The request information receiving means 73 receives information of the function addition request transmitted from the maintenance personal computer PC.

The function addition request transmitting means 74 transfers to the customer center CC the information of the function addition request received from the maintenance personal computer PC of the user. The additional function information receiving means 75 receives the additional function notification information transmitted from the customer center CC and transfers this information to the user's maintenance personal computer PC which has sent the request. The function download transmitting means 76 transmits a function download request to the customer center CC when the confirmation answer is returned from the maintenance personal computer PC with respect to transfer of the additional function notification information.

The function registration termination receiving means 77 receives function registration termination notification transmitted from the customer center CC. The charging means 78 requests the credit company CR to charge the fee required for adding the function after receiving the function registration termination notification.

The customer center CC includes, as means for communicating information to/from the dealer DL, function addition request receiving means 79, additional function information transmitting means 80, function download receiving means 81, and function registration termination transmitting means 82.

Among these means, the function addition request receiving means 79 receives the function addition request information transmitted from the dealer DL. The additional function information transmitting means 80 transmits the function information acquired from the key telephone unit BT to the dealer DL. When the dealer DL transmits the function download request, the function download receiving means 81 receives it and activates the function download processing with respect to the Key telephone unit BT, i.e., the processing for transmitting the license code. The function registration termination transmitting means 82 transmits the function registration termination notification to the dealer DL after completion of the function download to the key telephone unit BT and the charging operation with respect to the credit company CR.

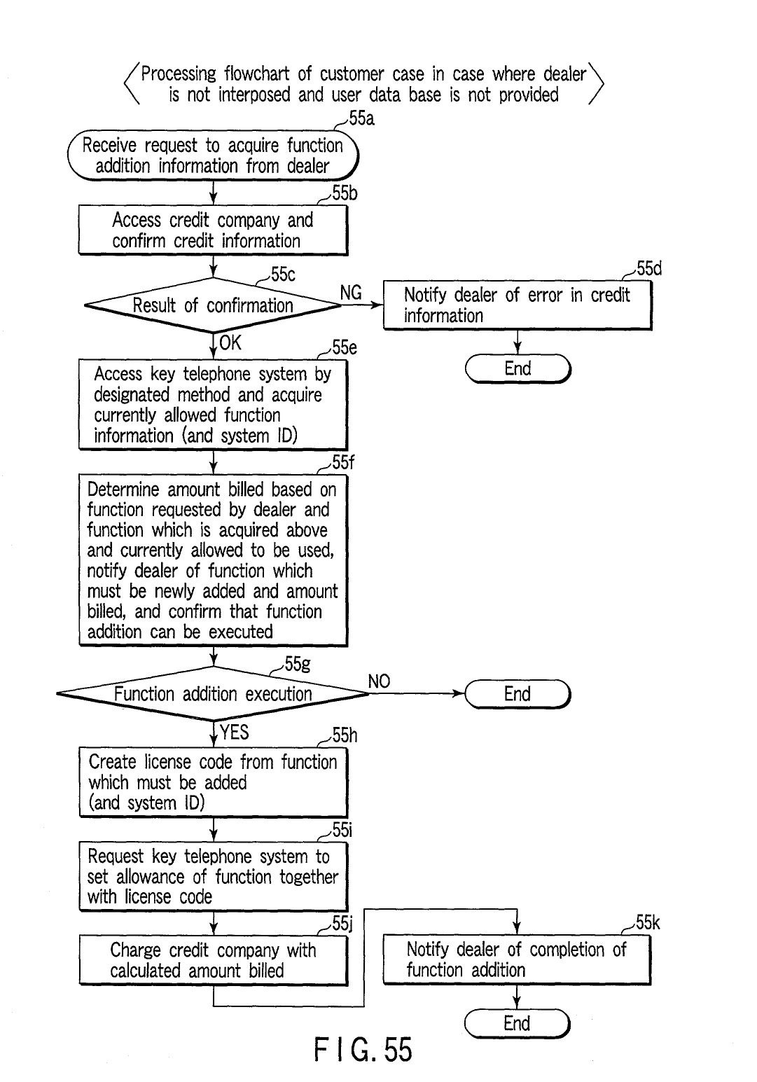

FIG. 55 is a flowchart showing the processing operation of the customer center CC, and the processing operation for the above-described function addition is executed in accordance with the procedure shown at the steps 55a to 55k.

That is, when the customer center CC receives the function addition request of the user from the dealer DL through the Internet INW at the step 55a, it first accesses the credit company CR and confirms the credit information at the step 55b. Then, if the credit information can not be confirmed, the processing proceeds from the step 55c to the step 55d, and the customer center CC notifies the maintenance personal computer PC which has sent the request of an error in the credit implementation information.

On the other hand, if the credit information can be confirmed, the processing advances from the step 55c to the step 55e, and the customer center CC accesses the key telephone unit BT of the user by using a telephone number or a mail address of the key telephone unit BT transmitted from the user and acquires information of functions which are currently allowed to be used and a system ID from the key telephone unit BT.

Subsequently, the customer center CC calculates an amount billed based on the function requested from the dealer DL and the function information acquired from the Key telephone unit BT at the step 55f, notifies the dealer DL of a name of the function to be newly added and the amount billed and inquires if it can execute the operation. When the dealer DL transmits an execution request with respect to this inquiry, the customer center CC shifts from the step 55g to the step 55h, creates a license code based on the function to be added and the system ID of the Key telephone unit BT, and transmits to the Key telephone unit BT a request for setting use of the license code and use of the function to be enabled at the step 55i.

Further, when the setting for adding the function is terminated in the key telephone unit BT, the customer center CC transmits to the credit company CR payment request information of the amount billed which has been calculated in advance. Then, when an answer informing that the payment request has been accepted is returned from the credit company CR, the customer center CC notifies the maintenance personal computer PC of the user who has sent a request of termination of addition of the function at the step 55k.

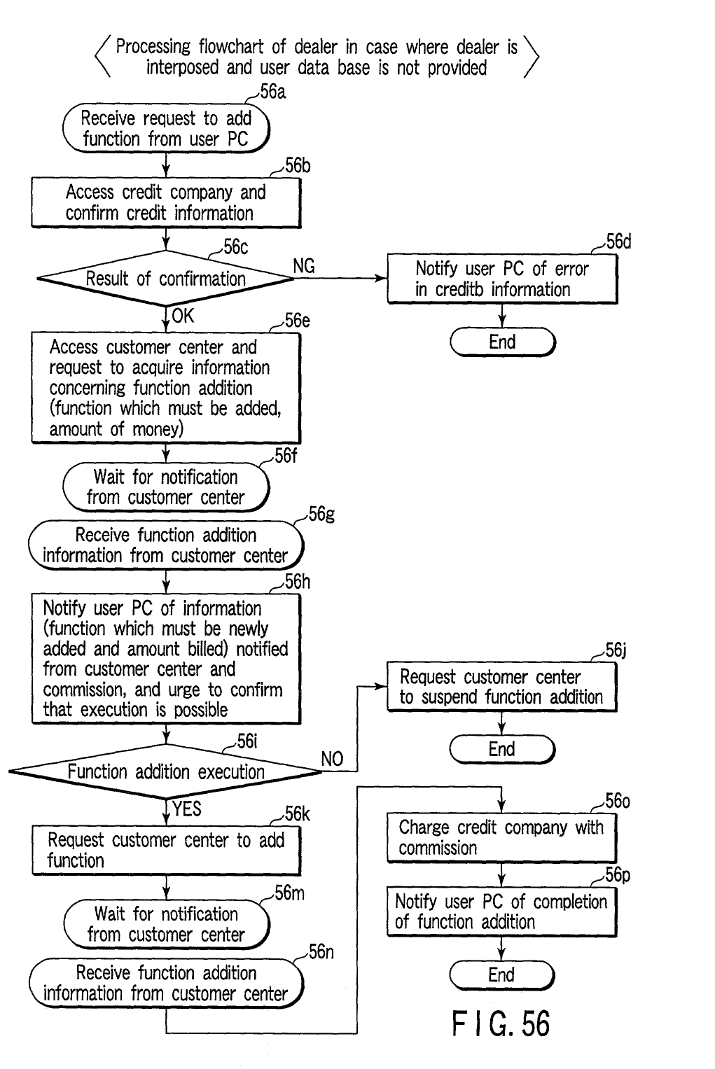

On the other hand, FIG. 56 is a flowchart showing the processing operation of the dealer DL, and a series of the processing operations for adding the function are executed in accordance with the procedures indicated at steps 56a to 56p.

That is, when the dealer DL receives a request for adding the function from the maintenance personal computer PC through the Internet INW at the step 56a, the dealer DL first accesses the credit company CR and confirms the credit information at the step 56b. If the credit information can not be confirmed, the processing proceeds from the step 56c to the step 56d, the maintenance personal computer PC which has sent the request is informed of an error in the credit implementation information.

On the other hand, if the credit information can not be confirmed, the dealer DL proceeds from the step 56c to the step 56e, accesses the customer center CC and requests to acquire information concerning the function addition, i.e., the function which must be added and an amount of money. Furthermore, the dealer DL waits for the notification from the customer center CC at the step 56f.

In this state, when the function addition information is transmitted from the customer center CC, the dealer DL proceeds from the step 56g to the step 56h, notifies the user's maintenance personal computer PC of the function addition information transmitted from the customer center CC, namely, a name of the function to be newly added and an amount billed, and inquires if it can execute the processing. When the user transmits an execution request for adding the function with respect to this inquiry, the processing proceeds from the step 56i to the step 56k, and a request for executing the function addition is transmitted to the customer center CC. Then, the dealer waits for the notification from the customer center CC at the step 56m. Incidentally, when the user transmits a request to abandon addition of the function, the processing advances from the step 56i to the step 56j, and the customer center CC is informed of abandon of addition of the function.

When the function addition information is transmitted from the customer center CC, the dealer DL receives this information at the step 56n and moves to the step 56o. Furthermore, it transmits to the credit company CR payment request information of the amount billed which has been previously calculated. Then, when an answer informing that the payment request has been accepted is returned from the credit company CR, the maintenance personal computer PC of the user who has sent a request is informed of completion of addition of the function at the step 56p.

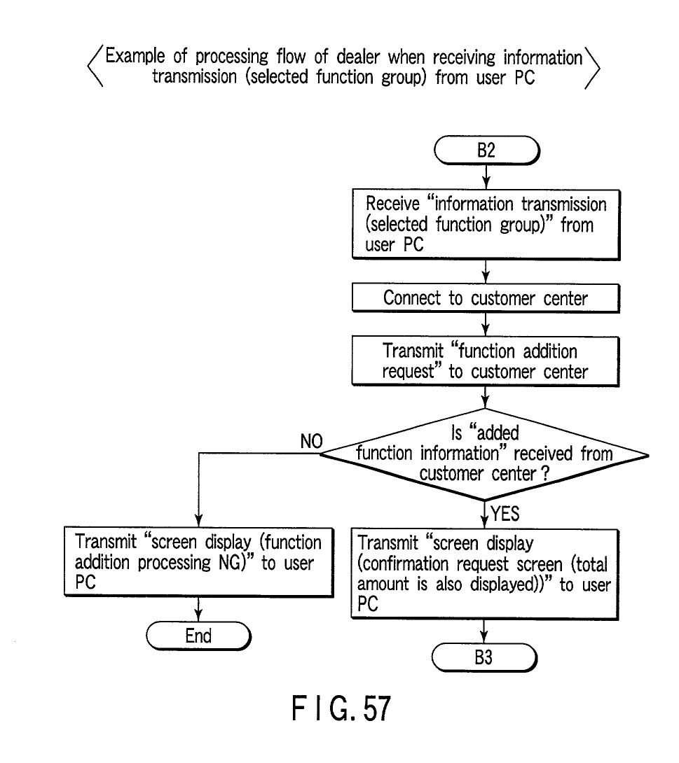

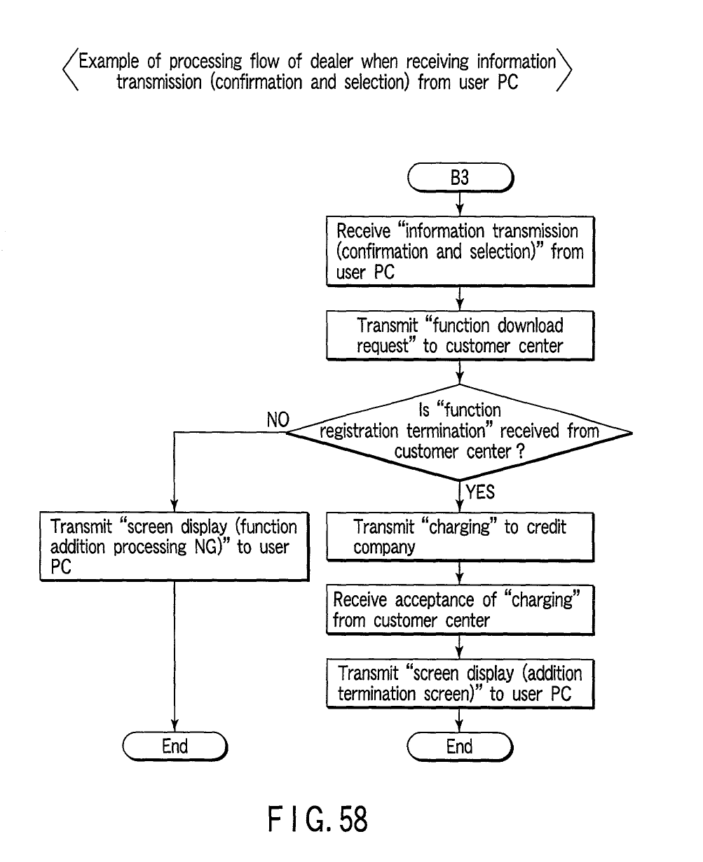

Incidentally, FIGS. 57 and 58 are flowcharts showing the detailed processing procedures of the dealer DL mentioned above, and illustrate the processing procedures when receiving information indicative of a selected function group and information for confirmation and selection from the personal computer PC, respectively. It is to be noted that the processing procedures when receiving a request to access a main page and user information from the maintenance personal computer are similar to the processing procedures of the customer center CC described in the first embodiment.

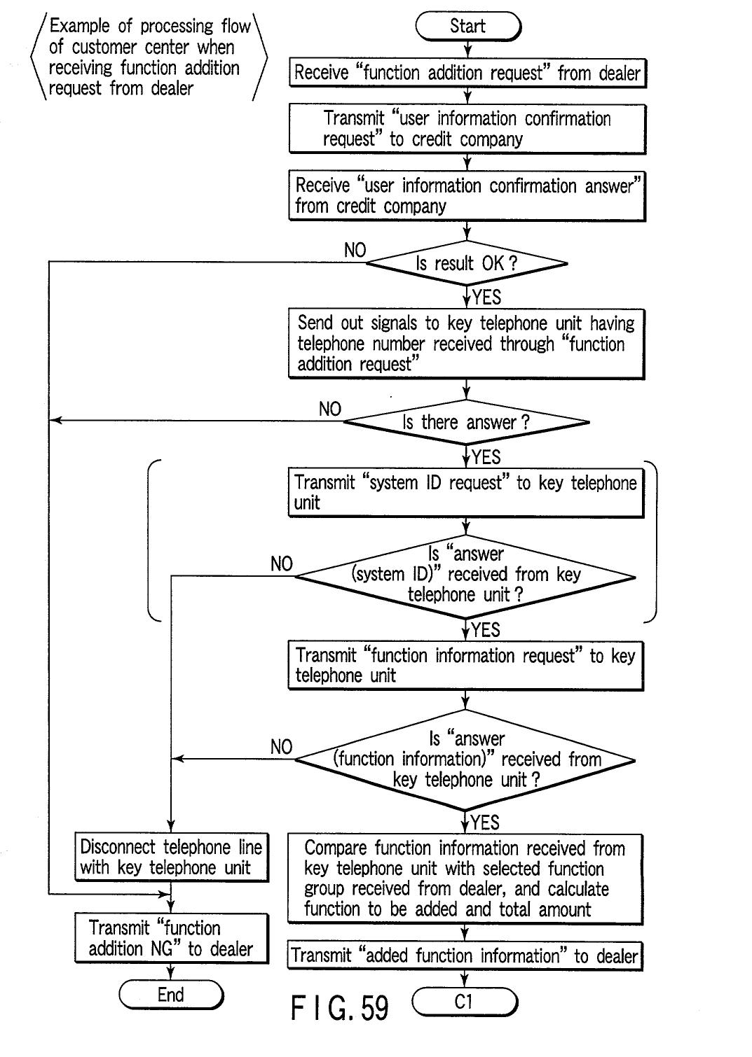

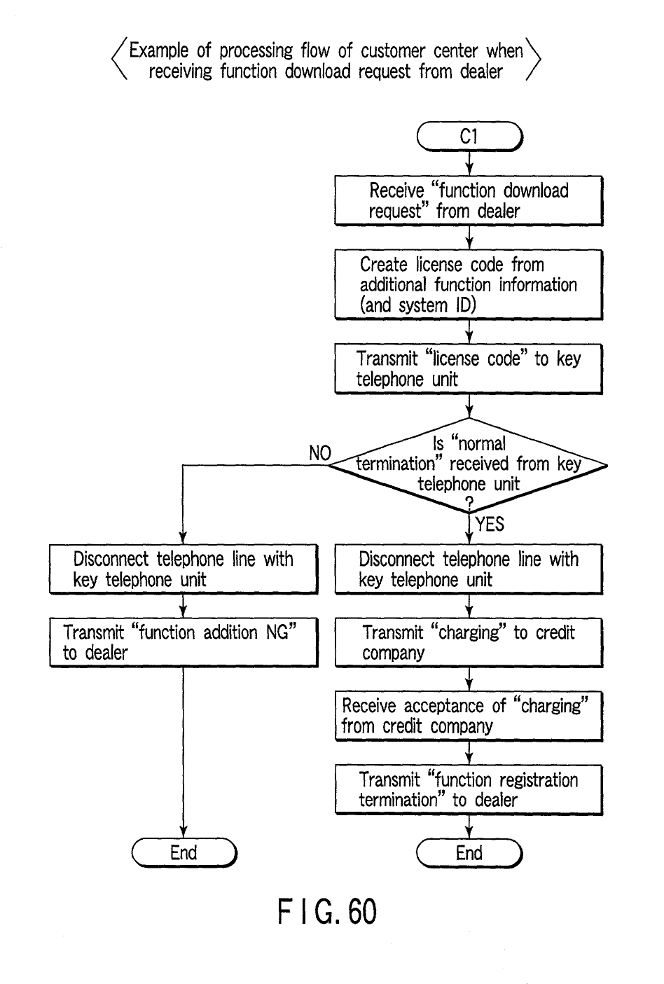

Moreover, FIGS. 59 and 60 are flowcharts showing the detailed processing procedures of the customer center CC and illustrates the processing procedures when receiving a function addition request and a function download request from the dealer DL, respectively.

It is to be noted that the processing procedures of the maintenance personal computer PC when receiving a title screen, a user information input request, a function selection screen, a confirmation request screen, an addition termination screen, a user information re-input request screen and a function addition processing NG screen are the same as those of the maintenance personal computer PC when receiving the display screens transmitted from the customer center CC mentioned in the first embodiment with reference to FIGS. 9 to 15. In addition, the processing procedure of the Key telephone unit BT and that of the credit company are similar to the processing procedures described in the first embodiment with reference to FIGS. 20 and 21, respectively.

As mentioned above, according to the function change method of the third embodiment, since a series of steps from the request of the function change by the user to the function addition in the Key telephone unit BT of the user are all automatically executed through the communication network without requiring the labor while interposing the dealer DL between the user and the customer center CC, the time required for the function addition and the burden of the cost on the user can be reduced, and the labor and cost required for the function addition in the dealer DL or the customer center CC can be greatly decreased.

Additionally, since judgment is made upon whether the function addition is possible based on the function information acquired from the key telephone unit BT which is a target of the function addition, the appropriate function addition processing can be carried out in accordance with each key telephone unit BT without making any error. Further, since the license code is encrypted by using the system ID of the key telephone unit BT and then transferred to the key telephone unit BT, the erroneous function addition or the fraudulent function addition processing can be prevented from being executed.

(Fourth Embodiment)

The fourth embodiment of the function change method according to the present invention adds a function to the key telephone unit of said user system in the system which interpose the dealer between said user system and the customer center and includes a user data base in the customer center.

That is, as shown in (1), the maintenance personal computer of the user transmits a function addition request to the dealer through the Internet INW. The function addition request includes information indicative of a function to be added, individual identification information of the user (user ID) and a credit number. Subsequently, the dealer accesses the credit company and performs the credit research based on the credit number included in the function addition request. Further, if there is no problem, the dealer transfers the function addition request to the customer center. The customer center accesses the user data base based on the user identification information included in the function addition request, and reads a system ID, function information and a telephone number of the Key telephone unit of the user. Then, the customer center makes judgment upon whether the function demanded by the user can be added based on the function information, and notifies the user of a result of judgment through the dealer. Also, if addition is possible, the customer center calls the key telephone unit through the public network based on the telephone number, transmits a license code of the function to be added, and sets the function to be added.

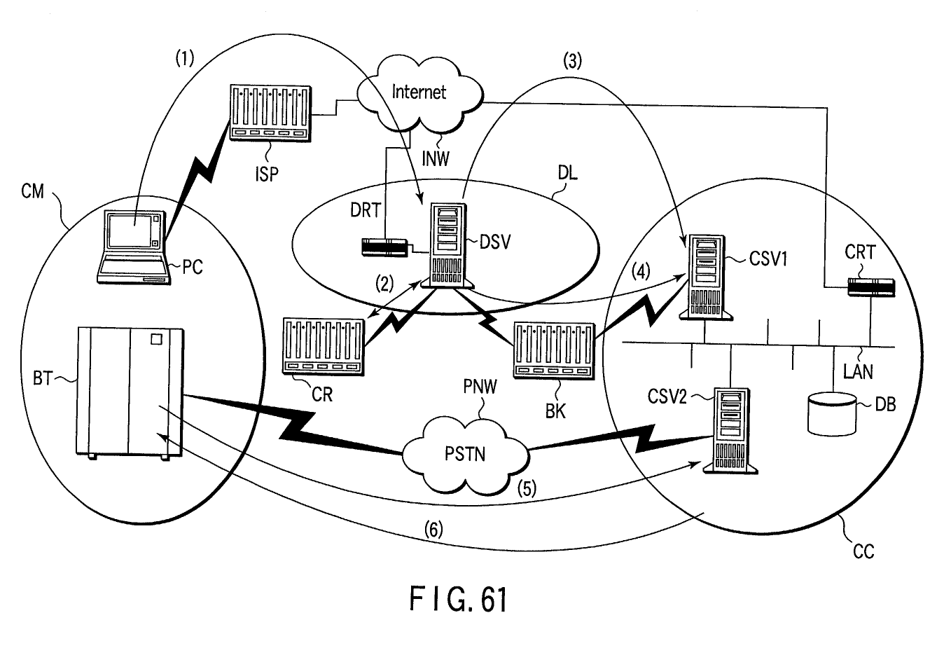

FIG. 61 is a schematic structural view showing a support system which carries out the function change method according to the fourth embodiment. Incidentally, in the drawing, like reference numerals denote parts similar to those in FIGS. 39 and 49.

A dealer DL is newly provided to the support system according to this embodiment. The dealer DL includes an acceptance/charging/communication server DSV and a router DRT. The acceptance/charging/communication server DSV is connected to the Internet INW through the router DRT, and further connected to the maintenance personal computer PC of said user system CM and the customer center CC from the internet INWPNW. Furthermore, information required for the function addition processing is transmitted/received between the maintenance personal computer PC and the customer center CC.

Moreover, the acceptance/charging/communication server DSV is connected to the credit company CR or the bank BK through a dedicated line. In addition, the inquiry about the credit of the user or the operation for charging an agent commission required for adding the function is effected between the credit company CR or the bank BK.

On the other hand, a user data base DB is provided to the customer center CC. The user data base DB stores therein a system ID, function information and a telephone number of the Key telephone unit BT owned by each user in association with a unique user ID given to that user.

When the function addition request of the user is transferred from the dealer DL, the acceptance/charging server CSV1 or the license server CSV2 of the customer center CC accesses the user data base DB based on the user ID included in the function addition request, and reads the system ID, the function information and the telephone number of the Key telephone unit BT owned by the user. Additionally, by using the read information, judgment upon whether the function desired by the user can be added, access to the Key telephone unit BT and transmission of the license code are carried out.

Description will now be given as to the procedure when adding the function to the Key telephone unit BT in the above-mentioned system.

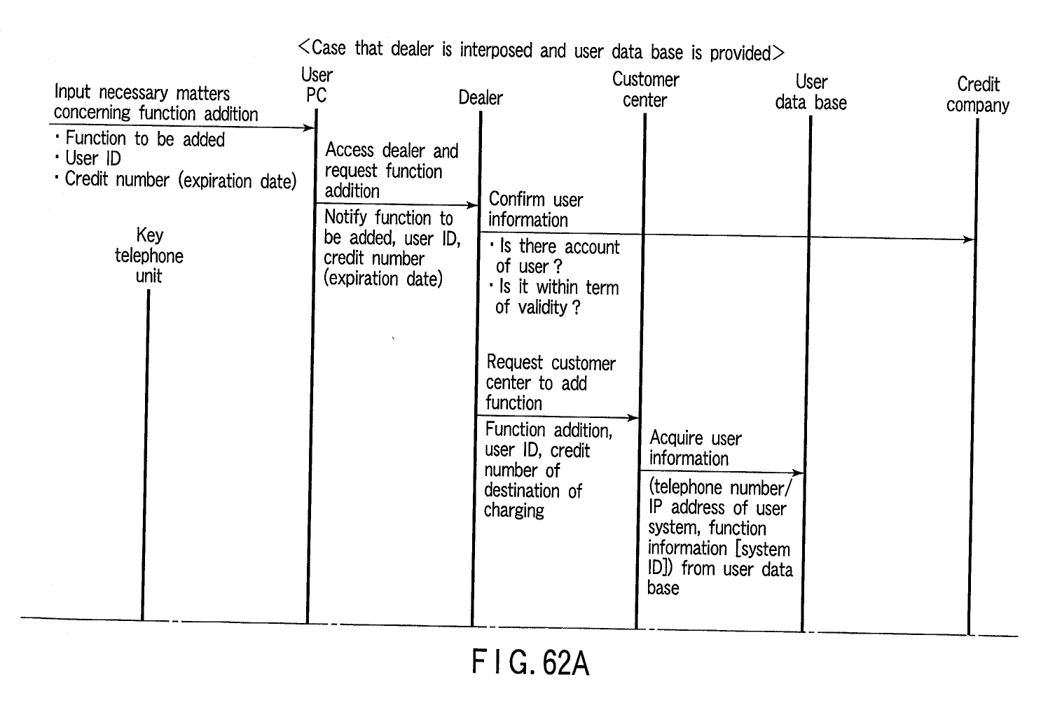

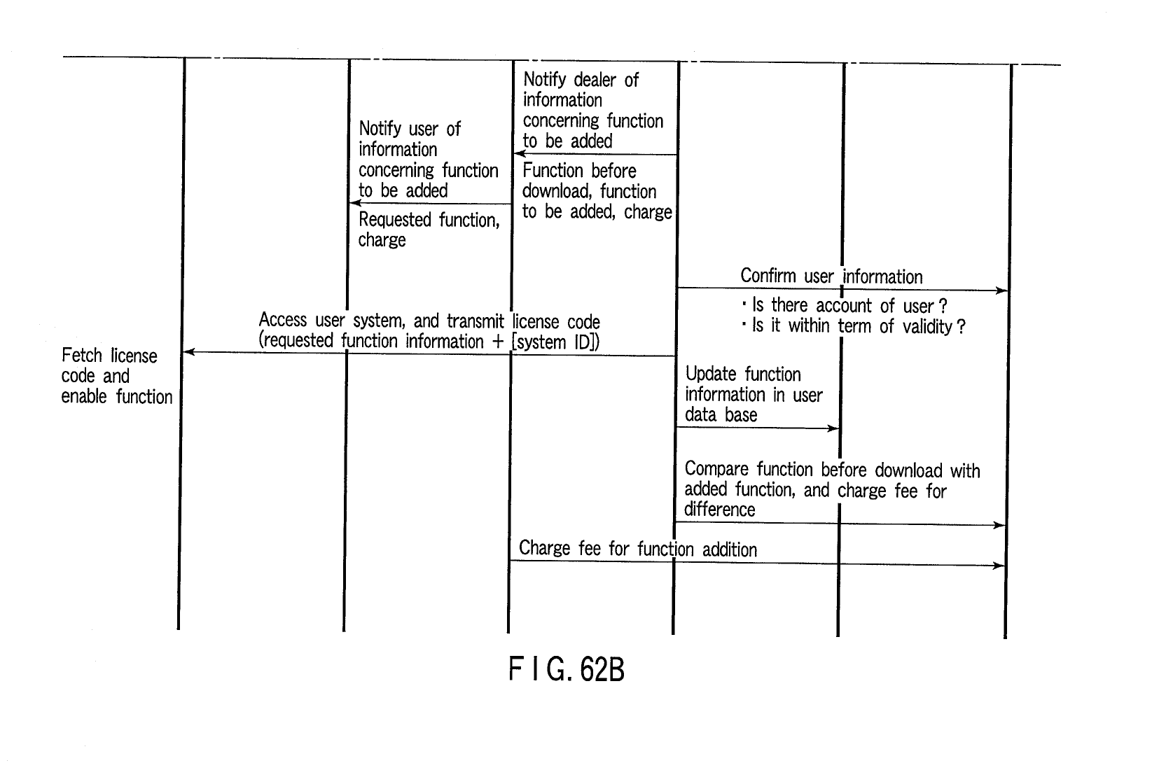

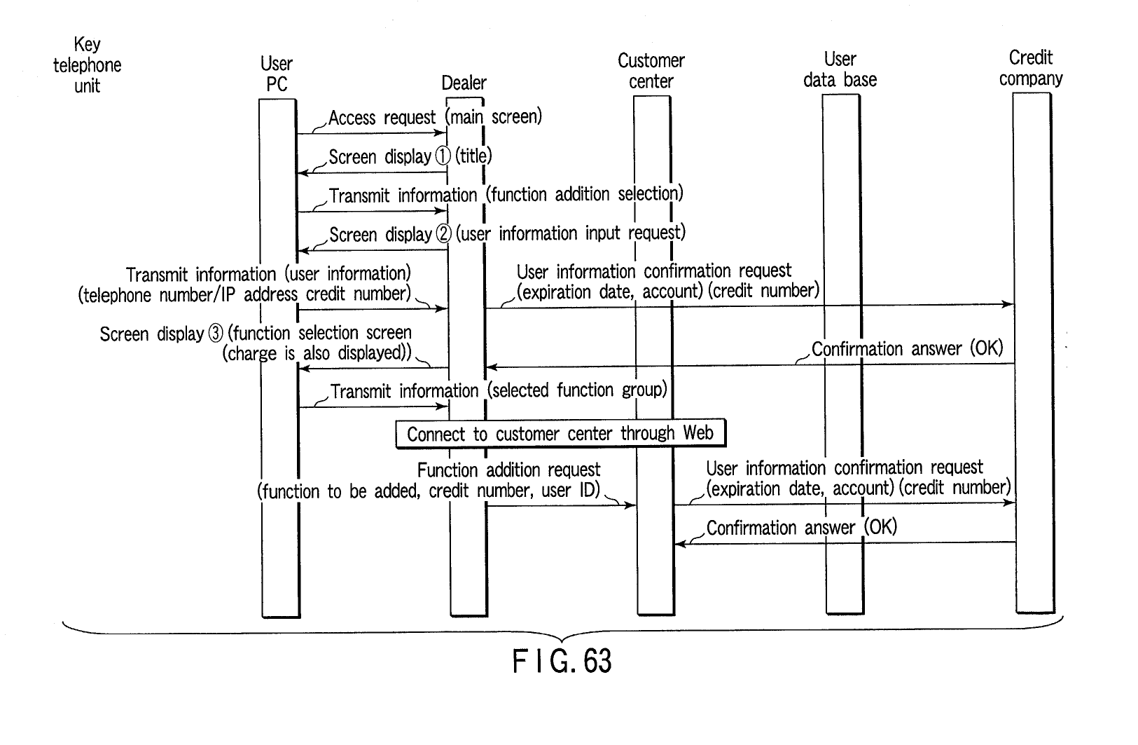

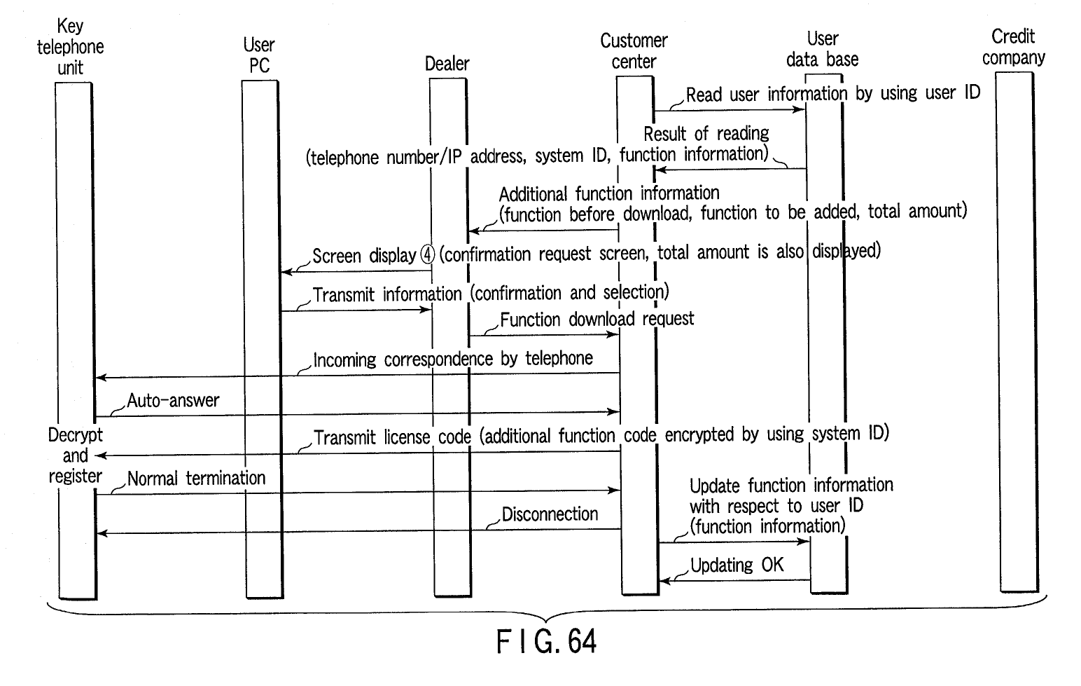

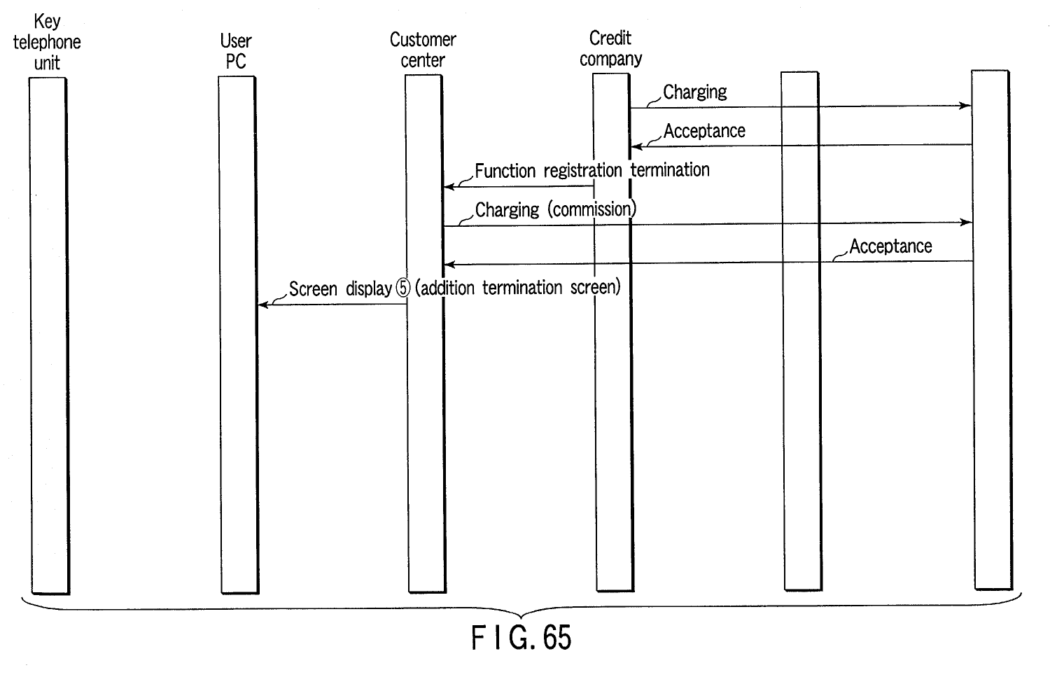

FIG. 62 is a schematic sequence diagram showing the operation for communicating information between the maintenance personal computer PC of said user system CM (user PC), the dealer DL, the customer center CC and the credit company CR, and FIGS. 63 to 65 are detailed sequence diagrams of FIG. 62.

When adding the function of the Key telephone unit BT, the user accesses a web page of the dealer DL through the Internet INW by using the maintenance personal computer PC, and inputs necessary matters concerning the function addition in accordance with the guidance of a screen downloaded from the dealer DL. The necessary matters to be inputted are information indicative of the function to be added, an ID and a credit number of the user. Then, when input of these necessary matters is terminated, the function addition request including such information is transmitted to the dealer DL.

Upon receiving the function addition request, the dealer DL first accesses the credit company CR through the dedicated line and inquires about the credit of the user based on the credit number of the user. With respect to this inquiry, the credit company CR makes judgment upon whether there is an account corresponding to the credit number, whether an expiration date of the credit is within a term of validity, and whether suspension of use is set. Thereafter, the answer is returned to the dealer DL.

The dealer DL judges the credit of the user based on the answer from the credit company CR. If there is no problem, the dealer DL transfers the function addition request transmitted from the user to the customer center CC through the internet INW.

Upon receiving the function addition request, the customer center CC accesses the credit company CR and requests the credit research of the user. Then, when it is confirmed that there is no problem, the customer center CC accesses the user data base DB based on the user ID included in the function addition request, and reads a system ID, function information and a telephone number of the Key telephone unit BT owned by the user.

Subsequently, judgment is made upon whether the function demanded by the user can be added based on the read function information, and the dealer DL is notified through the Internet INW of a list of functions which have been already used and functions which can be added and a table showing charges required for adding the function together with a result of judgment. The dealer DL transfers the notified function list and charge table to the maintenance personal computer PC of the user through the Internet INW. Moreover, upon receiving an answer of confirmation from the user with respect to notification of the function list and the charge table, the dealer DL transmits a function download request to the customer center CC.

Upon receiving the function download request from the dealer DL, the customer center CC calls the Key telephone unit BT of the user through the public network PNW based on the telephone number of the Key telephone unit BT read from the user data base DB, and transmits a license code to the Key telephone unit BT. An instruction code used for setting the function to be added to “enabled” is inserted into the license code. At this moment, the instruction code is encrypted by using the system ID of the Key telephone unit BT precedent read from the user data base D.

When the Key telephone unit BT receives the license code from the customer center CC, it first decrypts the instruction code included in the license code by using its system ID. Then, a flag of the corresponding function in the function information setting processing table is changed from “disabled” to “enabled” in accordance with the decrypted instruction code. When the processing for setting the function addition is terminated, the Key telephone unit BT returns to the customer center CC information indicating that the function addition processing has been normally terminated.

When the customer center CC receives the function addition termination notification from the Key telephone unit BT, it disconnects the line between itself and the Key telephone unit BT, and then accesses the credit company CR in order to charge the additional function fee. Further, upon receiving an answer informing that the payment request has been accepted from the credit company CR, the customer center CC notifies the dealer DL of information indicative of termination of the function addition processing. When the dealer DL receives the processing termination notification, it charges the credit company CR with the agent commission.

In this way, the function that the user wants to add is set to the enabled state in the Key telephone unit BT, and thereafter the newly added optional service function can be used in the Key telephone unit BT of the user.

Incidentally, as described in the third embodiment, the request to the credit company CR to perform the credit research of the user by the customer center CC itself may be omitted, and the customer center CC may not carry out the cost charging operation but the dealer DL may lump this operation. Furthermore, the bank BK may conduct the cost payment operation in place of the credit company CR.

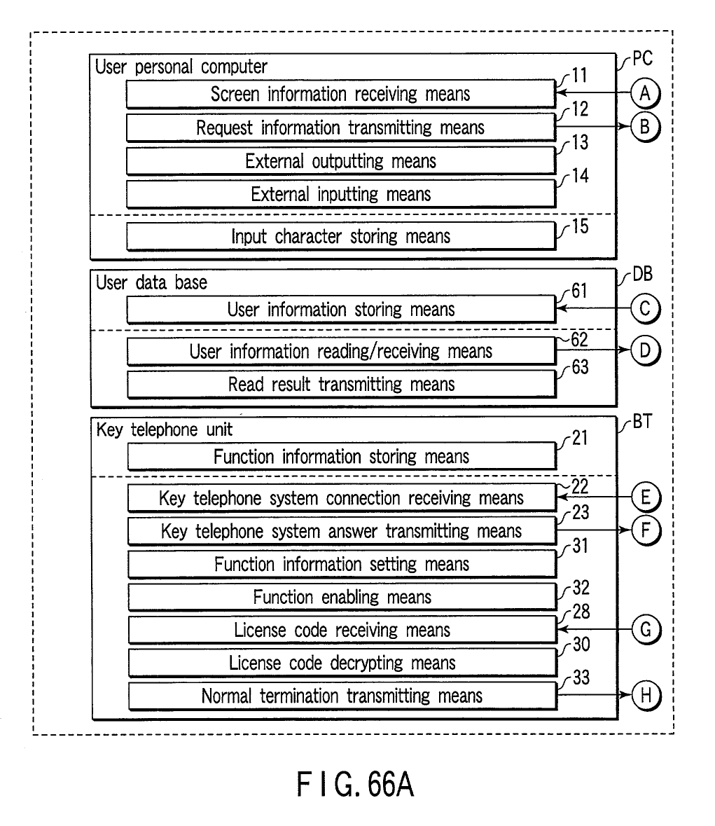

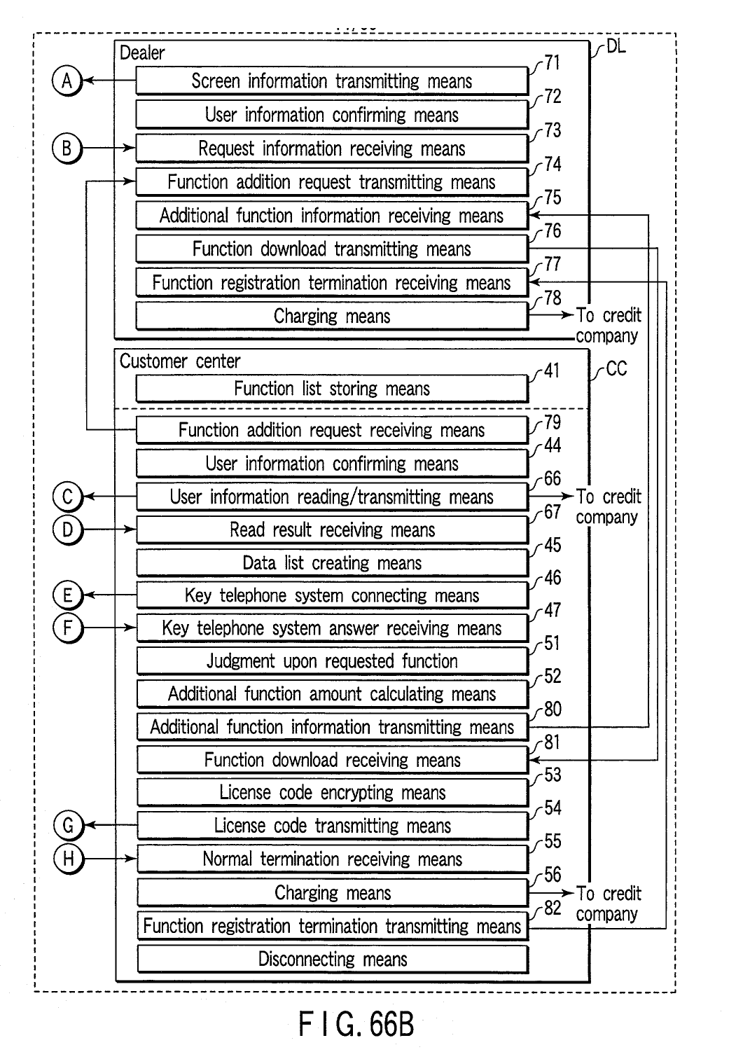

The structure of each part in the support system which carries out the above-described function change method is as shown in FIG. 66, for example. Incidentally, the function configuration shown in FIG. 66 is the same as those illustrated in FIGS. 43 and 51 described in the second and third embodiments, thereby omitting the explanation here.

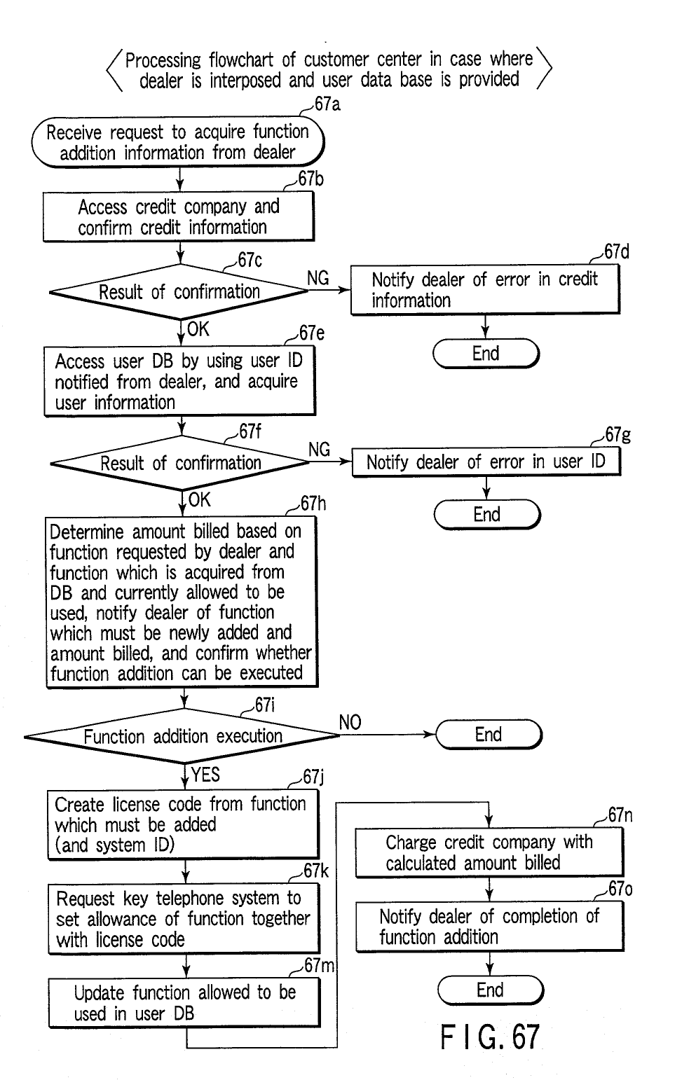

Moreover, FIG. 67 is a flowchart showing the processing operation of the customer center CC, and the above-described processing operation for adding the function is executed in accordance with the procedure shown at steps 67a to 67o.

That is, when the customer center CC receives a function addition request of the user from the dealer DL through the Internet INW at the step 67a, it first accesses the credit company CR and confirms the credit information at the step 67b. Then, if the credit information can not be confirmed, the processing advances from the step 67c to the step 67d, and the dealer DL is notified of an error in the credit implementation information. On the other hand, if the credit information can be confirmed, the processing proceeds from the step 67c to the step 67e, the customer center CC accesses the user data base DB and acquires the user information based on the user ID transmitted from the dealer DL. The user information includes the function information of the Key telephone unit owned by the user. Incidentally, if the access can not be consequently made, the processing proceeds from the step 67f to the step 67g, and the dealer DL is notified of an error in the user ID.

Subsequently, at the step 67h, the customer center CC calculates an amount billed based on the function requested from the dealer DL and the function information read from the user data base DB, notifies the dealer DL of a name of the function to be newly added and the amount billed, and inquires if the customer center CC can execute the processing. When the dealer DL transmits an execution request with respect to this inquiry, the customer center CC advances from the step 67i to the step 67j, creates a license code based on the function to be added and the system ID of the Key telephone unit BT, and transmits to the Key telephone unit BT a request to set the license code and use of the function to the enabled state at the step 67k.

Then, upon completing the setting to add the function in the Key telephone unit BT, the customer center CC updates the corresponding function information of the user stored in the user data base DB at the step 67m, and transmits to the credit company CR payment request information of the previously calculated amount billed at the step 67n. Moreover, when an answer informing that the payment request has been accepted from the credit company CR, the dealer DL which has sent the request is informed of completion of adding the function at the step 67o.

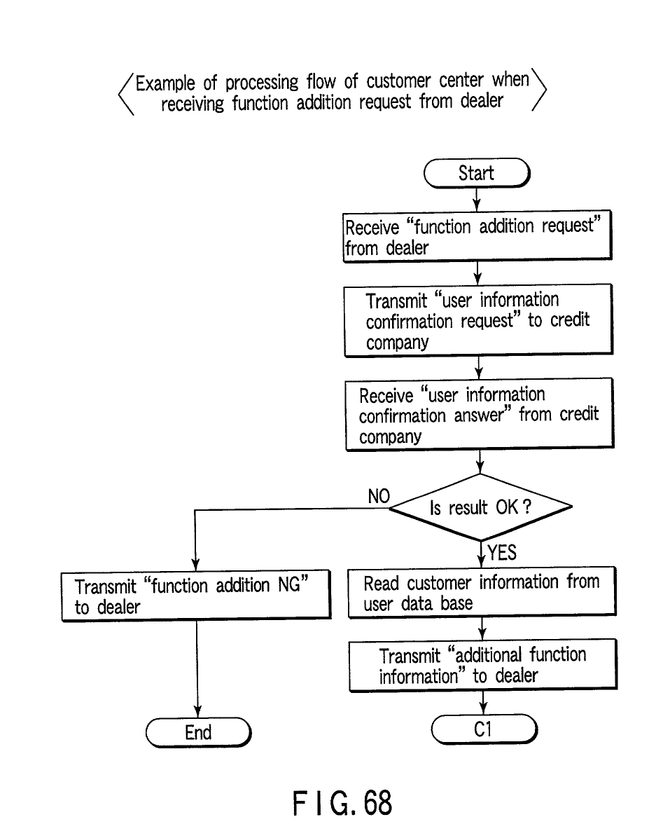

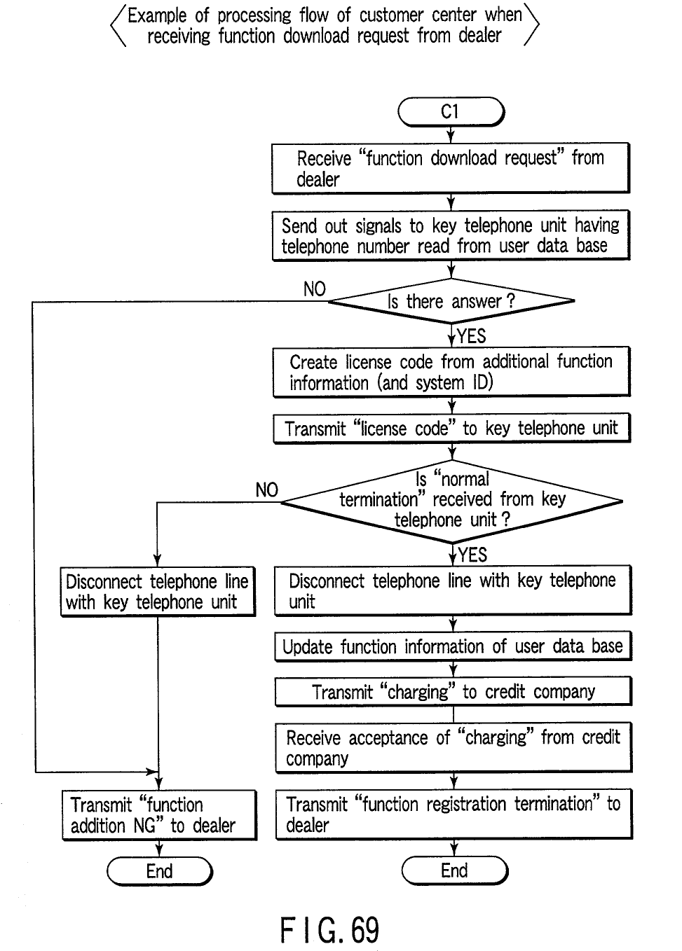

Incidentally, FIGS. 68 and 69 are flowcharts showing the detailed processing procedures of the customer center CC and illustrate the processing procedures when receiving the function addition request and the function download request from the dealer DL, respectively.

As described above, according to the function change method of the fourth embodiment, as similar to the third embodiment, since a series of steps from the request of the function change by the user and addition of the function in the Key telephone unit BT of the user are all automatically carried out through the communication network without requiring the labor while interposing the dealer DL between the user and the customer center CC, the time required for adding the function and the burden of the cost on the user can be reduced, and the labor and the cost required for changing the function in the dealer DL or the customer center CC can be greatly decreased.

In addition, as similar to the second embodiment, communication between the customer center CC and the Key telephone unit BT or judgment upon whether the function can be changed or the like is performed by utilizing the user information stored and managed in the user data base DB. Therefore, the information indicative of the function does not have to be acquired from the Key telephone unit BT each time, and the appropriately function change processing can be thereby executed with the simple procedure.

Additionally, the corresponding function information in the user data base DB is updated by the customer center CC after completion of the function addition processing. Thus, the information stored and managed in the user data base DB can be automatically constantly updated to latest information without manually executing the updating processing by a person in charge of the maintenance management in the customer center CC.

(Fifth Embodiment)

The fifth embodiment of the function change method according to the present invention executes the function addition processing with respect to the Key telephone unit of said user system in the system having the dealer interposed between said user system and the customer center.

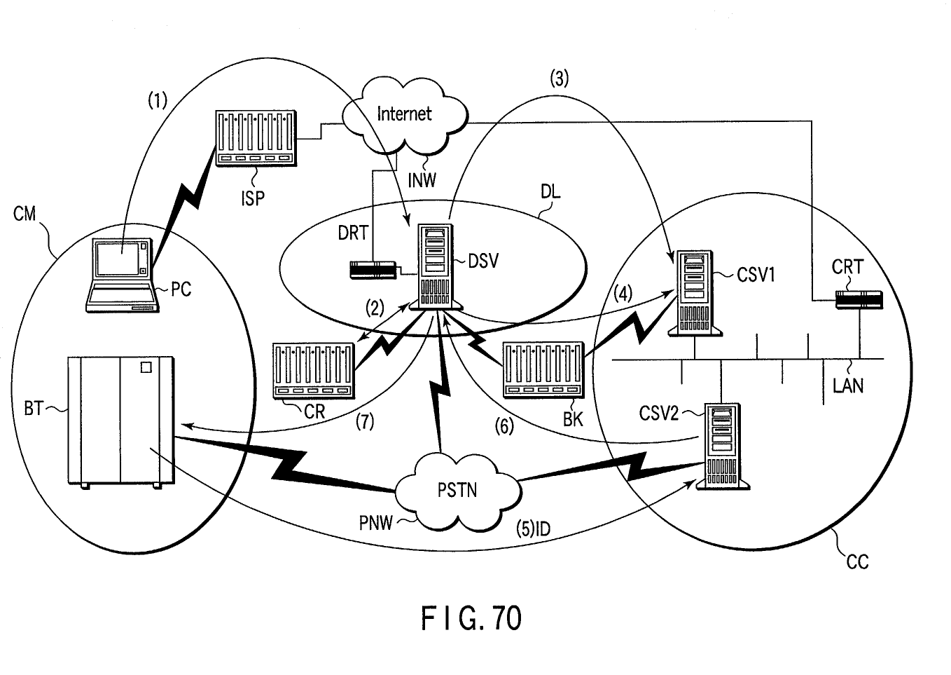

FIG. 70 is a schematic structural view of a support system which carries out the function change method in the fifth embodiment. Incidentally, in the drawing, like reference numerals denote parts similar to those in FIG. 49, thereby omitting the detailed explanation.

That is, the acceptance/charging/communication server DSV of the dealer DL is connected to the Key telephone unit BT of said user system CM and the license setting server CSV2 of the customer center CC through the public network PNW. Further, information required for the function addition processing is transmitted/received between the Key telephone unit BT and the license setting server CSV2.

Furthermore, the acceptance/charging/communication server DSV is connected to the credit company CR or the bank BK through a dedicated line. Moreover, the inquiry about the credit of the user or the operation for charging the agent commission required for the function addition is carried out between itself and the credit company CR or the bank BK.

That is, the user first transmits the function addition request from his/her maintenance personal computer PC to the dealer DL through the Internet INW as illustrated in (1). The function addition request includes information indicative of a function to be added, a credit number of the user and a telephone number of the Key telephone unit BT.

Subsequently, the dealer DL accesses the credit company CR and carries out the credit research of the user based on the credit number included in the function addition request. If there is no problem, the function addition request is transferred to the customer center CC as shown in (3).

The customer center CC accesses the Key telephone unit BT of the user through the public network based on the telephone number included in the function addition request, acquires the function information of the Key telephone unit, and makes judgment upon whether the function demanded by the user can be added based on the function information. Furthermore, if addition is possible, a license setup request is transmitted to the acceptance/charging/communication server DSV of the dealer DL through the public network PNW as shown in (6). Thereafter, the dealer DL transmits the license code according to the license setup request sent thereto through the public network PNW, and sets addition of the function.

The procedure when adding the function to the Key telephone unit BT in the above-described system will now be described.

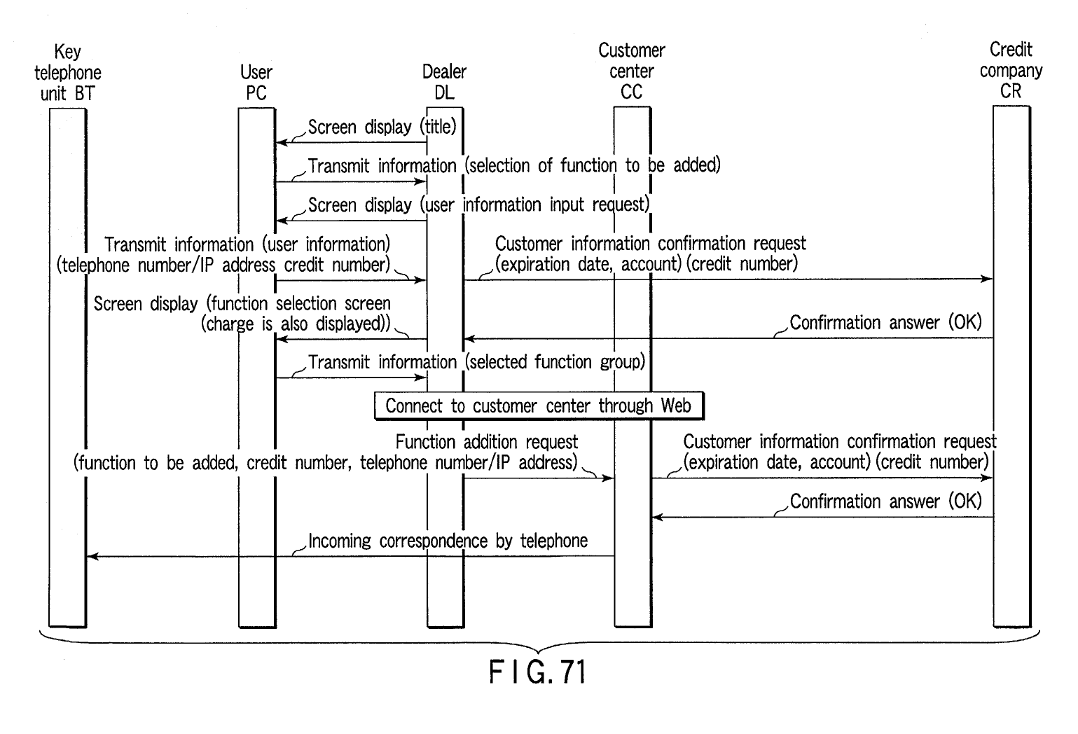

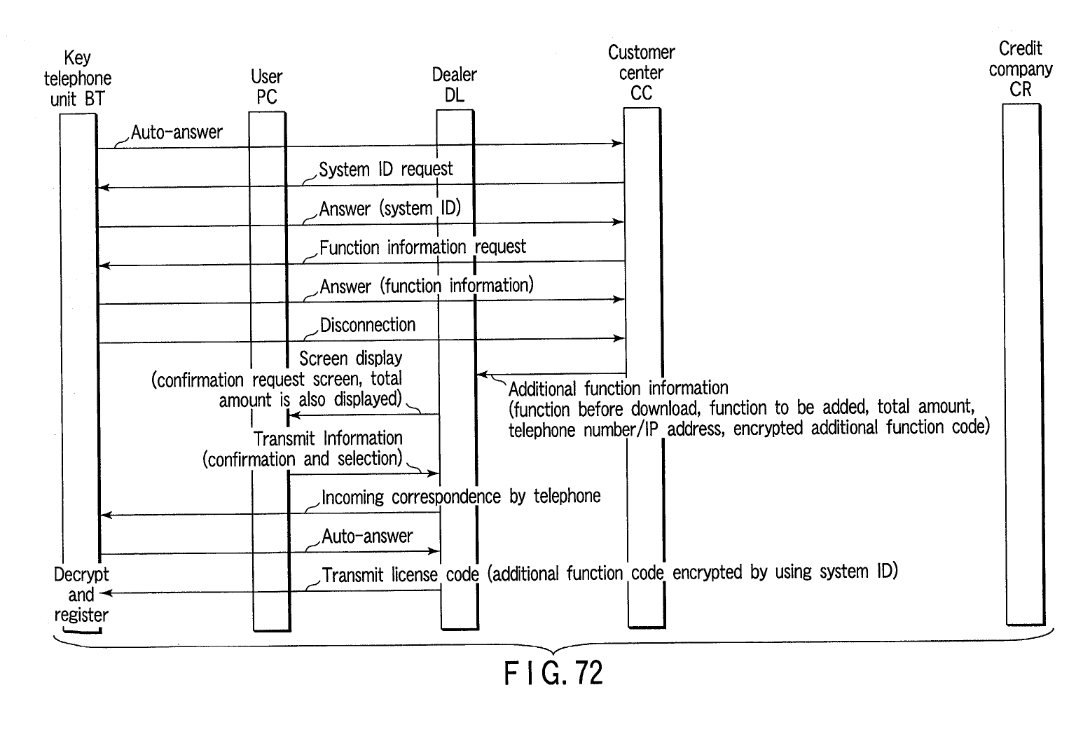

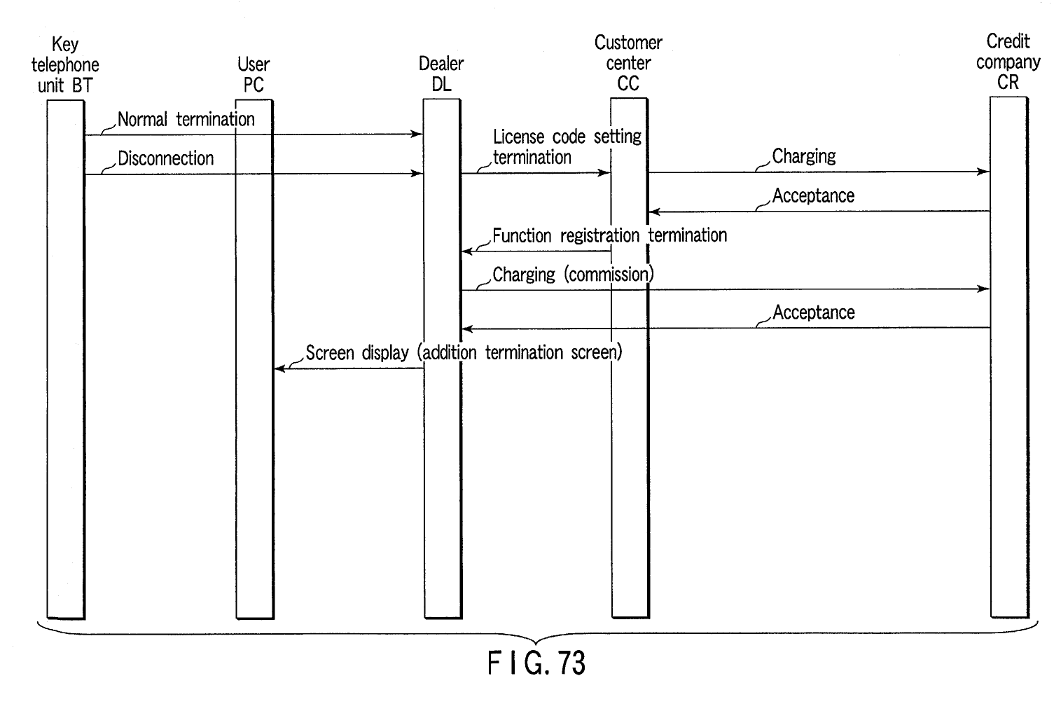

FIGS. 71 to 73 are sequence diagrams showing the operation for communicating information between the maintenance personal computer PC of said user system CM (user PC), the dealer DL, the customer center CC and the credit company CR.

When adding the function in the Key telephone unit BT, the user accesses a web page of the dealer DL through the Internet INW by using the maintenance personal computer PC, and inputs necessary matters concerning the function addition in accordance with the guidance on a screen downloaded from the dealer DL. The necessary matters to be inputted are information indicative of the function to be added, a credit number of the user, and a telephone number or an IP address allocated to the Key telephone unit BT from the public network PNW. Moreover, when input of such necessary matters is completed, the function addition request including such information is transmitted to the dealer DL.

Upon receiving the function addition request, the dealer DL first accesses the credit company CR through the dedicated line and inquires about the credit of the user based on the credit number of the user. With respect to this inquiry, the credit company CR makes judgment upon whether there is an account corresponding to the credit number, whether an expiration date of the credit is within a term of validity and whether suspension of use is set. Then, an answer of judgment is returned to the dealer DL.

The dealer DL makes judgment upon the credit of the user based on the answer from the credit company CR. If there is no problem, the dealer DL transfers the function addition request transmitted from the user to the customer center CC through the Internet INW.

When the customer center CC receives the function addition request, it accesses the credit company CR and requests the credit research of the user. Then, if there is no problem, the customer center CC accesses the Key telephone unit BT of the user through the public network PNW based on the telephone number included in the function addition request, and acquires the function information and the system ID from the Key telephone unit BT. Further, the customer center CC notifies the dealer DL of additional function information including the acquired function information and a table indicative of charges required for adding the function through the Internet INW. The dealer DL transfers the notified function information and charge table to the maintenance personal computer PC of the user through the Internet INW. Furthermore, upon receiving an answer of confirmation from the user with respect to notification of the function information and the charge table, the dealer DL accesses the Key telephone unit BT of the user through the public network PNW, and transmits a license code to the Key telephone unit BT of the user through the public network PNW. To the license code is inserted an instruction code used for setting the function to be added to “enabled”, and the instruction code is encrypted by using the system ID previously acquired from the Key telephone unit BT.

When the Key telephone unit BT receives the license code from the dealer DL, it first decrypts the instruction code included in the license code by using its system ID. Then, the key telephone unit BT changes a flag of the corresponding function in the function information setting processing table from “disabled” to “enabled”. Upon completion of the processing for setting addition of the function, the key telephone unit BT returns information indicative of normal termination of the function addition processing to the dealer DL.

When the dealer DL receives the function addition termination notification from the key telephone unit BT, it disconnects the line between itself and the key telephone unit BT and then notifies the customer center CC of completion of setting the license code.

When the customer center CC receives the license code setting termination notification from the dealer DL, it accesses the credit company CR and charges it with the additional function fee. Then, when the customer center CC receives an answer indicating that the payment request has been accepted from the credit company CR, it notifies the dealer DL of information indicative of completion of the function addition processing. Upon receiving the processing termination notification, the dealer DL charges the credit company CR with the agent commission.

In this manner, the function that the user wants to add is set to the enabled state in the key telephone unit BT, and thereafter the newly added optional service function can be used in the key telephone unit BT of the user.

The structure of each part in the support system which carries out the above-described function change method is as follows, for example.

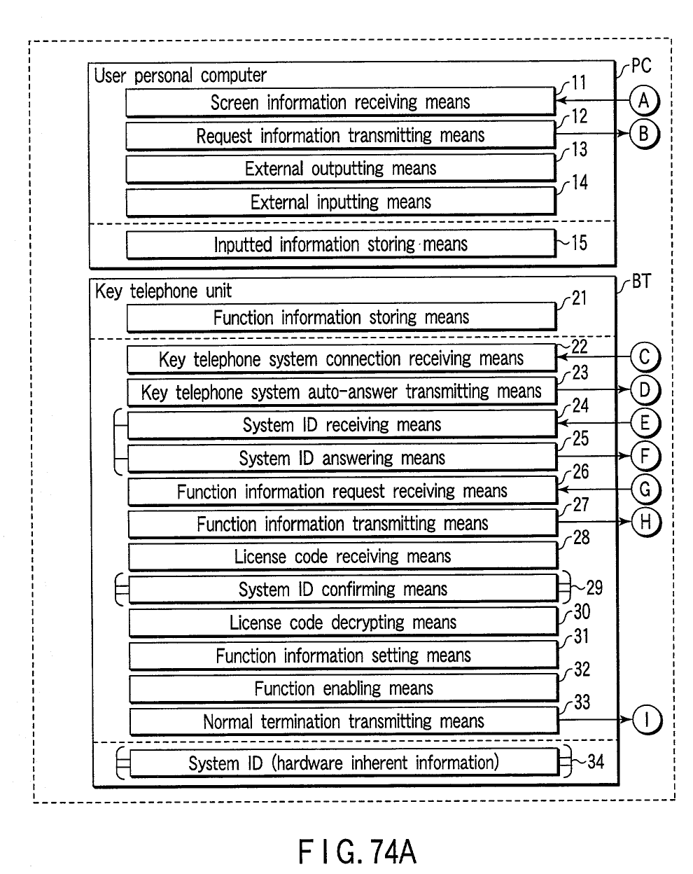

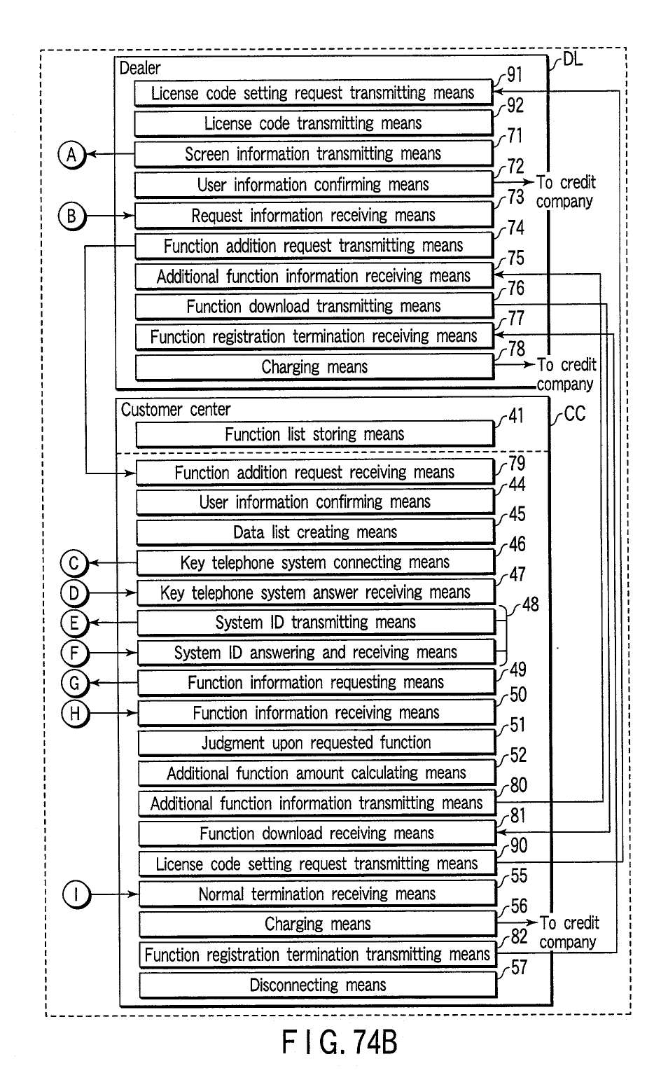

FIG. 74 is a block diagram showing the function configuration of the maintenance personal computer PC, the key telephone unit BT, the dealer DL and the customer center CC. Incidentally, in the drawing, like reference numerals denote parts similar to those in FIG. 7, thereby omitting the detailed explanation.

That is, the customer center CC includes license code setting request transmitting means 90. The license code setting request transmitting means 90 transmits to the dealer DL the function addition request information received from the maintenance personal computer PC by the function addition request receiving means 79, the function information and the system ID of the Key telephone unit BT received by the function information receiving means 50.

Moreover, the dealer DL further includes license code setting request receiving means 91 and license code transmitting means 92.

The license code setting request receiving means 91 receives the function addition request information, the function information and the system ID of the Key telephone unit BT transmitted by the customer center CC.

The license code transmitting means 92 accesses the key telephone unit BT through the public network PNW based on the telephone number included in the received function addition request information, encrypts the license code by using the system ID included in the function information and transmits the encrypted license code to the key telephone unit BT.

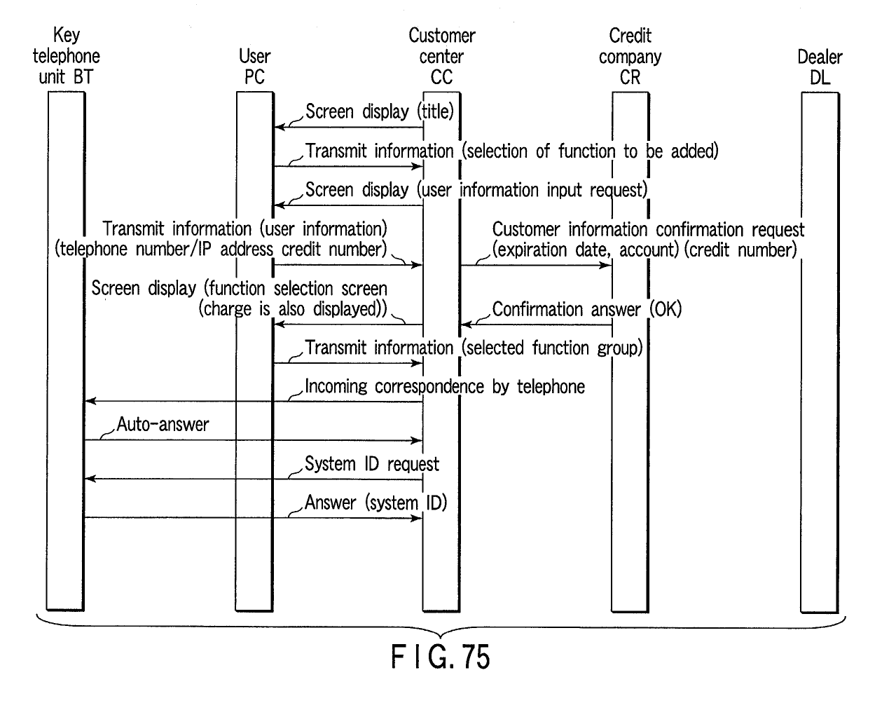

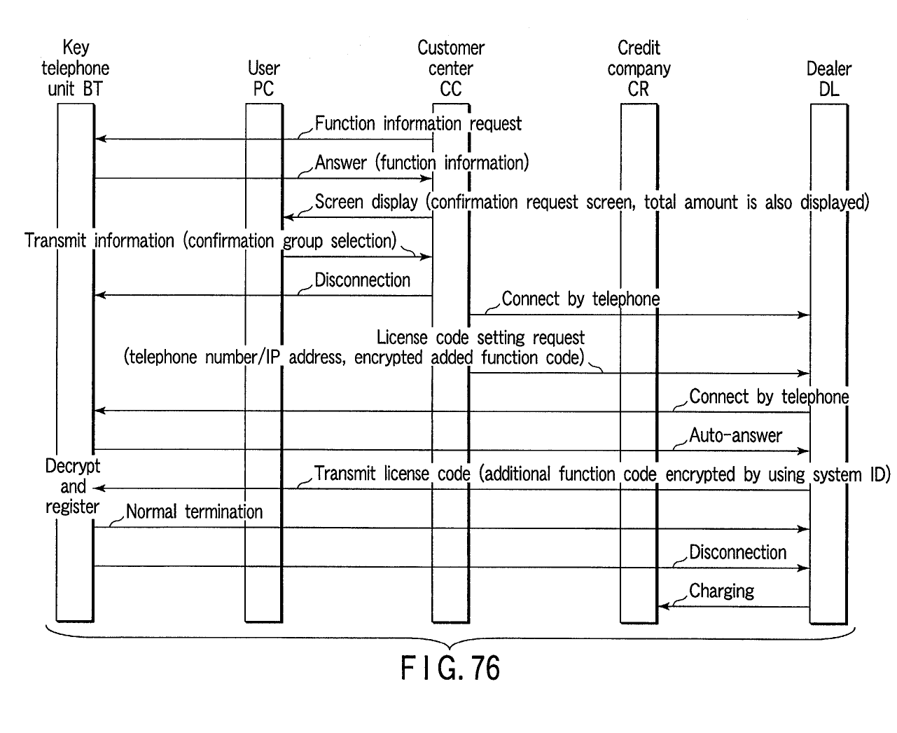

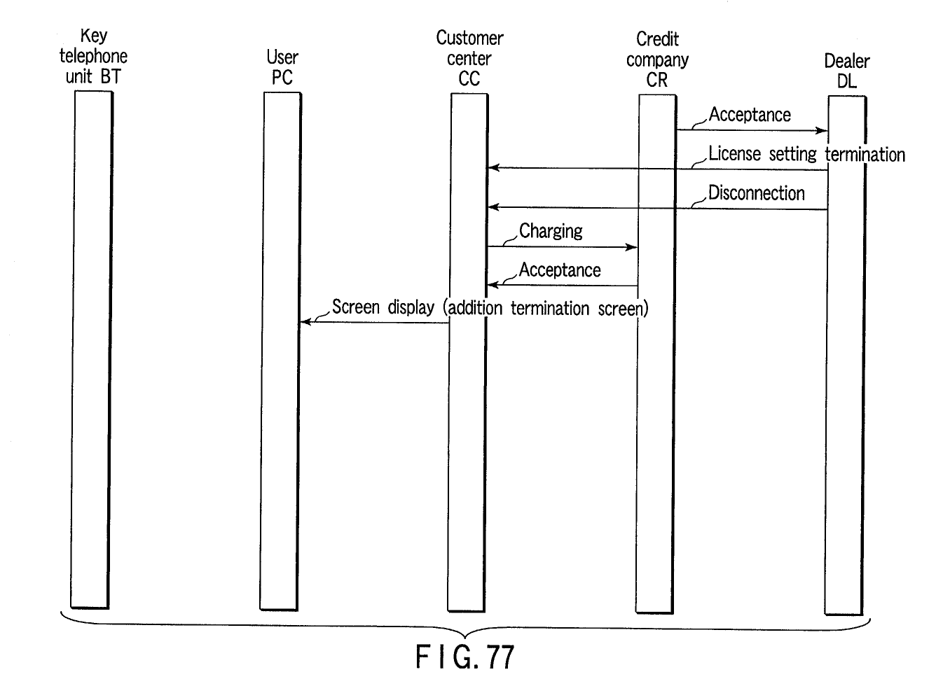

Incidentally, although the above has described the example where the dealer DL is interposed from the beginning in the transmission/reception procedures, the dealer DL may be interposed when setting the function to the Key telephone unit BT as shown in FIGS. 75 to 77.

In this case, when adding the function of the key telephone unit BT, the user accesses the customer center CC through the Internet INW by using the maintenance personal computer PC, and inputs necessary matters concerning the function addition in accordance with the guides in a screen downloaded from the customer center CC. The necessary matters to be inputted are information indicative of the function to be added, a credit number, and a telephone number or an IP address allocated to the key telephone unit BT from the public network PNW. In addition, when input of these necessary matters is completed, the function addition request including such information is transmitted to the customer center CC.

Upon receiving the function addition request, the customer center CC first accesses the credit company CR through a dedicated line, and inquires about the credit of the user based on the credit number of the user. With respect to this inquiry, the credit company CR makes judgment upon whether there is an account corresponding to the credit number, whether an expiration date of the credit is within a term of validity, and whether suspension of use is set. Additionally, the answer is returned to the customer center CC.

The customer center CC makes judgment upon the credit of the user based on the answer from the credit company CR. If there is no problem, the customer center CC displays a function selection screen together with the charge with respect to the maintenance personal computer PC. When the function is selected, the customer center CC accesses the key telephone unit BT of the user through the public network PNW based on the telephone number included in the function addition request, and acquires the function information and the system ID from the Key telephone unit BT. Further, based on the acquired function information, the customer center CC makes judgment upon whether the function that the user wants to add has been already used and whether this function can be added if it has not been used, and notifies the maintenance personal computer PC of the user of a result of judgment together with the cost required for adding the function.

Furthermore, upon receiving an answer of confirmation from the user with respect to this notification, the customer center CC disconnects the line between itself and the key telephone unit BT, subsequently accesses the dealer DL through the public network PNW, and transmits to the dealer DL the information indicative of the function to be added and the license code setting request including the telephone number or the IP address allocated to the key telephone unit BT from the public network PNW.

Then, the dealer DL accesses the key telephone unit BT of the user through the public network PNW based on the telephone number included in the license code setting request, and transmits the license code as function change control information. To the license code is inserted an instruction code used for setting the function to be added to “enabled”, and this instruction code is encrypted by the system ID previously acquired from the key telephone unit BT.

When the key telephone unit BT receives the license code from the dealer DL, it first decrypts the instruction code included in the license code by using its system ID. Then, the key telephone unit BT changes a flag of the corresponding function in the function information setting processing table from “disabled” to “enabled”. Then, when the processing for setting the function addition is terminated, the key telephone unit BT returns to the dealer DL information indicative of normal termination of the function addition processing.

When the dealer DL receives the function addition termination processing from the Key telephone unit BT, it disconnects the line between itself and the Key telephone unit BT, then accesses the credit company CR and requests payment of the function addition charge. At this moment, the dealer DL calculates an amount billed with respect to each function which the user wants to add and which has been actually set to the enabled state, and creates an electronic bill of particulars. Moreover, the electronic bill of particulars is included in the payment request information and transmitted to the credit company CR.

When the credit company CR receives the payment request information, it first performs user authentication and makes judgment upon whether the transaction is possible based on the credit number of the user included in the payment request information. In addition, if the transaction is possible, the credit company CR executes the payment acceptance processing of the charge based on the electronic bill of particulars included in the payment request information. Then, upon completing the payment acceptance processing, the credit company CR returns an answer informing that the payment request has been accepted to the dealer DL which has sent the request.

When the dealer DL receives the answer informing acceptance of the payment request from the credit company CR, it transmits information indicative of completion of setting the license to the customer center CC.

When the customer center CC receives this information, it disconnects the line between itself and the dealer DL, thereafter accesses the credit company CR and charges it with the additional function fee. Additionally, when the customer center CC receives an answer informing that the payment request has been accepted from the credit company CR, it notifies the user's maintenance personal computer PC of information about termination of the function addition processing.

In this manner, the function that the user wants to add is set to the enabled state in the key telephone unit BT, and thereafter the newly added optional service function can be used in the key telephone unit BT.

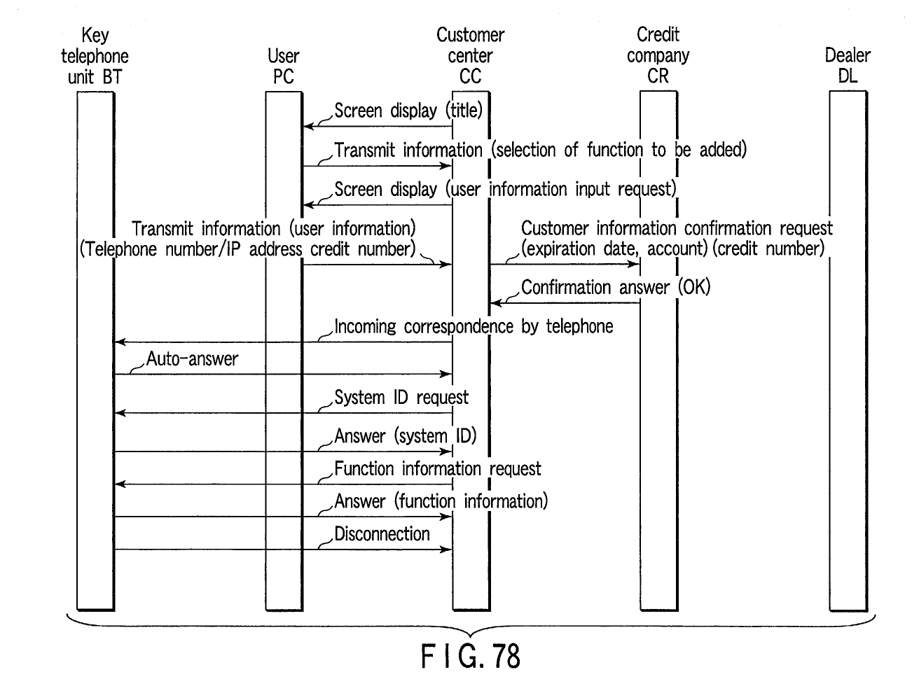

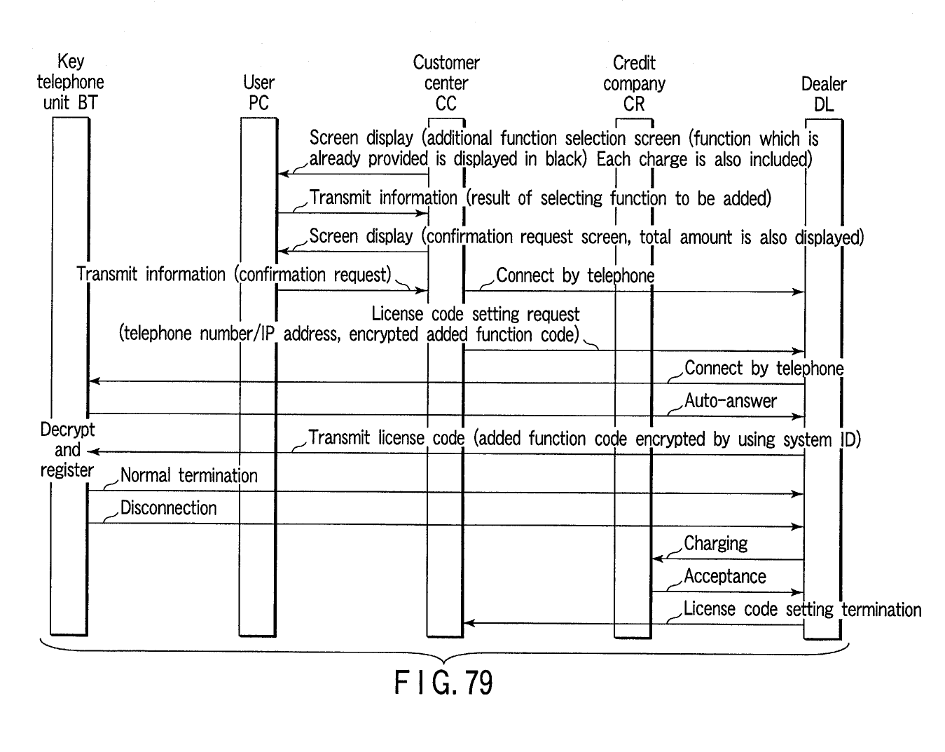

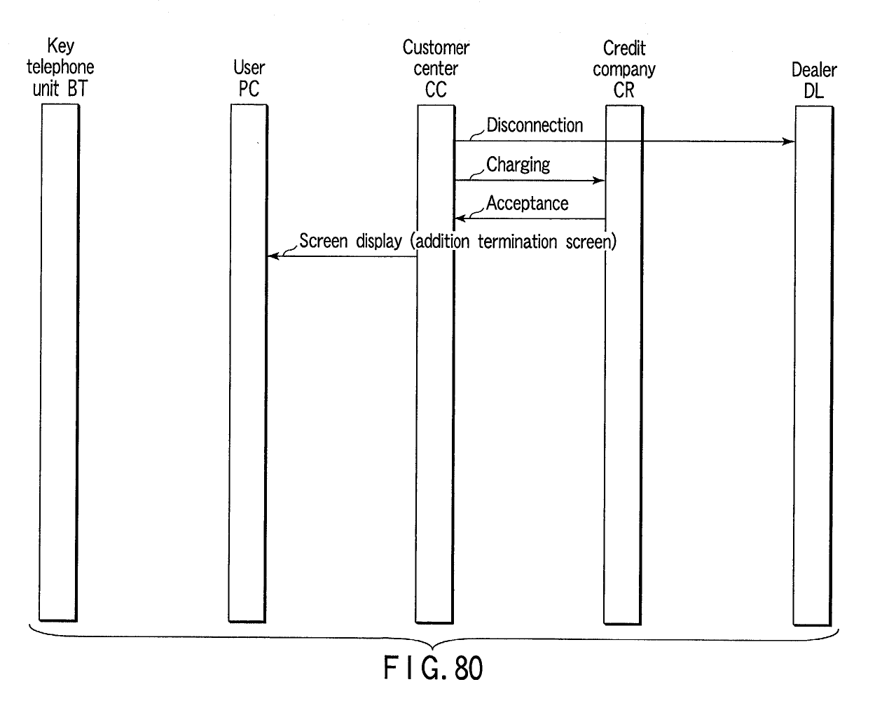

Incidentally, although the above has described the case where the user is caused to confirm the current functions in the key telephone unit BT and then request the function to be added, the user may be caused to input the function to be added from the beginning without confirming the current functions as shown in FIGS. 78 to 80.

As described above, according to the function change method of the fifth embodiment, since a series of steps from the request of the function change by the user to the function addition in the key telephone unit BT of the user are all automatically carried out through the communication network without requiring the labor while interposing the dealer DL between said user system CM and the customer center CC, the time required for adding the function and the burden of the cost on the user can be reduced, and the labor and the cost required for changing the function in the dealer DL or the customer center CC can be greatly decreased.

Further, since the dealer DL makes judgment upon whether the function can be added based on the function information acquired from the key telephone unit BT as a function addition target, the appropriate function addition processing can be executed in accordance with each key telephone unit BT without making any error, and the burden of processing in the customer center CC can be thereby reduced. Furthermore, since the dealer DL encrypts the license code by using the system ID of the key telephone unit BT and transfers it to the Key telephone unit BT, the erroneous function addition or the fraudulent function addition processing can be prevented from being executed, and the burden of processing in the customer center CC can be reduced.

(Sixth Embodiment)

The sixth embodiment of the function change method according to the present invention adds a function to the key telephone unit of said user system in the system having the dealer interposed between said user system and the customer center and including the user data base in the customer center.

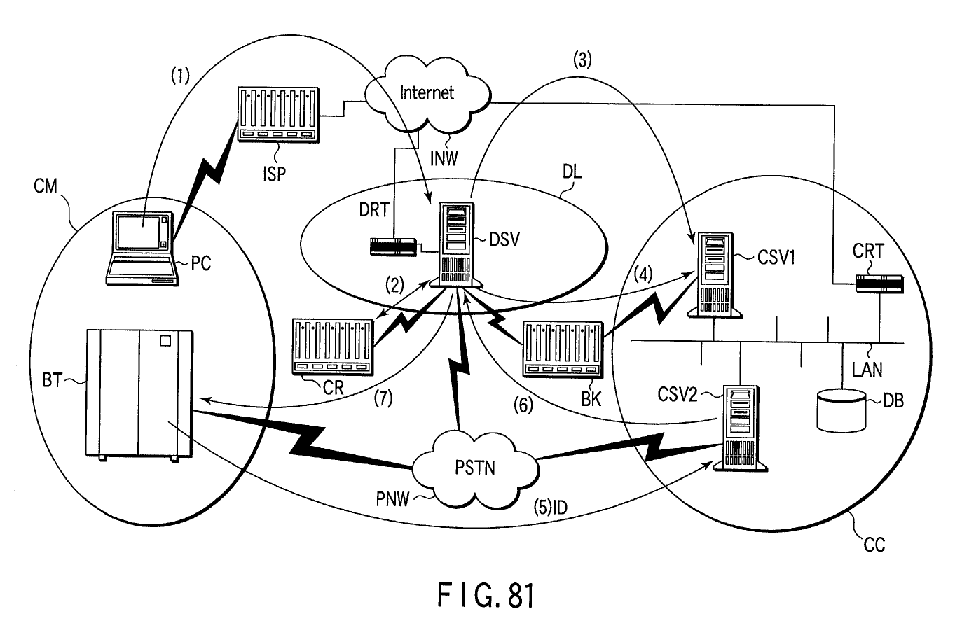

FIG. 81 is a schematic structural view showing a support system which carries out the function change method in the sixth embodiment. Incidentally, in the drawing, like reference numerals denote parts similar to those in FIG. 61, thereby omitting the detailed explanation.

That is, the acceptance/charging/communication server DSV is connected to the key telephone unit BT of said user system CM and the license setting server CSV2 through the public network PNW. Moreover, information required for the function addition processing is transmitted/received between the key telephone unit BT and the license setting server CSV2.

In addition, the acceptance/charging/communication server DSV is connected to the credit company CR or the bank BK through a dedicated line. Additionally, the inquiry about the credit of the user or the operation for charging the agent commission required for adding the function is carried out between this server and the credit company CR or the bank BK.

On the other hand, the user data base DB is provided to the customer center CC. This user data base DB stores therein a system ID, function information and a telephone number of the key telephone unit BT owned by each user in association with a unique user ID given to each user.

When the function addition request of the user is transferred from the dealer DL, the acceptance/charging server SCV1 or the licenser server CSV2 of the customer center CC accesses the user data base DB based on the user ID included in the function addition request and reads the system ID, the function information and the telephone number of the key telephone unit BT owned by the user. Then, judgment upon whether the function desired by the user can be added, access to the key telephone unit BT and transmission of the license code are performed by using the read information.

That is, as shown in (1), the function addition request is first transmitted from the maintenance personal computer PC of the user to the dealer DL through the Internet INW. The function addition request includes information indicative of the function to be added, individual identification information of the user (user ID) and a credit number.

Subsequently, as shown in (2), the dealer DL accesses the credit company based on the credit number included in the function addition request and conducts the credit research of the user. If there is no problem, as shown in (3), the function addition request is transferred to the customer center CC.

The customer center CC accesses the user data base DB based on the user identification information included in the function addition request, and reads the system ID, the function information and the telephone number of the key telephone unit of the user as shown in (5). Then, judgment is made upon whether the function requested by the user can be added based on the function information, and the user is informed of a result of judgment through the dealer. If addition is possible, a license setup request for the function to be added is transmitted to the acceptance/charging/communication server DSV of the dealer DL through the public network PNW as shown in (6). Thereafter, as illustrated in (7), the dealer DL transmits the license code corresponding to the received license setup request to the Key telephone unit BT through the public network PNW, thereby setting addition of the function.

Description will now be given as to the procedure when adding the function to the key telephone unit BT in the system mentioned above.

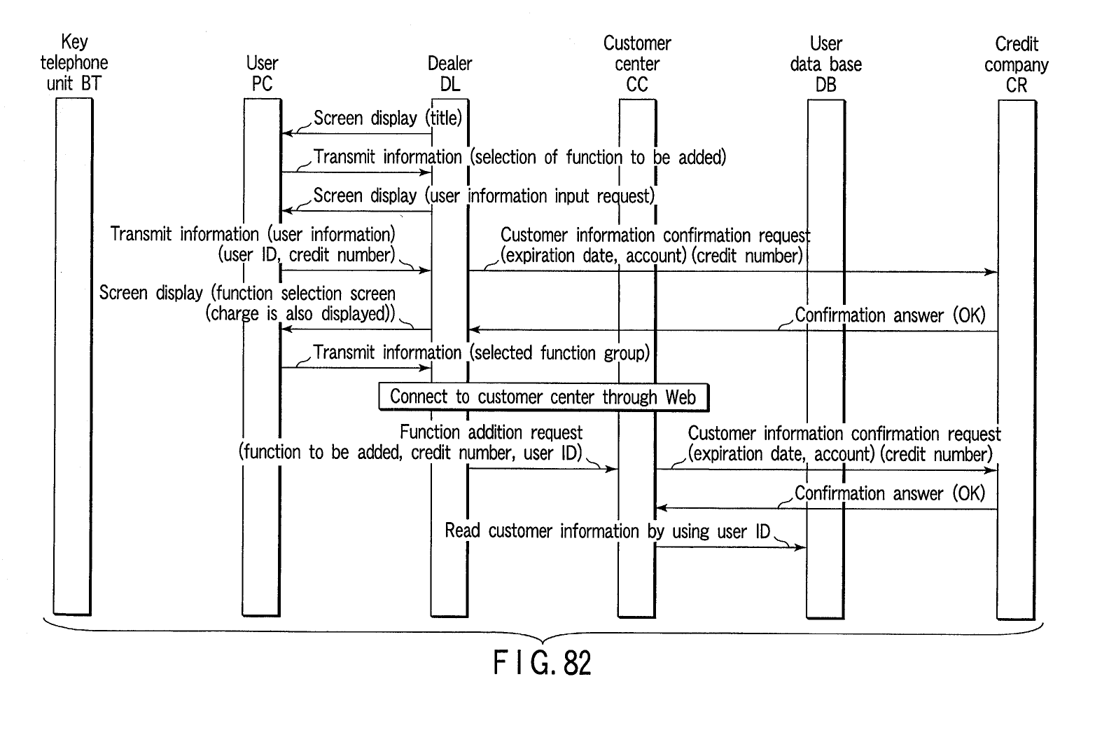

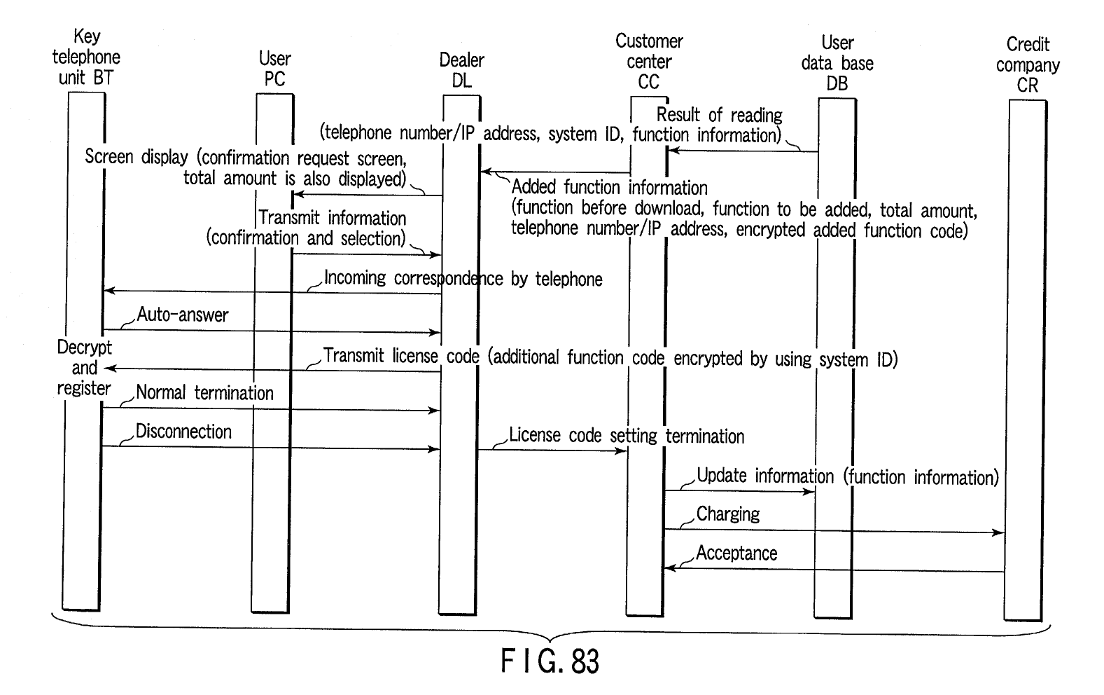

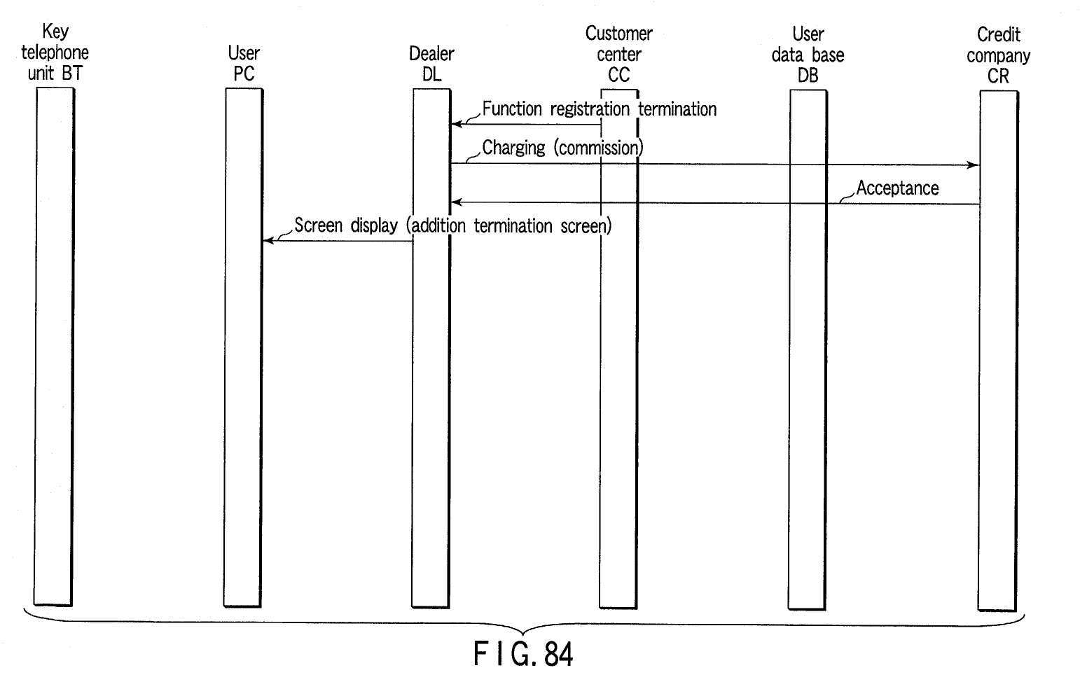

FIGS. 82 to 84 are sequence diagrams showing the operation for communicating information between the maintenance personal computer PC of said user system CM (user PC), the dealer DL, the customer center CC and the credit company CR.

When adding the function of the key telephone unit BT, the user accesses a web page of the dealer DL through the Internet INW by using the maintenance personal computer PC, and inputs necessary matters concerning addition of the function in accordance with the guidance in a screen downloaded from the dealer DL. The necessary matters to be inputted are information indicative of the function to be added, an ID and a credit number of the user. Further, when input of these necessary matters are terminated, the function addition request including such information is transmitted to the dealer DL.

Upon receiving the function addition request, the dealer DL first accesses the credit company through a dedicated line, and inquires about the credit of the user based on the credit number of the user. With respect to this inquiry, the credit company makes judgment upon whether there is an account corresponding to the credit number, whether an expiration date of the credit is within a term of validity and whether suspension of use is set. Furthermore, the answer is returned to the dealer DL.

The dealer DL makes judgment upon the credit of the user based on the answer from the credit company CR. If there is no problem, the dealer DL transfers the function addition request transmitted from the user to the customer center CC through the Internet INW.

When the customer center CC receives the function addition request, it accesses the credit company CR and requests the credit research of the user. Then, if it is confirmed that there is no problem, the customer center CC accesses the user data base DB based on the user ID included in the function addition request, and reads the system ID, the function information and the telephone number of the key telephone unit BT owned by the user.

Subsequently, the dealer DL is informed of the read function information, the function information before download and a table showing charges required for adding the function through the Internet INW. The dealer DL transfers the notified function information and charge table to the maintenance personal computer PC of the user through the Internet INW. In addition, upon receiving an answer of confirmation from the user with respect to notification of the function information and the charge table, the dealer DL accesses the key telephone unit BT of the user through the public network PNW and transmits the license code to the key telephone unit BT of the user through the public network PNW. To the license code is inserted an instruction code for setting the function to be added to “enabled”, and this instruction code is encrypted by using the system ID previously read from the user data base DB.

When the key telephone unit BT receives the license code from the dealer DL, it first decrypts the instruction code included in the license code by using its system ID. Then, the Key telephone unit BT changes a flag of the corresponding function in the function information setting processing table from “disabled” to “enabled” in accordance with the decrypted instruction code. Upon completing the function addition setting processing, the key telephone unit BT returns information indicative of normal termination of the function addition processing to the dealer DL.

When the dealer DL receives the function addition termination notification from the key telephone unit BT, it disconnects the line between itself and the key telephone unit BT and then notifies the customer center CC of completion of setting the license code.

When the customer center CC receives the license code setting termination notification from the dealer DL, it updates information with respect to the user data base DB and accesses the credit company CR in order to charge the additional function fee. Then, upon receiving an answer informing that the payment request has been accepted from the credit company CR, the dealer DL is notified of information indicative of termination of the function addition processing. When the dealer DL receives the processing termination notification, it charges the credit company CR with the agent commission.

In this way, the function that the user wants to add is set to the enabled state in the key telephone unit BT, and thereafter the newly added optional service function can be used in the key telephone unit BT of the user.

The structure of each part in the support system which realizes the above-described function change method is as follows.

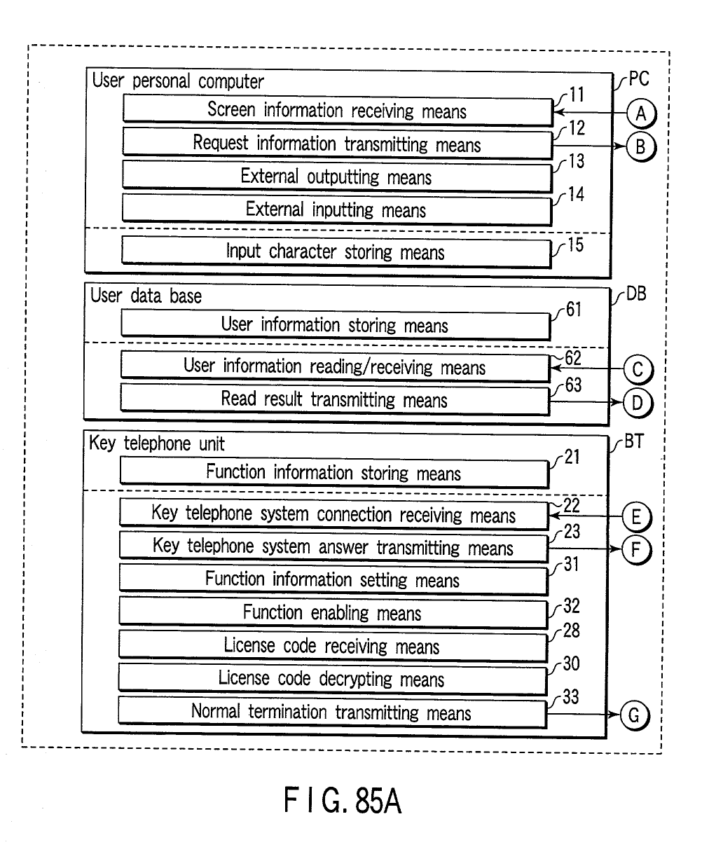

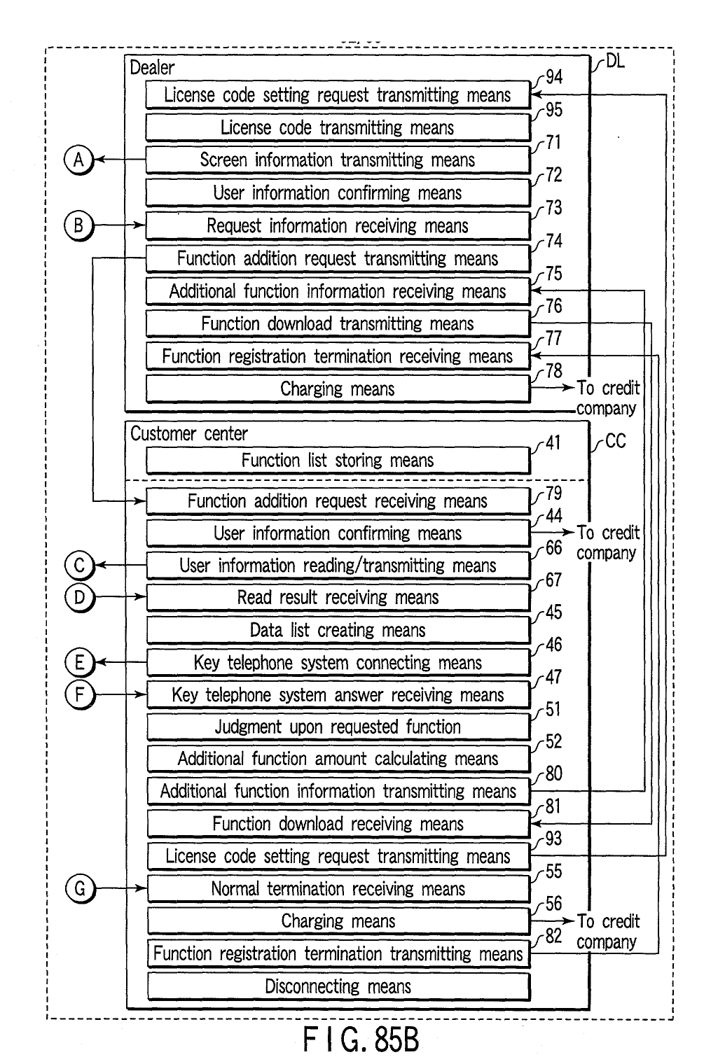

FIG. 85 is a block diagram showing the function configuration of the maintenance personal computer PC, the key telephone unit BT and the customer center CC. Incidentally, in the drawing, like reference numerals denote parts equal to those in FIG. 74, thereby omitting the detailed explanation.

That is, the customer center CC includes license code setting request transmitting means 93. The license code setting request transmitting means 93 transmits to the dealer DL the function addition request information received from the maintenance personal computer PC by the function addition request receiving means 79, and the user information including a telephone number, a system ID and function information of the Key telephone unit BT read from the user data base DB by the read result receiving means 67.

In addition, the dealer DL further includes license code setting request receiving means 94 and license code transmitting means 95.

The license code setting request receiving means 94 receives function addition request information and user information transmitted from the customer center CC.

The license code transmitting means 92 accesses the key telephone unit BT through the public network PNW based on the telephone number included in the received user information, encrypts the license code by using the system ID included in the user information, and transmits the encrypted license code to the key telephone unit BT.

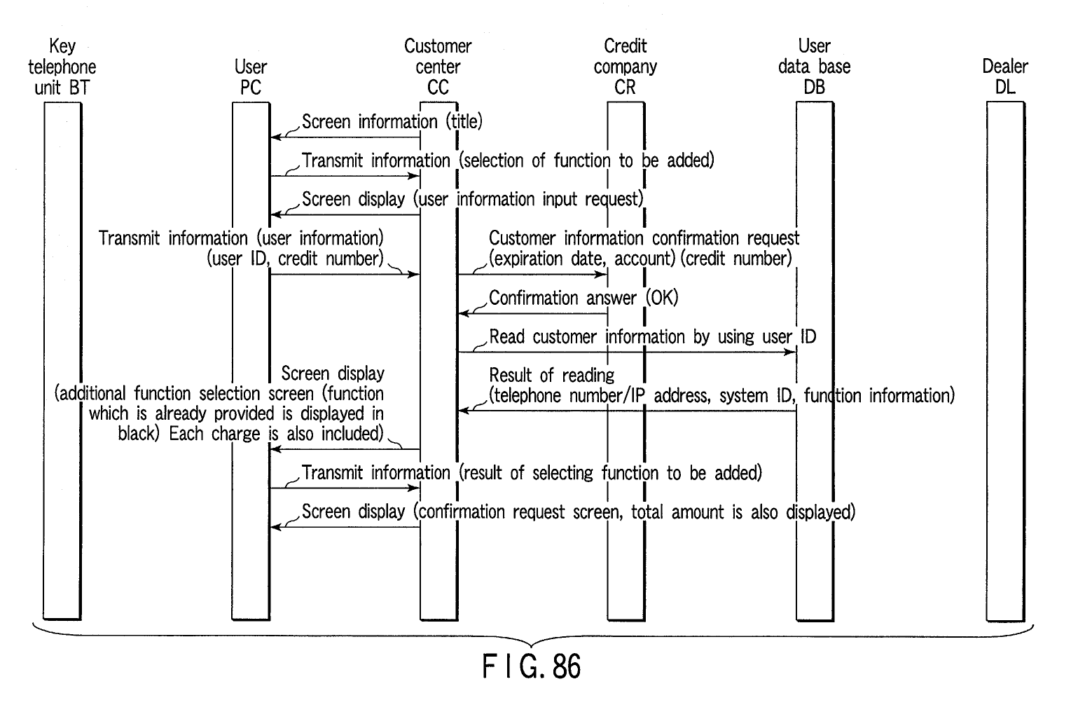

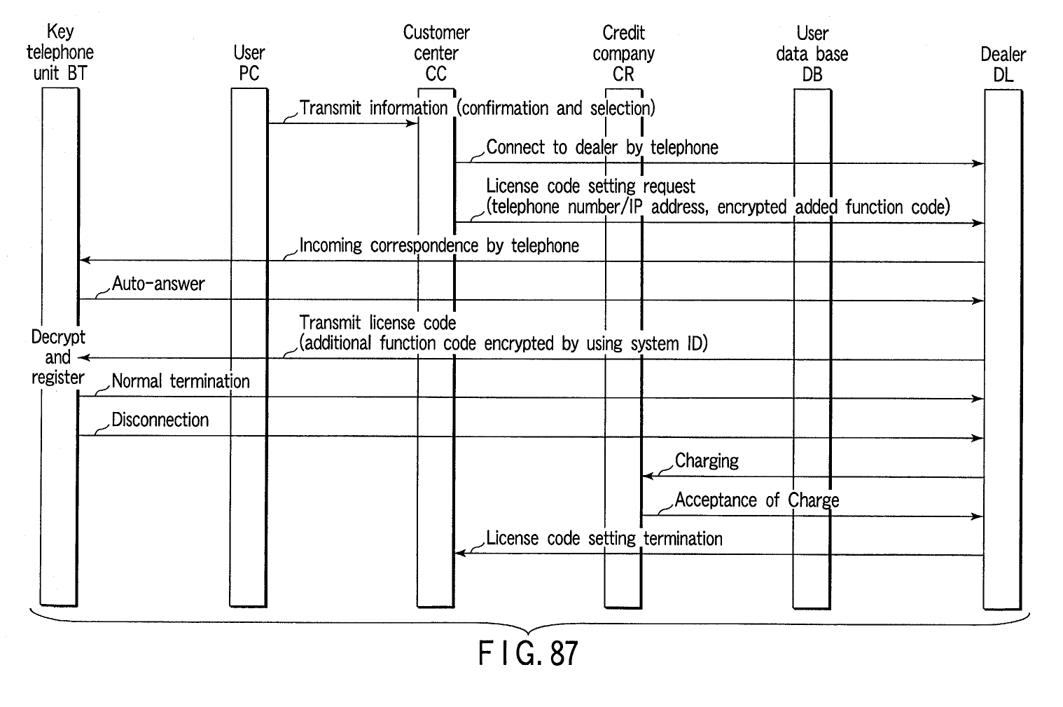

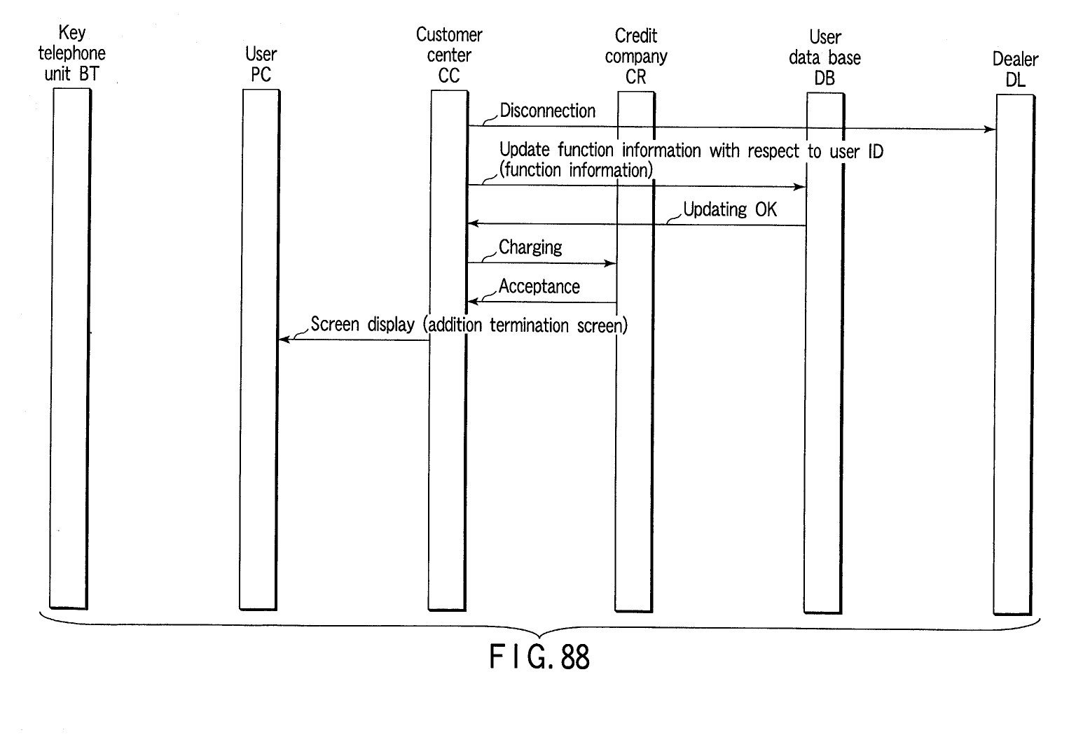

Incidentally, although the above has described the example where the dealer DL is interposed from the beginning in the transmission/reception procedures, the dealer DL may be interposed when setting the function with respect to the key telephone unit BT as shown in FIGS. 86 to 88.

In this case, when adding the function of the key telephone unit BT, the user accesses the customer center CC through the Internet INW by using the maintenance personal computer PC, and inputs necessary matters concerning the function addition in accordance with the guidance in a screen downloaded from the customer center CC. The necessary matters to be inputted are information indicative of the function to be added, an ID and a credit number of the user. Additionally, upon completing input of these necessary matters, the function addition request including such information is transmitted to the customer center CC.

When the customer center CC receives the function addition request, it first accesses the credit company CR through the dedicated line and inquires about the credit of the user based on the credit number of the user. With respect to this inquiry, the credit company CR makes judgment upon whether there is an account corresponding to the credit number, whether an expiration date of the credit is within a term of validity and whether suspension of use is set. Then, the answer is returned to the customer center CC.

The customer center CC judges the credit of the user based on the answer from the credit company CR. If there is no problem, the customer center CC accesses the user data base DB based on the user ID included in the function addition request, and reads a system ID, function information and a telephone number of the key telephone unit BT owned by the user.

Subsequently, the customer center CC displays a function selection screen together with the charge with respect to the maintenance personal computer PC. When the function is selected, the customer center CC accesses the dealer DL through the public network PNW, and transmits to the dealer DL information indicative of the function to be added and the license code setting request including the telephone number or the IP address allocated to the key telephone unit BT from the public network PNW.

Then, the dealer DL accesses the key telephone unit BT of the user through the public network PNW based on the telephone number included in the license code setting request, and transmits the license code as function change control information. To the license code is inserted an instruction code used for setting the function to be added to “enabled”, and this instruction code is encrypted by using the system ID previously acquired from the key telephone unit BT.

The dealer DL receives the function addition termination notification from the key telephone unit BT. After the line between the dealer DL and the key telephone unit BT is disconnected, the dealer DL accesses the credit company CR and requests payment of the function addition charge. At this moment, the dealer DL calculates an amount billed with respect to each function which the user wants to add and which has been actually set to the enabled state, and creates an electronic bill of particulars. Additionally, the electronic bill of particulars is included in the payment request information and transmitted to the credit company CR.

When the credit company CR receives the payment request information, it first performs user authentication and makes judgment upon whether the transaction is possible based on the credit number of the user included in the payment request information. Then, if the transaction is possible, the credit company CR executes the payment acceptance processing for the charge based on the electronic bill of particulars included in the payment request information. Further, upon completion of the payment acceptance processing, the credit company CR returns an answer informing that the payment request has been accepted to the dealer DL which has sent the request.

When the dealer DL receives the answer informing that the payment request has been accepted from the credit company CR, it transmits to the customer center CC information indicative of completion of the license setting.

Upon receiving this information, the customer center CC disconnects the line between itself and the dealer DL. Thereafter, the customer center CC updates the information with respect to the user data base DB and accesses the credit company CR in order to charge the additional function fee. Furthermore, when the customer center CC receives an answer informing that the payment request has been accepted from the credit company CR, it notifies the user's maintenance personal computer PC of information indicative of termination of the function addition processing.

In this manner, the function that the user wants to add is set to the enabled sate in the key telephone unit BT, and thereafter the newly added optional service function can be used in the key telephone unit BT of the user.

As described above, according to the function change method of the sixth embodiment, as similar to the fourth embodiment, since a series of steps from the request for changing the function by the user to addition of the function in the key telephone unit BT of the user are all automatically carried out through the communication network without requiring the labor while interposing the dealer DL between the user and the customer center CC, the time required for adding the function and the burden of the cost on the user can be reduced, and the labor and the cost required for changing the function in the dealer DL or the customer center CC can be greatly decreased.

Moreover, as similar to the second embodiment, communication between the customer center CC and the key telephone unit BT or judgment upon whether the function can be changed is carried out by utilizing the user information stored and managed in the user data base DB. Therefore, the information indicative of the function does not have to be acquired from the key telephone unit BT each time, thereby executing the appropriate function change processing with the simple procedure.

In addition, after completion of the function addition processing the corresponding function information in the user data base DB is updated by the customer center CC. Accordingly, the information stored and managed in the user data base DB can be automatically constantly updated to latest information without manually executing the updating processing by a person in charge of the maintenance management in the customer center CC.

(Any Other Embodiment)

Although the case where the user data base DB is set in the customer center CC has been described in connection with the second and fourth embodiments, the user data base DB may be provided to the dealer DL or may be provided to a third party body other than the customer center CC and the dealer DL.

Additionally, the credit number is transmitted from the user when sending the function addition request in each embodiment mentioned above. However, the present invention is not restricted thereto, and the credit number may be stored in the user data base DB in associated with the user ID, and the customer center CC or the dealer DL may access the use data base DB based on the user ID transmitted from the user in order to acquire the credit number. By doing so, only transmitting the credit number of the user when registering the user information in the user data base DB can suffice, and the credit number can be thereby prevented from being underlooked on the communication network when transmitting the function addition request, thus improving the security.

Further, in each of the foregoing embodiments, a program used for executing various kinds of optical service functions is stored in the key telephone unit BT in advance, and the enabled/disabled states of each function are managed in the service information table by using a flag. Furthermore, addition of the function is set by transmitting the license code from the customer center CC and changing the flag to “enabled”. However, the present invention is not restricted thereto, and the program used for executing the function that the user wants to add may be downloaded to the key telephone unit BT from the customer center CC and then executed.

Moreover, in each of the foregoing embodiments, only the license code corresponding to the function to be added is transmitted from the customer center CC to the key telephone unit BT, and the flag of the function to be added is set to “enabled” by using this license code. However, the license codes of all functions including the license code corresponding to the function to be added may be transmitted so that all of the service information table of the key telephone unit BT can be rewritten.

In addition, the above has described the example where the enabled/disabled states of a plurality of functions provided to the Key telephone unit are variably set from the customer center in each of the foregoing embodiments. However, the present invention is not restricted thereto, and the present invention can be likewise applied to the case where the enabled/disabled states of each of a plurality of ports previously provided to the Key telephone unit are variably set from the customer center. In this case, the port enabled/disabled flag shown in, e.g., FIG. 25 can be realized by selectively controlling this flag to be turned on/off in accordance with an instruction from the customer center, as similar to the case of functions.

Additionally, although the above has described the case where the function is added in each of the foregoing embodiments, the currently used function can be also deleted.

Further, although the above has described the case where the customer center has access based on the telephone number of the Key telephone unit included in the function addition request information transmitted from said user system in order to acquire the function information and the system ID of the Key telephone unit, the present invention is not restricted thereto, and the function information and the system ID of the Key telephone unit may be included in the function addition request information and then transmitted as long as the personal computer is connected to the Key telephone unit.

Besides, a procedure for changing a function and its content, a structure of the support system or a content of its operation, types of electronic devices and others can be variously modified and carried out without departing from a scope of the present invention.

As described above, according to the present invention, steps from the request for changing a function by a user to function change processing in an electronic device of the user can be all automatically executed through the communication network without requiring the labor, and the business trip and the manual change operation by a person responsible for the maintenance service are thereby no longer necessary. Therefore, it is possible to provide the method for changing a function of an electronic device, the customer center, the dealer system and said user system, which can reduce the burden of the cost on a user and a time required for change and decrease the cost and labor in the customer center.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of changing a function of an electronic device in a user system in accordance with information being communicated through a communication network, between said user system and a customer center for carrying out an operation support business for said electronic device,
said method comprising:
a step of transmitting a function change request including a function change content of said electronic device and subscriber information allocated to said electronic device from said communication network, from said user system to said customer center; and
a step of creating function change control information based on said function change content included in said function change request, in said customer center, transmitting said function change control information from said customer center to said corresponding electronic device through said communication network, and changing a function of said electronic device based on said function change control information.

2. A method of changing a function of an electronic device in a user system in accordance with information being communicated through a communication network, between said user system and a customer center for carrying out an operation support business for said electronic device,
said method comprising:
a step of transmitting a function change request including a function change content of said electronic device and subscriber information allocated to said electronic device from said communication network, from said user system to said customer center;
a step of accessing said corresponding electronic device through said communication network based on said subscriber information included in said function change request transmitted from said user system, and acquiring information indicative of said function of said electronic device, in said customer center; and
a step of creating function change control information based on said information indicative of said function acquired from said electronic device and said function change content included in said function change request, transmitting said function change control information from said customer center to said corresponding electronic device through said communication network, and changing said function of said electronic device based on said function change control information.

3. A method of changing a function of an electronic device in a user system in accordance with information being communicated through a communication network, between said user system and the customer center for carrying out an operation support business for said electronic device, said method for use in a system comprising: said user system; said customer center being connected said user system through said communication network; user data base for storing therein subscriber information allocated to said electronic device from said communication network, confidential device identification information given to said electronic device in advance and information indicative of said function of said electronic device in association with individual identification information given to said user in advance,
said method comprising:
a step of transmitting a function change request including a function change content of said electronic device and said individual identification information of said user from said user system to said customer center,
a step of reading said subscriber information and said information indicative of said function of said corresponding electronic device from said user data base based on said individual identification information included in said function change request transmitted from said user system, in said customer center, and
a step of creating function change control information based on said information indicative of said function read from said user data base and said function change content included in said function change request, accessing said corresponding electronic device from said customer center through said communication network based on said subscriber information of said electronic device read from said user data base in order to transmit said function change control information, and changing said function of said electronic device based on said function change control information.

4. A method of changing a function of an electronic device in a user system in accordance with information being communicated through a communication network, between said user system, and a customer center for carrying out an operation support business for said electronic device via a dealer system for mediating a support business between said user system,
said method comprising:
a step of transmitting a function change request including a function change content of said electronic device and subscriber information allocated to said electronic device from said communication network, from said user system to said dealer system,
a step of transferring said function change request transmitted from said user system, from said dealer system to said customer center; and
a step of creating function change control information based on said function change content included in said function change request transferred from said dealer system in said customer center, transmitting said function change control information to said corresponding electronic device from said customer center through said communication network, and changing said function in said electronic device based on said function change control information.

5. A method of changing a function of an electronic device in a user system in accordance with information being communicated through a communication network, between said user system, and a customer center for carrying out an operation support business for said electronic device via a dealer system for mediating a support business between said user system,
said method comprising:
a step of transmitting a function change request including a function change content of said electronic device and subscriber information allocated to said electronic device from said communication network to said dealer system from said user system;
a step of transferring to said customer center from said dealer system said function change request transmitted from said user system;
a step of accessing said corresponding electronic device through said communication network based on said subscriber information included in said function change request transferred from said dealer system, and acquiring information indicative of said function from said electronic device, in said customer center; and
a step of creating function change control information based on said information indicative of said function acquired from said electronic device and said function change content included in said function change request, transmitting said function change control information from said customer center to said corresponding electronic device through said communication network, and changing said function in said electronic device based on said function change control information.

6. A method of changing a function of an electronic device in a user system in accordance with information being communicated through a communication network, between said user system, and a customer center for carrying out an operation support business for said electronic device via a dealer system for mediating a support business between said user system,
said method comprising:
a step of transmitting from said user system to said dealer system a function change request including a function change content of said electronic device and subscriber information allocated to said electronic device from said communication network;
a step of transferring from said dealer system to said customer center said function change request transmitted from said user system;
a step of accessing said corresponding electronic device through said communication network based on said subscriber information included in said function change request transferred from said dealer system, and acquiring information indicative of said function from said electronic device, in said customer center;
a step of transferring from said customer center to said dealer system said information indicative of said function acquired from said electronic device and said function change request; and
a step of creating function change control information based on said information indicative of said function transferred from said customer center and said function change content included in said function change request, transmitting said function change control information to said corresponding electronic device through said communication network based on said subscriber information of said electronic device included in said function change request, in said dealer system, and changing said function in said electronic device based on said function change control information.

7. A method of changing a function of an electronic device in a user system in accordance with information being communicated through a communication network, between said user system, and a customer center for carrying out an operation support business for said electronic device via a dealer system for mediating a support business between said user system,
said method comprising:
a step of transmitting from said user system to said customer center a function change request including a function change content of said electronic device and subscriber information allocated to said electronic device from said communication network;
a step of accessing said corresponding electronic device through said communication network based on said subscriber information included in said function change request transmitted from said user system, and acquiring information indicative of said function from said electronic device, in said customer center;
a step of transferring from said customer center to said dealer system said information indicative of said function acquired from said electronic device and said function change request; and
a step of creating function change control information based on said information indicative of said function transferred from said customer center and said function change content included in said function change request, in said dealer system, transmitting from said dealer system to said corresponding electronic device said function change control information through said communication network, and changing said function in said electronic device based on said function change control information.

8. A method of changing a function of an electronic device in a user system in accordance with information being communicated through a communication network, between said user system, and the customer center for carrying out an operation support business for said electronic device via a dealer system for mediating a support business between said user system, said method for use in a system comprising: said user system; said customer center being connected said user system through said communication network; said dealer system being connected said customer center and said user system through said communication network; user data base for storing therein subscriber information allocated to said electronic device from said communication network, confidential device identification information given to said electronic device in advance and information indicative of said function of said electronic device in association with individual identification information given to said user in advance,
said method comprising:
a step of transmitting from said user system to said dealer system a function change request including a function change content of said electronic device and individual identification information of a user;
a step of transferring from said dealer system to said customer center said function change request transmitted from said user system;
a step of reading said subscriber information and said information indicative of said function of said corresponding electronic device from said user data base based on said individual identification information of said user included in said function change request transmitted from said user system, in said customer center; and
a step of creating function change control information based on said information indicative of said function read from said user data base and said function change content included in said function change request, accessing said corresponding electronic device from said customer center through said communication network based on said subscriber information of said electronic device read from said user data base in order to transmit said function change control information, and changing said function in said electronic device based on said function change control information.

9. A method of changing a function of an electronic device in a user system in accordance with information being communicated through a communication network, between said user system, and the customer center for carrying out an operation support business for said electronic device via a dealer system for mediating a support business between said user system, said method for use in a system comprising: said user system; said customer center being connected said user system through said communication network; said dealer system being connected said customer center and said user system through said communication network; user data base for storing therein subscriber information allocated to said electronic device from said communication network, confidential device identification information given to said electronic device in advance and information indicative of said function of said electronic device in association with individual identification information given to said user in advance,
said method comprising:
a step of transmitting from said user system to said dealer system a function change request including a function change content of said electronic device and said individual identification information of said user;
a step of transferring from said dealer system to said customer center said function change request transmitted from said user system;
a step of reading said subscriber information and said information indicative of said function of said corresponding electronic device from said user data base based on said individual identification information of said user included in said function change request transmitted from said dealer system, in said customer center;
a step of transferring from said customer center to said dealer system said subscriber information and said information indicative of said function of said electronic device read from said user data base, and said function change request; and
a step of creating function change control information based on said information indicative of said function transferred from said customer center and said function change content included in said function change request, accessing said corresponding electronic device through said communication network based on said subscriber information of said electronic device transferred from said customer center in order to transmit said function change control information, in said dealer system, and changing said function in said electronic device based on said function change control information.

10. A method of changing a function of an electronic device in a user system in accordance with information being communicated through a communication network, between said user system, and the customer center for carrying out an operation support business for said electronic device via a dealer system for mediating a support business between said user system, said method for use in a system comprising: said user system; said customer center being connected said user system through said communication network; said dealer system being connected said customer center and said user system through said communication network; user data base for storing therein subscriber information allocated to said electronic device from said communication network, confidential device identification information given to said electronic device in advance and information indicative of said function of said electronic device in association with individual identification information given to said user in advance,
said method comprising:
a step of transmitting from said user system to said customer center a function change request including a function change content of said electronic device and said individual identification information of said user;
a step of reading said subscriber information and said information indicative of said function of said corresponding electronic device from said user data base based on said individual identification information included in said function change request transmitted from said user system, in said customer center,
a step of transferring from said customer center to said dealer system said function change request transmitted from said user system, said subscriber information and said information indicative of said function of said electronic device read from said user data base; and
a step of creating function change control information based on said information indicative of said function transferred from said customer center and said function change content included in said function change request, accessing said corresponding electronic device through said communication network based on said subscriber information of said electronic device transferred from said customer center in order to transmit said function change control information, in said dealer system, and changing said function in said electronic device based on said function change control information.

11. The method of changing a function of an electronic device according to any of claims 1 to 10, wherein when said customer center and a payment institution can be connected to each other through said communication network, said method further comprises:
a step of transmitting from said user system to said customer center account identification information of said user; and
a step of executing payment processing in order to transfer a charge required for the function change from an account of said user between said customer center and said payment institution through said communication network after completion of the function change with respect to said electronic device of said user system.

12. The method of changing a function of an electronic device according to any of claims 4 to 10, wherein when said dealer system and a payment institution can be connected to each other through said communication network, said method further comprises:
a step of transmitting from said user system to said dealer system account identification information of said user; and
a step of executing payment processing in order to transfer a charge required for the function change from an account of said user between said dealer system and said payment institution through said communication network after completion of the function change with respect to said electronic device.

13. The method of changing a function of an electronic device according to any of claims 1 to 10, wherein when said customer center and a payment institution can be connected to each other through a communication network, said method further comprises:
a step of transmitting from said user system to said customer center account identification information of said user;
a step of executing payment processing in order to transfer a charge required for the function change from an account of said user between said customer center and said payment institution through said communication network after completion of the function change with respect to said electronic device of said user system;
a step of inquiring about the legitimacy of said user from said customer center to said payment institution through said communication network based on said acquired account identification information of said user; and
a step of making judgment upon whether the function change can be allowed based on a result of said inquiry, and allowing the function change with respect to said corresponding electronic device only when it is determined that the function change can be allowed, in said customer center.

14. The method of changing a function of an electronic device according to any of claims 4 to 10, wherein when said dealer system and a payment institution can be connected to each other through a communication network, said method further comprises:
a step of transmitting from said user system to said dealer system account identification information of said user;
a step of executing payment processing in order to transfer a charge required for the function change from an account of said user between said dealer system and said payment institution through said communication network after completion of the function change with respect to said electronic device;
a step of inquiring about the legitimacy of said user from said dealer system to said payment institution through said communication network based on said acquired account identification information of said user; and
a step of making judgment upon whether the function change can be allowed based on a result of said inquiry, and enabling the function change only when it is determined that the function change can be allowed, in said dealer system.

15. The method of changing a function of an electronic device according to claim 2 or 5 or 6 or 7, further comprising a step of acquiring by said customer center said device identification information given to said electronic device in advance together with said information indicative of said function from said electronic device,
wherein said step of transmitting said function change information encrypts said function change control information by using said acquired device identification information, transmits said encrypted function change control information from said customer center to said electronic device, decrypts said function change control information transmitted from said customer center by said electronic device using its own device identification information, and allows the function change in accordance with said decrypted function change control information.

16. The method of changing a function of an electronic device according to claim 3 or 8 or 9 or 10, further comprising a step of reading said device identification information of said corresponding electronic device from said user data base based on said individual identification information of said user, in said customer center,
wherein said step of transmitting said function change information encrypts said function change control information by using said device identification information read from said user data base, transmits said encrypted function change control information from said customer center to said electronic device, decrypts said function change control information transmitted from said customer center by said electronic device using its own device identification information, and allows the function change in accordance with said decrypted function change control information.

17. The method of changing a function of an electronic device according to claim 2 or 5 or 6 or 7, further comprising a step of making judgment upon whether the function change requested from said user system is possible based on said information indicative of said function acquired from said electronic device and said function change content included in said function change request, in said customer center,
wherein said step of changing said function of said electronic device transmits said function change control information from said customer center to said corresponding electronic device through said communication network and changing said function of said electronic device based on said function change control information when it is determined that the function change is possible by said step of making judgment.

18. The method of changing a function of an electronic device according to claim 3 or 8 or 9 or 10, further comprising a step of making judgment upon whether the function change is possible based on said information indicative of said function change content included in said function change request, in said customer center,
wherein said step of performing function change Processing for said electronic device from said customer center through said communication network based on said subscriber information of said electronic device read from said user data base in order to transmit said function of said electronic device based on said function change control information.

19. The method of changing a function of an electronic device according to claim 2, further comprising:
a step of making judgment upon whether the function change requested from said user system is possible based on said information indicative of said function acquired from said electronic device and said function change content included in said function change request, in said customer center; and
a step of notifying said user system of a result of judgment upon whether the function change requested from said user system is possible from said customer system through said communication network.

20. The method of changing a function of an electronic device according to claim 5 or 6 or 7, further comprising:
a step of making judgment upon whether the function change requested from said user system is possible based on said information indicative of said function acquired from said electronic device and said function change content included in said function change request, in said customer center; and
a step of transferring a result of judgment upon whether the function change requested from said user system is possible from said customer center to said dealer system through said communication network, and notifying said user system which has sent said request of said result of judgment by said dealer system through said communication network.

21. The method of changing a function of an electronic device according to claim 3, further comprising:
a step of making judgment upon whether the function change requested is possible based on said information indicative of said function read from said user data base and said function change content included in said function change request, in said customer center; and
a step of notifying said user system of a result of judgment upon whether the function change requested from said user system is possible from said customer center through said communication network.

22. The method of changing a function of an electronic device according to claim 8 or 9 or 10, further comprising:
a step of making judgment upon whether the function change requested is possible based on said information indicative of said function read from said user data base and said function change content included in said function change request, in said customer center; and
a step of transferring a result of judgment upon whether the function change requested from said user system is possible from said customer center to said dealer system through communication network, and notifying said user system which has sent said request of said result of judgment by said dealer system through said communication network.

23. The method of changing a function of an electronic device according to claim 3 or 8 or 9 or 10, further comprising a step of updating said information indicative of said function of said corresponding electronic device relative to said user system in said user data base after completion of function change processing with respect to said electronic device.

24. The method of changing a function of an electronic device according to any of claims 1 to 10, wherein when said electronic device has a function table which stores therein setting information indicative of enabled/disabled states with respect to at least a part of all previously provided functions,
said step of changing said function of said electronic device changes setting information of said corresponding function in said function table in accordance with the content of said function change control information transmitted to said electronic device.

25. A customer center which is connected to a user system including an electronic device having a communication function through a communication network and changes a function of said electronic device by communicating information between itself and said user system,
said customer center comprising:
function change request receiving means for receiving a function change request including a function change content of said electronic device transmitted from said user system and subscriber information allocated to said electronic device from said communication network;
creating means for creating function change control information based on said function change content included in said function change request received by said function change request receiving means; and
function change controlling means for transmitting said function change control information created by said creating means to said corresponding electronic device through said communication network, and making said electronic device execute function change processing based on said function change control information.

26. A customer center which is connected to a user system including an electronic device having a communication function through a communication network and changes a function of said electronic device by communicating information between itself and said user system,
said customer center comprising:
function change request receiving means for receiving a function change request including a function change content of said electronic device transmitted from said user system and subscriber information allocated to said electronic device from said communication network;
function information acquiring means for accessing said corresponding electronic device through said communication network based on said subscriber information included in said function change request received by said function change request receiving means, and acquiring information indicative of said function from said electronic device;
creating means for creating function change control information based on said information indicative of said function acquired by said function information acquiring means and said function change content included in said function change request; and
function change controlling means for transmitting said function change control information created by said creating means to said corresponding electronic device through said communication network, and making said electronic device execute function change processing based on said function change control information.

27. A customer center which is connected to a user system including an electronic device having a communication function through a communication network and changes a function of said electronic device by communicating information between itself and said user system,
said customer center comprising:
a user data base which stores therein subscriber information allocated to said electronic device from said communication network, confidential device identification information given to said electronic device in advance and information indicative of a function of said electronic device in association with individual identification information given to said user system in advance;
function change request receiving means for receiving a function change request including a function change content of said electronic device transmitted from said user system and said individual identification information of said user system;
reading means for reading said subscriber information of said corresponding electronic device and said information indicative of said function from said user data base based on said individual identification information of said user system included in said function change request received by said function change request receiving means;
creating means for creating function change control information based on said information indicative of said function read from said user data base and said function change content included in said function change request; and
function change controlling means for transmitting said function change control information created by said creating means by accessing said corresponding electronic device through said communication network based on said subscriber information of said electronic device read from said user data base, and making said electronic device execute function change processing based on said function change control information.

28. A customer center which is connected to a user system including an electronic device having a communication function and to a dealer system through a communication network and changes a function of said electronic device by communicating information between itself and said user system through said dealer system,
said customer center comprising:
function change request receiving means for receiving a function change request including a function change content of said electronic device transmitted from said user system through said dealer system and subscriber information allocated to said electronic device from said communication network;
creating means for creating function change control information based on said function change content included in said function change request received by said function change request receiving means; and
function change controlling means for transmitting function change control information created by said creating means to said corresponding electronic device through said communication network, and making said electronic device execute function change processing based on said function change control information.

29. A customer center which is connected to a user system including an electronic device having a communication function and a dealer system through a communication network and changes a function of said electronic device by communicating information between itself and said user system through said dealer system,
said customer center comprising:
function change request receiving means for receiving a function change request including a function change content of said electronic device transmitted from said user system through said dealer system and subscriber information allocated to said electronic device from said communication network;
function information acquiring means for accessing said corresponding electronic device through said communication network based on subscriber information included in said function change request received by said function change request receiving means, and acquiring information indicative of a function of said electronic device;
creating means for creating function change control information based on said information indicative of said function of said electronic device acquired by said function information acquiring means and said function change content included in said function change request; and
function change controlling means for transmitting said function change control information created by said creating means to said corresponding electronic device through said communication network, and making said electronic device execute function change processing based on said function change control information.

30. A customer center which is connected to a user system including an electronic device having a communication function and a dealer system through a communication network and change a function of said electronic device by communicating information between itself and said user system through said dealer system,
said customer center comprising:
function change request receiving means for receiving a function change request including a function change content of said electronic device transmitted from said user system through said dealer system and subscriber information allocated to said electronic device from said communication network;
function information acquiring means for accessing said corresponding electronic device through said communication network based on said subscriber information included in said function change request received by said function change request receiving means, and acquiring information indicative of said function from said electronic device; and
information transferring means for transferring said information indicative of said function acquired from said electronic device by said function information acquiring means and said function change request.

31. A customer center which is connected to a user system including an electronic device having a communication function and a dealer system through a communication network and changes a function of said electronic device by communicating information between itself and said user system through said dealer system,
said customer center comprising:
function change request receiving means for receiving a function change request including a function change content of said electronic device and subscriber information allocated to said electronic device from said communication network transmitted from said user system;
function information acquiring means for accessing said corresponding electronic device through said communication network based on said subscriber information included in said function change request received by said function change request receiving means, and acquiring information indicative of said function from said electronic device; and
information transferring means for transferring to said dealer system said information indicative of said function acquired from said electronic device by said function information acquiring means and said function change request.

32. A customer center which is connected to a user system including an electronic device having a communication function and a dealer system through a communication network and changes a function of said electronic device by communicating information between itself and said user system through said dealer system,
said customer center comprising:
a user data base which stores therein subscriber information allocated to said electronic device from said communication network, confidential device identification information given to said electronic device in advance and information indicative of said function of said electronic device in association with individual identification information given to said user system in advance;
function change request receiving means for receiving a function change request including a function change content of said electronic device and said individual identification information of said user system transmitted from said user system through said dealer system;
reading means for reading said subscriber information of said corresponding electronic device and said information indicative of said function from said user data base based on said individual identification information of said user system included in said function change request received by said function change request receiving means;
creating means for creating function change control information based on said information indicative of said function read from said user data base and said function change content included in said function change request; and
function change controlling means for transmitting said function change control information created by said creating means by accessing said corresponding electronic device through said communication network based on said subscriber information of said electronic device read from said user data base, and making said electronic device execute function change processing based on said function change control information.

33. A customer center which is connected to a user system including an electronic device having a communication function and a dealer system through a communication network and changes a function of said electronic device by communicating information between itself and said user system through said dealer system,
said customer center comprising:
a user data base which stores therein subscriber information allocated to said electronic device from said communication network, confidential device identification information given to said electronic device in advance and information indicative of said function of said electronic device in association with individual identification information given to said user system in advance;
function change request receiving means for receiving a function change request including a function change content of said electronic device and said individual identification information of said user system transmitted from said user system through said dealer system;
reading means for reading said subscriber information of said corresponding electronic device and said information indicative of said function from said user data base based on said individual identification information of said user system included in said function change request received by said function change request receiving means; and
transferring means for transferring to said dealer system said subscriber information of said electronic device and said information indicative of said function read from said user data base by said reading means and said function change request.

34. A customer center which is connected to a user system including an electronic device having a communication function and a dealer system through a communication network and changes a function of said electronic device by communicating information between itself and said user system through said dealer system,
said customer center comprising:
a user data base which stores therein subscriber information allocated to said electronic device from said communication network, confidential device identification information given to said electronic device in advance and information indicative of said function of said electronic device in association with individual identification information given to said user system in advance;
function change request receiving means for receiving a function change request including a function change content of said electronic device and said individual identification information of said user system transmitted from said user system;
reading means for reading said subscriber information of said corresponding electronic device and said function indicative of said function from said user data base based on said individual identification information of said user system included in said function change request received by said function change request receiving means; and
information transferring means for transferring to said dealer system said subscriber information of said electronic device, and said information indicative of said function read from said user data base by said reading means, and said function change request.

35. The customer center according to any of claims 25 to 34, wherein when said customer center can be connected to a payment institution through said communication network,
said customer center further comprises means for executing payment processing in order to transfer a charge required for the function change from an account corresponding to said user system between itself and said payment institution through said communication network after completion of execution of function change control with respect to said electronic device by said function change controlling means.

36. The customer center according to any of claims 25 to 34, wherein when said customer center can be connected to a payment institution through said communication network,
said customer center further comprises:
account identification information receiving means for receiving account identification information of a user from said user system;
inquiring means for inquiring said payment institution about legitimacy of said user system through said communication network based on said account identification information of said user received from said user system by said account identification information receiving means; and
means for judging whether the function change can be allowed based on a result of said inquiry, and allowing execution of function change processing with respect to said corresponding electronic device only when it is determined that the function change can be allowed.

37. The customer center according to claim 26 or 29, further comprising means for acquiring device identification information given to said electronic device in advance together with information indicative of a function from said electronic device,
wherein said function change controlling means encrypts said function change control information by using said acquired function identification information, and transmits said encrypted function change control information to said electronic device.

38. The customer center according to claim 27 or 32, further comprising means for reading device identification information of said corresponding electronic device from said user data base based on said individual identification information transmitted from said user system,
wherein said function change control information encrypts said function change control information by using said device identification information read from said user data base, and transmits said encrypted function change control information to said electronic device.

39. The customer center according to claim 26 or 29, further comprising judging means for judging whether the function change requested from said user system is possible based on said information indicative of said function acquired from said electronic device and said function change content included in said function change request,
wherein said function change controlling means transmits said function change control information to said corresponding electronic device through said communication network, and makes said electronic device execute function change processing based on said function change control information, when it is determined that the function change is possible by said judging means.

40. The customer center according to claim 27 or 32, further comprising judging means for judging whether the requested function change is possible based on said information indicative of said function read from said user data base and said function change content included in said function change request,
wherein said function change controlling means accesses said corresponding electronic device through said communication network based on said subscriber information of said electronic device read from said user data base, transmits the function change control information to said corresponding electronic device, and makes said electronic device execute function change processing based on said function change control information, when it is determined that the function change is possible by said judging means.

41. The customer center according to claim 26, further comprising:
judging means for judging whether the function change requested from said user system is possible based on said information indicative of said function acquired from said electronic device and said function change content included in said function change request; and
means for notifying said user system of a result of judgment upon whether the function change requested from said user system is possible through said communication network.

42. The customer center according to claim 27, further comprising:
judging means for judging whether the requested function change is possible based on said information indicative of said function read from said user data base, and said function change content included in said function change request; and
means for notifying said user system of a result of judgment upon whether the function change requested from said user system is possible through said communication network.

43. The customer center according to claim 29, further comprising:
judging means for judging whether the function change requested from said user system is possible based on said information indicative of said function acquired from said electronic device, and said function change content included in said function change request; and
means for notifying said user system which has sent said request of a result of judgment upon whether the function change requested from said user system is possible through said dealer system.

44. The customer center according to claim 32, further comprising:
judging means for judging whether the requested function change is possible based on said information indicative of said function read from said user data base and said function change content included in said function change request; and
means for notifying said user system which has sent said request of a result of judgment upon whether the function change requested from said user system is possible through said dealer system.

45. The customer center according to claim 27 or 32, further comprising means for updating said information indicative of said function of said corresponding electronic device with respect to said user system in said user data base, after completion of function change control with respect to said electronic device by said function change controlling means.

46. A dealer system which is connected to a user system including an electronic device having a communication function and a customer center through a communication network and changes a function of said electronic device by communicating information between said user system and said customer center,
said dealer system comprising:
function change request receiving means for receiving a function change request including a function change content of said electronic device transmitted from said user system and subscriber information allocated to said electronic device from said communication network; and
function change request transferring means for transferring said function change request received by said function change request receiving means to said customer center.

47. A dealer system which is connected to a user system including an electronic device having a communication function and a customer center through a communication network and changes a function of said electronic device by communicating information between said user system and said customer center,
said dealer system comprising:
function change request receiving means for receiving a function change request including a function change content of said electronic device transmitted from said user system and subscriber information allocated to said electronic device from said communication network;
function change request transferring means for transferring said function change request received by said function change request receiving means to said customer center;
information receiving means for receiving said information indicative of said function of said electronic device and said function change request transmitted from said customer center; and
function change controlling means for creating function change control information based on said information indicative of said function of said electronic device received by said information receiving means and said function change content included in said function change request, transmitting said function change control information to said corresponding electronic device through said communication network based on said subscriber information of said electronic device included in said function change request, and making said electronic device execute function change processing based on said function change control information.

48. A dealer system which is connected to a user system including an electronic device having a communication function and a customer center through a communication network and changes a function of said electronic device by communicating information between said user system and said customer center,
said dealer system comprising:
information receiving means for receiving a function change request including a function change content of said electronic device and subscriber information allocated to said electronic device from said communication network transmitted from said customer center, and information indicative of a function acquired from said electronic device; and
function change controlling means for creating function change control information based on said information indicative of said function received by said information receiving means and said function change content included in said function change request, transmitting said function change control information to said corresponding electronic device through said communication network based on said subscriber information of said electronic device included in said function change request, and making said electronic device execute function change processing based on said function change control information.

49. A dealer system which is connected to a user system including an electronic device having a communication function and a customer center through a communication network and changes a function of said electronic device by communicating information between said user system and said customer center,
wherein when said customer center includes a user data base which stores therein subscriber information allocated to said electronic device from said communication network, confidential device identification information given to said electronic device in advance, and information indicative of a function of said electronic device in association with individual identification information given to said user system in advance,
said dealer system comprises:
function change request receiving means for receiving a function change request including a function change content of said electronic device and individual identification information of a user transmitted from said user system; and
function change request transferring means for transferring said function change request received by said function change request receiving means to said customer center.

50. A dealer system which is connected to a user system including an electronic device having a communication function and a customer center through a communication network and changes a function of said electronic device by communicating information between said user system and said customer center,
wherein when said customer center includes a user data base which stores therein subscriber information allocated to said electronic device from said communication network, confidential device identification information given to said electronic device in advance and information indicative of a function of said electronic device in association with individual identification information given to said user system in advance,
said dealer system comprises:
function change request receiving means for receiving a function change request including a function change content of said electronic device and said individual identification information of a user transmitted from said user system;
function change request transferring means for transferring said function change request received by said function change request receiving means to said customer center;
information receiving means for receiving said function change request transmitted from said customer center, said subscriber information of said electronic device and said information indicative of said function of said electronic device read from said user data base, and said function change request; and
function change controlling means for creating function change control information based on said information indicative of said function of said electronic device received by said information receiving means and said function change content included in said function change request, transmitting said function change control information to said corresponding electronic device through said communication network based on said subscriber information of said electronic device, and making said electronic device execute function change processing based on said function change control information.

51. A dealer system which is connected to a user system including an electronic device having a communication function and a customer center through a communication network and changes a function of said electronic device by communicating information between said user system and said customer center,
wherein when said customer center includes a user data base which stores therein subscriber information allocated to said electronic device from said communication network, confidential device identification information given to said electronic device in advance and information indicative of a function of said electronic device in association with individual identification information given to said user system in advance,
said dealer system comprises:
information receiving means for receiving a function change request including a function change content of said electronic device and said individual identification information of a user transmitted from said customer center, said subscriber information of said electronic device and said information indicative of said function of said electronic device read from said user data base; and
function change controlling means for creating function change control information based on said information indicative of said function of said electronic device received by said information receiving means and said function change content included in said function change request, transmitting said function change control information to said corresponding electronic device through said communication network based on said subscriber information of said electronic device, and making said electronic device execute function change processing based on said function change control information.

52. The dealer system according to any of claims 46 to 51, wherein when said dealer system can be connected to a payment institution through said communication network,
said dealer system further comprises:
account identification information receiving means for receiving account identification information of said user from said user system; and
means for executing payment processing in order to transfer a charge required for the function change from an account of said user between itself and said payment institution through said communication network after completion of the function change with respect to said electronic device.

53. The dealer system according to any of claims 46 to 51, wherein when said dealer system can be connected to a payment institution through said communication network,
said dealer system further comprises:
account identification information receiving means for transmitting account identification information of said user from said user system;
means for executing payment processing in order to transfer a charge required for the function change from an account of said user between itself and said payment institution through said communication network after completion of the function change with respect to said electronic device;
inquiring means for inquiring said payment institution about legitimacy of said user through said communication network based on said acquired account identification information of said user; and
means for making judgment upon whether the function change can be allowed based on a result of said inquiry, and enabling the function change only when it is determined that the function change can be allowed.

54. A user system which is connected to said customer center defined in claim 37 or 38,
said user system comprising:
receiving means for receiving function change control information transmitted from said customer center; and
means for decrypting said function change control information received by said receiving means by using device identification information given to an electronic device of said user system itself, and allowing execution of function change processing in accordance with said decrypted function change control information.

55. A user system which includes an electronic device having a communication function, and is connected to a customer center through a communication network,
said user system comprising:
a function table which stores therein setting information indicative of enabled/disabled states with respect to at least a part of all functions provided to said electronic device;
receiving means for receiving function change control information transmitted from said customer center through said communication network; and
means for changing a setting of a corresponding function by varying setting information of said corresponding function in said function table in accordance with the content of said function change control information received by said receiving means.
